(19) United States
(12) Patent Application Publication
(10) Pub. No.: US 2021/0191629 A1
(43) Pub. Date: Jun. 24, 2021

(54) EXPANDABLE DATA STORAGE MANAGEMENT SYSTEM

(71) Applicant: Commvault Systems, Inc., Tinton Falls, NJ (US)

(72) Inventors: Anand Vibhor, Manalapan, NJ (US); Mrityunjay Upadhyay, Hyderabad (IN); Bhavyan Bharatkumar Mehta, Sion (IN); Suraj Bharech, Santa Clara, CA (US)

(21) Appl. No.: 17/087,100

(22) Filed: Nov. 2, 2020

Related U.S. Application Data
(60) Provisional application No. 62/953,057, filed on Dec. 23, 2019.

(51) Int. Cl. G06F 3/06

(52) U.S. Cl. CPC G06F 3/0619; G06F 3/067; G06F 3/0659

(57) ABSTRACT

An illustrative expandable data storage management system includes rules for assigning data protection operations to suitable subtending storage service cells. Each cell is specially configured to protect certain data types and/or to provide certain storage resources for backup data. The system controls customer account access, authentication, service allocation, data security, and sharing of information between a centralized “hub manager” and the storage service cells that perform storage operations, including data backup, data recovery, and data lifecycle management. The system maintains a many-to-many relationship between distinct customers and storage service cells so that any storage service cell may be responsible for protecting any number of data sources of any number of distinct customers, and responsibility for protecting any given customer's data sources may be distributed among any number of storage service cells. The system supports global searching, ensuring that a user-initiated search is applied across the storage service cells.

### INCORPORATION BY REFERENCE TO ANY PRIORITY APPLICATIONS

The present application claims the benefit of priority to U.S. Provisional Patent Application No. 62/953,057 filed on Dec. 23, 2019 with the title of “Expandable Data Storage Management System.” Any and all applications for which a foreign or domestic priority claim is identified in the Application Data Sheet of the present application are hereby incorporated by reference in their entireties under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND

Businesses recognize the commercial value of their data and seek reliable, cost-effective ways to protect the information stored on their computer networks while minimizing impact on productivity. A company might back up critical computing systems such as databases, file servers, web servers, virtual machines, and so on as part of a maintenance schedule. The company may similarly protect computing systems used by its employees, such as those used by an accounting department, marketing department, engineering department, and so forth. Given the rapidly expanding volume of data under management, companies also continue to seek innovative techniques for managing data growth, for example by migrating data to lower-cost storage over time, reducing redundant data, pruning lower priority data, etc. Enterprises also increasingly view their stored data as a valuable asset and look for solutions that leverage their data. For instance, data analysis capabilities, information management, improved data presentation and access features, and the like, are in increasing demand.

Traditional data storage systems are configured to protect customer data generated by a given customer and can reach growth or configuration limits depending on the customer's size and data needs. Customers with multiple data storage systems have to manage access to and control over diverse systems and networks.

### SUMMARY

The present inventors devised an approach for providing flexible and scalable data storage management to a variety of customers seeking to protect their data. The illustrative expandable data storage management system optimizes how data protection services are assigned to certain resources. Accordingly, the system includes rules for assigning and delegating data protection operations to suitable subtending systems. Each subtending system is specially configured to protect certain data types and/or to provide certain storage resources for backup data (aka “secondary copies”). The illustrative expandable system controls customer account access, authentication, service allocation, data security, and sharing of information between a centralized “hub manager” and any number of sub-tending “storage service cells” that perform storage operations, including data backup, data recovery, and data lifecycle management. Illustratively, the hub manager comprises some of the resources of a storage service cell to maintain compatibility and architectural integrity therewith but preferably does not perform storage operations.

The illustrative expandable system, e.g., using the hub manager, presents a user interface that provides each customer with a unified simulated single-system view of their data protection services and hides how particular services are allocated to the subtending storage service cells. The unified user interface hides the underlying distributed architecture that, for any given customer, can involve any number of subtending storage service cells and can change over time. The unified user interface also hides and blocks attempts to access other customers' information and data. Each distinct customer who has a subscription to the illustrative expandable data storage management system may have numerous users with authorized access to the system, but each user is bound by the customer's subscription and ownership, and thus is blocked from viewing and/or accessing other customers' data and information in the system.

The illustrative architecture is scalable and enables any number of subtending storage service cells to be activated by the system operator without visibility to customers. The architecture includes a shard-based database that tracks key information collected from subtending storage service cells, e.g., MongoDB or another document-oriented database. The shards are organized so that they can be readily polled for customer-specific information to speedily provide reports and/or responses to queries received from the user interface.

The illustrative hub manager makes re-assignments without visibility to customers. Re-assignments are caused by any number of changes, e.g., changes in assignment rules, changes in customer administration/configurations, newly available storage service cells, storage service cells taken out of service, new data sources and data destinations, etc., without limitation. New storage service cells are associated with a new corresponding database shard at the hub manager. Information is received by each shard from its corresponding storage service cell through the use of a cache manager and a scheme of watching certain change reporting events at each storage service cell. Certain kinds of changes at the subtending storage service cell are trapped and transmitted to the cache manager and from there to the storage service cell's corresponding database shard.

The illustrative system supports global searching by customers, ensuring that a user-initiated search is applied across the storage service cells. When a customer enters a search or report request at the user interface, the hub manager rapidly extracts and aggregates appropriate responses via shard queries; if need be, the hub manager extracts information from the storage service cells and/or provides drill-down features to allow the customer access to further details available only from the storage service cell.

Thus, the illustrative expandable data storage management system has a “matrix management” architecture that flexibly accommodates any number of customer accounts as well as any number of storage service cells in a many-to-many relationship. According to the illustrative matrix management architecture, a given customer's data may be serviced (protected) by one or more storage service cells, each of which may or may not also service another customer's data. The illustrative system ensures “soft separation” of different customers' data processed at the same storage service cell. The system also provides “hard separation” when customers require dedicated storage service cells. Thus, a database shard may comprise customer-specific information for many customers being serviced by the shard's corresponding storage service cell. To maintain the simulated single-system view provided to each customer account, the system (e.g., using the hub manager) polls database shards and/or storage service cells for information pertaining to a given customer, aggregates the results, and presents unified results to the customer via the illustrative user interface.

The illustrative assignment rules are based on certain configuration needs associated with certain data sources and/or data destinations. By creating specialized storage service cells, the illustrative architecture advantageously allows for economies of scale that may not be available on a cell-by-cell basis. Moreover, the architecture supports easy incremental growth in customers or data sources by distributing assignments across multiple storage service cells, while assuring soft separation of diverse customers' backup data. In contrast, a traditional single-cell system requires customer-by-customer dedicated resources. Thus, for each data source of a distinct customer, the hub manager assigns data protection responsibilities (e.g., making secondary copies, archiving, lifecycle management, etc.) to one of the plurality of storage service cells based on: configuration information about the one storage service cell, attributes of the data source, and storage operation preferences administered for the data source.

Preferably, each storage service cell is specially configured to protect certain kinds of data (e.g., cloud-based data, laptop data, virtual machine data, etc.) and/or to provide certain storage resources for backup data (e.g., cloud-based storage environment, data center storage, archiving resources, etc.). For example, a customer's Microsoft Office 365 data is stored exclusively in a cloud computing environment (e.g., Microsoft Azure) and not in the customer's local data center or at users' laptop/desktop computers. To back up and protect the cloud-based data, a storage service cell needs access nodes that act as waypoints for the data being protected. The access node computing devices are specially configured for secure access to one or more cloud computing accounts hosting the cloud-based data (e.g., The Azure account for the Office 365 data) and are further equipped with binaries, application programming interfaces (APIs), and proprietary components of the storage service cell (e.g., media agents, data agents) that extract the cloud-based data from its source, process it, generate suitable backup copies, and store the backup copies to designated destination storage. Different storage service cells may be configured for access to distinct cloud computing environments supplied by different cloud service providers (e.g., Microsoft Azure, Amazon Web Services, Google Cloud Platform, etc.) and/or in different availability zones of a cloud service provider. Different data agents are needed for various cloud-based data sources, e.g., Exchange, SharePoint, etc. Preferably, the storage service cell is configured in the same cloud computing environment as the source data, e.g., Microsoft Azure, Amazon Web Services, Oracle Cloud, etc.; this configuration preference facilitates access and the secondary copies are preferably stored in the same cloud computing environment, though they are logically part of the particular storage service cell and managed by the storage service cell's storage manager

On the other hand, data that does not originate or terminate in a cloud computing environment, e.g., laptop data, and is backed up to non-cloud data center storage resources does not require cloud access configurations or cloud resources and is preferably backed up by a different storage service cell. Such cells do not require cloud access nodes or cloud computing and can be economically configured in a suitable non-cloud data center.

The illustrative hub manager, through the user interface it provides, receives administrative entries from each customer, e.g., storage operation preferences for each data source, such as data source definition (e.g., subclients), storage policies, storage schedules, retention policies, pruning preferences, etc. The hub manager distributes these storage operation preferences to the storage manager in the storage service cell assigned to protect the particular data source, and the storage manager stores the received preferences locally, e.g., to a local management database it maintains. Thus, any given storage service cell may be responsible for protecting any number of data sources of any number of customers, and responsibility for protecting any given customer's data sources may be distributed among any number of storage service cells, thus creating a many-to-many relationship within the illustrative system.

Thus, the illustrative data storage management system represents a technological improvement in storage management technologies, because it features an expandable architecture that supports any number of customer accounts, whose data is protected by any number of storage service cells, whether in a shared or exclusive configuration, without limitation. The system is configured with processing resources (e.g., hub manager) and data resources (e.g., sharded database, management database, assignment rules, graph database, etc.) that hide the distributed nature of a customer's data backup resources and offer a speedy and secure “single-system” unified view to each customer account. Furthermore, rules for assigning and delegating storage services to specialized storage service cells ease the incremental addition of new customers, data sources, and/or storage destinations. The rules and assignments can change as needed without visibility to a customer at the user interface. The operator of the illustrative expandable data storage management system benefits from economies of scale in configuring some of the specialized storage service cells, while providing secure individualized data protection to a variety of customers.

### BRIEF DESCRIPTION OF THE DRAWINGS

FIG. 1A is a block diagram illustrating an example information management system.

FIG. 1B is a detailed view of a primary storage device, a secondary storage device, and some examples of primary data and secondary copy data.

FIG. 1C is a block diagram of an example information management system including a storage manager, one or more data agents, and one or more media agents.

FIG. 1D is a block diagram illustrating a scalable information management system.

FIG. 1E illustrates certain secondary copy operations according to an example storage policy.

FIGS. 1F-1H are block diagrams illustrating suitable data structures that may be employed by the information management system.

FIG. 2A illustrates a system and technique for synchronizing primary data to a destination such as a failover site using secondary copy data.

FIG. 2B illustrates an information management system architecture incorporating use of a network file system (NFS) protocol for communicating between the primary and secondary storage subsystems.

FIG. 2C is a block diagram of an example of a highly scalable managed data pool architecture.

FIG. 3 is a block diagram illustrating some salient portions of an expandable data storage management system 300 according to an illustrative embodiment.

FIG. 4A is a block diagram illustrating a customer's secondary copies distributed among a plurality of storage service cells according to an illustrative embodiment.

FIG. 4B is a block diagram illustrating a customer's secondary copies distributed among a plurality of storage service cells, some of which also comprises other customers' secondary copies, according to an illustrative embodiment.

FIG. 5 is a block diagram illustrating a customer's primary data sources being protected by different storage service cells according to an illustrative embodiment.

FIG. 6 is a block diagram illustrating that in system 300 each customer receives a customer-specific “single system” view via storage hub manager 350, even when a plurality of storage service cells are protecting each customer's data, according to an illustrative embodiment.

FIG. 7A is a block diagram illustrating some salient portions of system 300, including some components of a storage service cell 301-1 protecting customer laptop data according to an illustrative embodiment.

FIG. 7B is a block diagram illustrating some salient portions of system 300, including a data protection scenario in which data sources and a storage service cell operate in a cloud computing environment according to an illustrative embodiment.

FIG. 8A is a block diagram illustrating some salient logical components of a storage hub manager 350 according to an illustrative embodiment.

FIG. 8B is a block diagram illustrating some salient data structures stored at management database 846 configured in an illustrative storage hub manager 350 according to an illustrative embodiment.

FIG. 9 is a block diagram illustrating the use of a document-oriented database in system 300 according to an illustrative embodiment.

FIGS. 10A-10C depict some salient operations of a method 1000 according to an illustrative embodiment.

### DETAILED DESCRIPTION

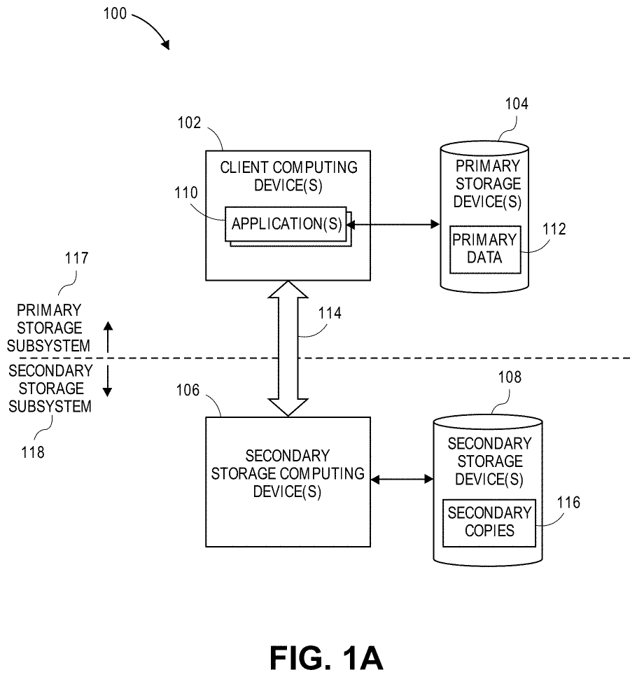

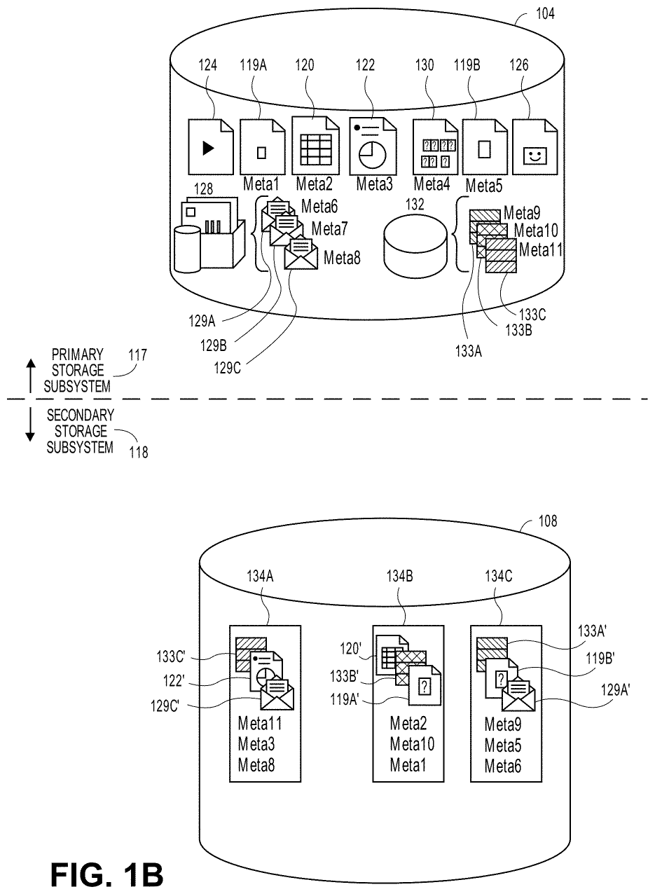

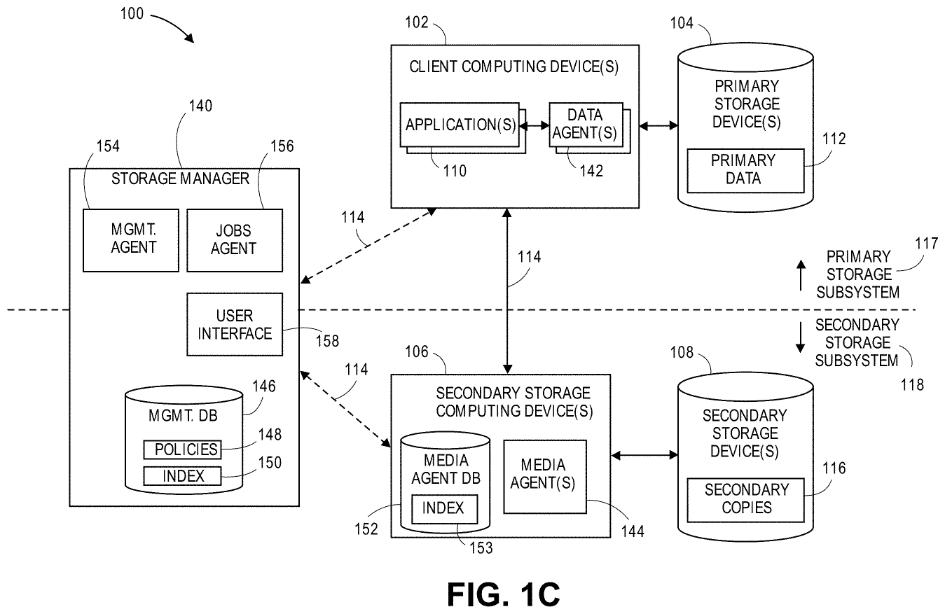

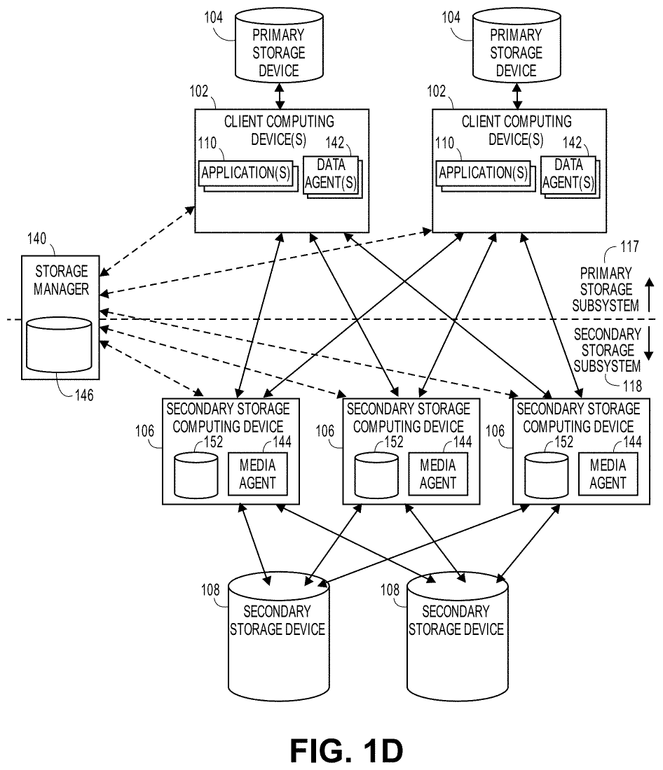

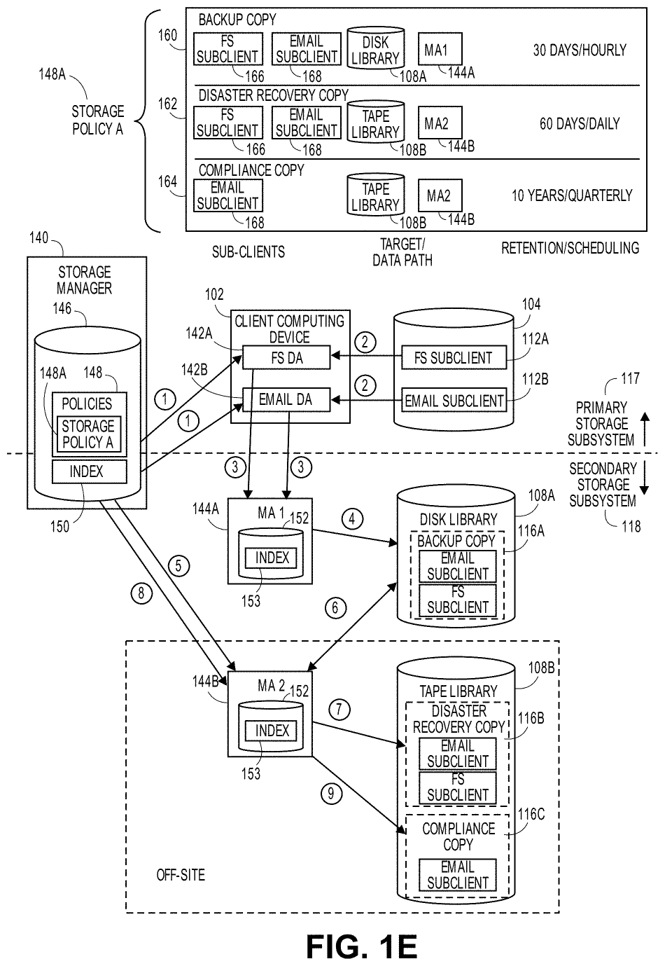

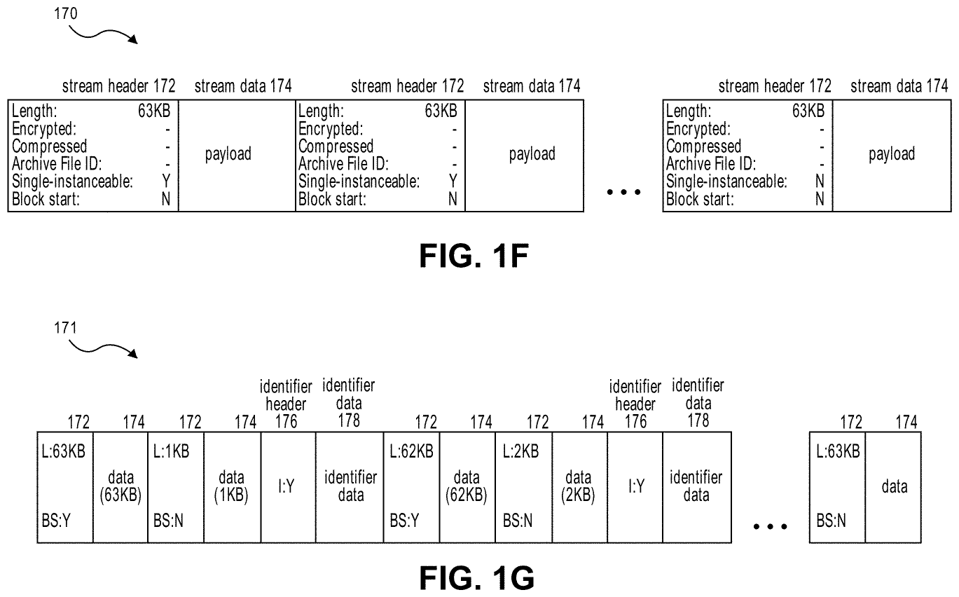

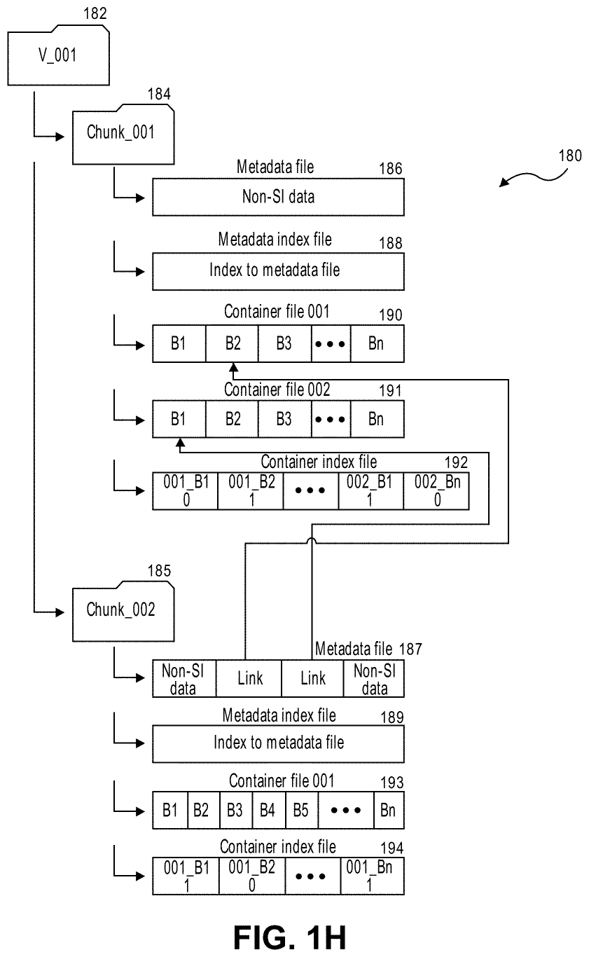

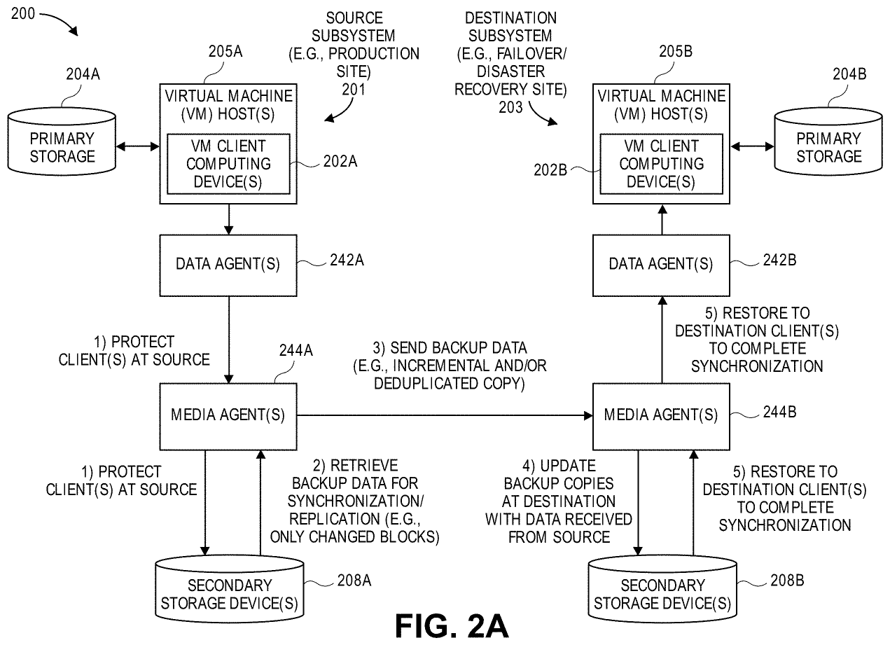

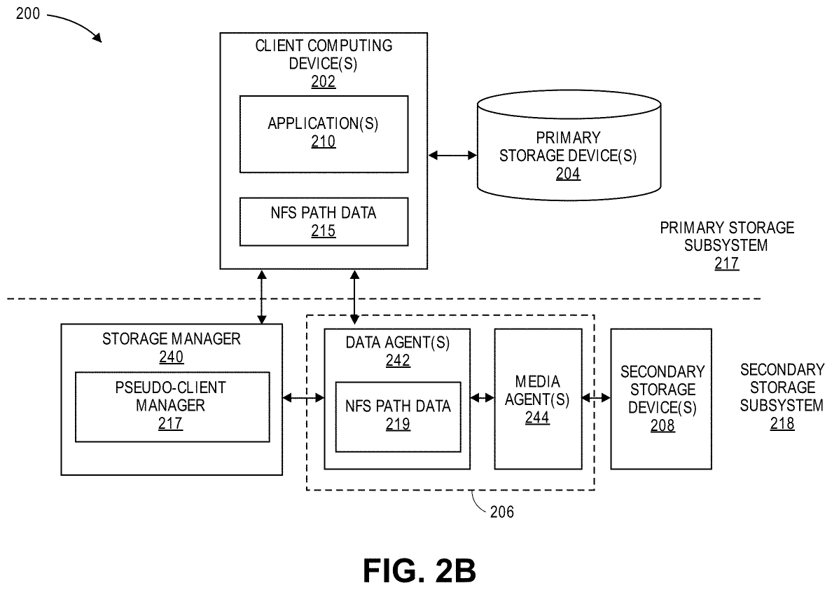

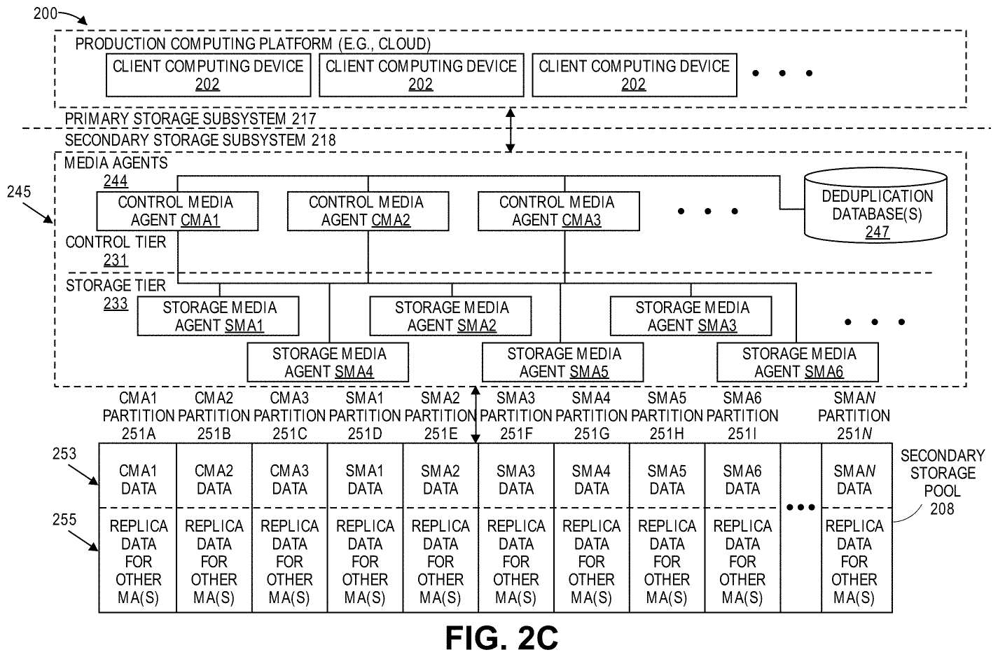

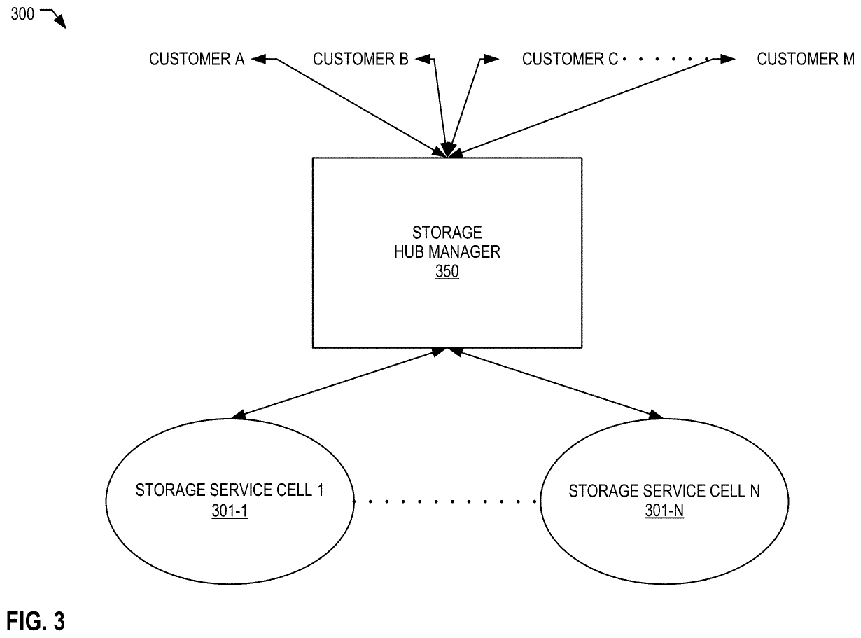

Detailed descriptions and examples of systems and methods according to one or more illustrative embodiments of the present invention may be found in the section entitled ILLUSTRATIVE EXPANDABLE DATA STORAGE MANAGEMENT SYSTEM, as well as in the section entitled Example Embodiments, and also in FIGS. 3-10C herein. Furthermore, some components and certain functionality for the illustrative expandable data storage management system may be adapted, configured, and/or incorporated into information management systems such as those described herein in FIGS. 1A-1H and 2A-2C.

Various embodiments described herein are intimately tied to, enabled by, and would not exist except for, computer technology. For example, rules for expandability of the illustrative expandable data storage management system, for assigning customers to certain storage service cells, and for tracking and sharing information among system components as described herein in reference to various embodiments cannot reasonably be performed by humans alone, without the computer technology upon which they are implemented.

### Information Management System Overview

With the increasing importance of protecting and leveraging data, organizations simply cannot risk losing critical data. Moreover, runaway data growth and other modern realities make protecting and managing data increasingly difficult. There is therefore a need for efficient, powerful, and user-friendly solutions for protecting and managing data and for smart and efficient management of data storage. Depending on the size of the organization, there may be many data production sources which are under the purview of tens, hundreds, or even thousands of individuals. In the past, individuals were sometimes responsible for managing and protecting their own data, and a patchwork of hardware and software point solutions may have been used in any given organization. These solutions were often provided by different vendors and had limited or no interoperability. Certain embodiments described herein address these and other shortcomings of prior approaches by implementing scalable, unified, organization-wide information management, including data storage management.

FIG. 1A shows one such information management system 100 (or “system 100”), which generally includes combinations of hardware and software configured to protect and manage data and metadata that are generated and used by computing devices in system 100. System 100 may be referred to in some embodiments as a “storage management system” or a “data storage management system.” System 100 performs information management operations, some of which may be referred to as “storage operations” or “data storage operations,” to protect and manage the data residing in and/or managed by system 100. The organization that employs system 100 may be a corporation or other business entity, non-profit organization, educational institution, household, governmental agency, or the like.

Generally, the systems and associated components described herein may be compatible with and/or provide some or all of the functionality of the systems and corresponding components described in one or more of the following U.S. patents/publications and patent applications assigned to Commvault Systems, Inc., each of which is hereby incorporated by reference in its entirety herein:
U.S. Pat. No. 7,035,880, entitled “Modular Backup and Retrieval System Used in Conjunction With a Storage Area Network”;
U.S. Pat. No. 7,107,298, entitled “System And Method For Archiving Objects In An Information Store”;
U.S. Pat. No. 7,246,207, entitled “System and Method for Dynamically Performing Storage Operations in a Computer Network”;
U.S. Pat. No. 7,315,923, entitled “System And Method For Combining Data Streams In Pipelined Storage Operations In A Storage Network”;
U.S. Pat. No. 7,343,453, entitled “Hierarchical Systems and Methods for Providing a Unified View of Storage Information”;
U.S. Pat. No. 7,395,282, entitled “Hierarchical Backup and Retrieval System”;
U.S. Pat. No. 7,529,782, entitled “System and Methods for Performing a Snapshot and for Restoring Data”;
U.S. Pat. No. 7,617,262, entitled “System and Methods for Monitoring Application Data in a Data Replication System”;
U.S. Pat. No. 7,734,669, entitled “Managing Copies Of Data”;
U.S. Pat. No. 7,747,579, entitled “Metabase for Facilitating Data Classification”;
U.S. Pat. No. 8,156,086, entitled “Systems And Methods For Stored Data Verification”;
U.S. Pat. No. 8,170,995, entitled “Method and System for Offline Indexing of Content and Classifying Stored Data”;
U.S. Pat. No. 8,230,195, entitled “System And Method For Performing Auxiliary Storage Operations”;
U.S. Pat. No. 8,285,681, entitled “Data Object Store and Server for a Cloud Storage Environment, Including Data Deduplication and Data Management Across Multiple Cloud Storage Sites”;
U.S. Pat. No. 8,307,177, entitled “Systems And Methods For Management Of Virtualization Data”;
U.S. Pat. No. 8,364,652, entitled “Content-Aligned, Block-Based Deduplication”;
U.S. Pat. No. 8,578,120, entitled “Block-Level Single Instancing”;
U.S. Pat. No. 8,954,446, entitled “Client-Side Repository in a Networked Deduplicated Storage System”;
U.S. Pat. No. 9,020,900, entitled “Distributed Deduplicated Storage System”;
U.S. Pat. No. 9,098,495, entitled “Application-Aware and Remote Single Instance Data Management”;
U.S. Pat. No. 9,239,687, entitled “Systems and Methods for Retaining and Using Data Block Signatures in Data Protection Operations”;
U.S. Pat. No. 9,633,033 entitled “High Availability Distributed Deduplicated Storage System”;
U.S. Pat. No. 9,766,825 entitled “Browse and Restore for Block-Level Backups”.
U.S. Pat. No. 9,852,026 entitled “Efficient Application Recovery in an Information Management System Based on a Pseudo-Storage-Device Driver”;
U.S. Pat. No. 10,228,962 “Live Synchronization and Management of Virtual Machines across Computing and Virtualization Platforms and Using Live Synchronization to Support Disaster Recovery;
U.S. Pat. No. 10,387,266 entitled “Application-Level Live Synchronization Across Computing Platforms Including Synchronizing Co-Resident Applications To Disparate Standby Destinations And Selectively Synchronizing Some Applications And Not Others;
U.S. Pat. No. 10,684,924 entitled “Data Restoration Operations Based on Network Path Information”; and
U.S. Pat. Pub. No. 2006/0224846, entitled “System and Method to Support Single Instance Storage Operations” now abandoned;
U.S. Pat. Pub. No. 2016/0350391 entitled “Replication Using Deduplicated Secondary Copy Data” now abandoned;
U.S. Pat. Pub. No. 2017/0235647 entitled “Data Protection Operations Based on Network Path Information” now abandoned.

System 100 includes computing devices and computing technologies. For instance, system 100 can include one or more client computing devices 102 and secondary storage computing devices 106, as well as storage manager 140 or a host computing device for it. Computing devices can include, without limitation, one or more: workstations, personal computers, desktop computers, or other types of generally fixed computing systems such as mainframe computers, servers, and minicomputers. Other computing devices can include mobile or portable computing devices, such as one or more laptops, tablet computers, personal data assistants, mobile phones (such as smartphones), and other mobile or portable computing devices such as embedded computers, set top boxes, vehicle-mounted devices, wearable computers, etc. Servers can include mail servers, file servers, database servers, virtual machine servers, and web servers. Any given computing device comprises one or more processors (e.g., CPU and/or single-core or multi-core processors), as well as corresponding non-transitory computer memory (e.g., random-access memory (RAM)) for storing computer programs which are to be executed by the one or more processors. Other computer memory for mass storage of data may be packaged/configured with the computing device (e.g., an internal hard disk) and/or may be external and accessible by the computing device (e.g., network-attached storage, a storage array, etc.). In some cases, a computing device includes cloud computing resources, which may be implemented as virtual machines. For instance, one or more virtual machines may be provided to the organization by a third-party cloud service vendor.

In some embodiments, computing devices can include one or more virtual machine(s) running on a physical host computing device (or “host machine”) operated by the organization. As one example, the organization may use one virtual machine as a database server and another virtual machine as a mail server, both virtual machines operating on the same host machine. A Virtual machine (“VM”) is a software implementation of a computer that does not physically exist and is instead instantiated in an operating system of a physical computer (or host machine) to enable applications to execute within the VM's environment, i.e., a VM emulates a physical computer. AVM includes an operating system and associated virtual resources, such as computer memory and processor(s). A hypervisor operates between the VM and the hardware of the physical host machine and is generally responsible for creating and running the VMs. Hypervisors are also known in the art as virtual machine monitors or a virtual machine managers or “VMMs”, and may be implemented in software, firmware, and/or specialized hardware installed on the host machine. Examples of hypervisors include ESX Server, by VMware, Inc. of Palo Alto, Calif.; Microsoft Virtual Server and Microsoft Windows Server Hyper-V, both by Microsoft Corporation of Redmond, Wash.; Sun xVM by Oracle America Inc. of Santa Clara, Calif.; and Xen by Citrix Systems, Santa Clara, Calif. The hypervisor provides resources to each virtual operating system such as a virtual processor, virtual memory, a virtual network device, and a virtual disk. Each virtual machine has one or more associated virtual disks. The hypervisor typically stores the data of virtual disks in files on the file system of the physical host machine, called virtual machine disk files (“VMDK” in VMware lingo) or virtual hard disk image files (in Microsoft lingo). For example, VMware's ESX Server provides the Virtual Machine File System (VMFS) for the storage of virtual machine disk files. A virtual machine reads data from and writes data to its virtual disk much the way that a physical machine reads data from and writes data to a physical disk. Examples of techniques for implementing information management in a cloud computing environment are described in U.S. Pat. No. 8,285,681. Examples of techniques for implementing information management in a virtualized computing environment are described in U.S. Pat. No. 8,307,177.

Information management system 100 can also include electronic data storage devices, generally used for mass storage of data, including, e.g., primary storage devices 104 and secondary storage devices 108. Storage devices can generally be of any suitable type including, without limitation, disk drives, storage arrays (e.g., storage-area network (SAN) and/or network-attached storage (NAS) technology), semiconductor memory (e.g., solid state storage devices), network attached storage (NAS) devices, tape libraries, or other magnetic, non-tape storage devices, optical media storage devices, combinations of the same, etc. In some embodiments, storage devices form part of a distributed file system. In some cases, storage devices are provided in a cloud storage environment (e.g., a private cloud or one operated by a third-party vendor), whether for primary data or secondary copies or both.

Depending on context, the term “information management system” can refer to generally all of the illustrated hardware and software components in FIG. 1C, or the term may refer to only a subset of the illustrated components. For instance, in some cases, system 100 generally refers to a combination of specialized components used to protect, move, manage, manipulate, analyze, and/or process data and metadata generated by client computing devices 102. However, system 100 in some cases does not include the underlying components that generate and/or store primary data 112, such as the client computing devices 102 themselves, and the primary storage devices 104. Likewise, secondary storage devices 108 (e.g., a third-party provided cloud storage environment) may not be part of system 100. As an example, “information management system” or “storage management system” may sometimes refer to one or more of the following components, which will be described in further detail below: storage manager, data agent, and media agent.

One or more client computing devices 102 may be part of system 100, each client computing device 102 having an operating system and at least one application 110 and one or more accompanying data agents executing thereon; and associated with one or more primary storage devices 104 storing primary data 112. Client computing device(s) 102 and primary storage devices 104 may generally be referred to in some cases as primary storage subsystem 117.

### Client Computing Devices, Clients, and Subclients

Typically, a variety of sources in an organization produce data to be protected and managed. As just one illustrative example, in a corporate environment such data sources can be employee workstations and company servers such as a mail server, a web server, a database server, a transaction server, or the like. In system 100, data generation sources include one or more client computing devices 102. A computing device that has a data agent 142 installed and operating on it is generally referred to as a “client computing device” 102, and may include any type of computing device, without limitation. A client computing device 102 may be associated with one or more users and/or user accounts.

A “client” is a logical component of information management system 100, which may represent a logical grouping of one or more data agents installed on a client computing device 102. Storage manager 140 recognizes a client as a component of system 100, and in some embodiments, may automatically create a client component the first time a data agent 142 is installed on a client computing device 102. Because data generated by executable component(s) 110 is tracked by the associated data agent 142 so that it may be properly protected in system 100, a client may be said to generate data and to store the generated data to primary storage, such as primary storage device 104. However, the terms “client” and “client computing device” as used herein do not imply that a client computing device 102 is necessarily configured in the client/server sense relative to another computing device such as a mail server, or that a client computing device 102 cannot be a server in its own right. As just a few examples, a client computing device 102 can be and/or include mail servers, file servers, database servers, virtual machine servers, and/or web servers.

Each client computing device 102 may have application(s) 110 executing thereon which generate and manipulate the data that is to be protected from loss and managed in system 100. Applications 110 generally facilitate the operations of an organization, and can include, without limitation, mail server applications (e.g., Microsoft Exchange Server), file system applications, mail client applications (e.g., Microsoft Exchange Client), database applications or database management systems (e.g., SQL, Oracle, SAP, Lotus Notes Database), word processing applications (e.g., Microsoft Word), spreadsheet applications, financial applications, presentation applications, graphics and/or video applications, browser applications, mobile applications, entertainment applications, and so on. Each application 110 may be accompanied by an application-specific data agent 142, though not all data agents 142 are application-specific or associated with only application. A file manager application, e.g., Microsoft Windows Explorer, may be considered an application 110 and may be accompanied by its own data agent 142. Client computing devices 102 can have at least one operating system (e.g., Microsoft Windows, Mac OS X, iOS, IBM z/OS, Linux, other Unix-based operating systems, etc.) installed thereon, which may support or host one or more file systems and other applications 110. In some embodiments, a virtual machine that executes on a host client computing device 102 may be considered an application 110 and may be accompanied by a specific data agent 142 (e.g., virtual server data agent).

Client computing devices 102 and other components in system 100 can be connected to one another via one or more electronic communication pathways 114. For example, a first communication pathway 114 may communicatively couple client computing device 102 and secondary storage computing device 106; a second communication pathway 114 may communicatively couple storage manager 140 and client computing device 102; and a third communication pathway 114 may communicatively couple storage manager 140 and secondary storage computing device 106, etc. (see, e.g., FIG. 1A and FIG. 1C). A communication pathway 114 can include one or more networks or other connection types including one or more of the following, without limitation: the Internet, a wide area network (WAN), a local area network (LAN), a Storage Area Network (SAN), a Fibre Channel (FC) connection, a Small Computer System Interface (SCSI) connection, a virtual private network (VPN), a token ring or TCP/IP based network, an intranet network, a point-to-point link, a cellular network, a wireless data transmission system, a two-way cable system, an interactive kiosk network, a satellite network, a broadband network, a baseband network, a neural network, a mesh network, an ad hoc network, other appropriate computer or telecommunications networks, combinations of the same or the like. Communication pathways 114 in some cases may also include application programming interfaces (APIs) including, e.g., cloud service provider APIs, virtual machine management APIs, and hosted service provider APIs. The underlying infrastructure of communication pathways 114 may be wired and/or wireless, analog and/or digital, or any combination thereof; and the facilities used may be private, public, third-party provided, or any combination thereof, without limitation.

A “subclient” is a logical grouping of all or part of a client's primary data 112. In general, a subclient may be defined according to how the subclient data is to be protected as a unit in system 100. For example, a subclient may be associated with a certain storage policy. A given client may thus comprise several subclients, each subclient associated with a different storage policy. For example, some files may form a first subclient that requires compression and deduplication and is associated with a first storage policy. Other files of the client may form a second subclient that requires a different retention schedule as well as encryption, and may be associated with a different, second storage policy. As a result, though the primary data may be generated by the same application 110 and may belong to one given client, portions of the data may be assigned to different subclients for distinct treatment by system 100. More detail on subclients is given in regard to storage policies below. Primary Data and Example Primary Storage Devices

Primary data 112 is generally production data or “live” data generated by the operating system and/or applications 110 executing on client computing device 102. Primary data 112 is generally stored on primary storage device(s) 104 and is organized via a file system operating on the client computing device 102. Thus, client computing device(s) 102 and corresponding applications 110 may create, access, modify, write, delete, and otherwise use primary data 112. Primary data 112 is generally in the native format of the source application 110. Primary data 112 is an initial or first stored body of data generated by the source application 110. Primary data 112 in some cases is created substantially directly from data generated by the corresponding source application 110. It can be useful in performing certain tasks to organize primary data 112 into units of different granularities. In general, primary data 112 can include files, directories, file system volumes, data blocks, extents, or any other hierarchies or organizations of data objects. As used herein, a “data object” can refer to (i) any file that is currently addressable by a file system or that was previously addressable by the file system (e.g., an archive file), and/or to (ii) a subset of such a file (e.g., a data block, an extent, etc.). Primary data 112 may include structured data (e.g., database files), unstructured data (e.g., documents), and/or semi-structured data. See, e.g., FIG. 1B.

It can also be useful in performing certain functions of system 100 to access and modify metadata within primary data 112. Metadata generally includes information about data objects and/or characteristics associated with the data objects. For simplicity herein, it is to be understood that, unless expressly stated otherwise, any reference to primary data 112 generally also includes its associated metadata, but references to metadata generally do not include the primary data. Metadata can include, without limitation, one or more of the following: the data owner (e.g., the client or user that generates the data), the last modified time (e.g., the time of the most recent modification of the data object), a data object name (e.g., a file name), a data object size (e.g., a number of bytes of data), information about the content (e.g., an indication as to the existence of a particular search term), user-supplied tags, to/from information for email (e.g., an email sender, recipient, etc.), creation date, file type (e.g., format or application type), last accessed time, application type (e.g., type of application that generated the data object), location/network (e.g., a current, past or future location of the data object and network pathways to/from the data object), geographic location (e.g., GPS coordinates), frequency of change (e.g., a period in which the data object is modified), business unit (e.g., a group or department that generates, manages or is otherwise associated with the data object), aging information (e.g., a schedule, such as a time period, in which the data object is migrated to secondary or long term storage), boot sectors, partition layouts, file location within a file folder directory structure, user permissions, owners, groups, access control lists (ACLs), system metadata (e.g., registry information), combinations of the same or other similar information related to the data object. In addition to metadata generated by or related to file systems and operating systems, some applications 110 and/or other components of system 100 maintain indices of metadata for data objects, e.g., metadata associated with individual email messages. The use of metadata to perform classification and other functions is described in greater detail below.

Primary storage devices 104 storing primary data 112 may be relatively fast and/or expensive technology (e.g., flash storage, a disk drive, a hard-disk storage array, solid state memory, etc.), typically to support high-performance live production environments. Primary data 112 may be highly changeable and/or may be intended for relatively short term retention (e.g., hours, days, or weeks). According to some embodiments, client computing device 102 can access primary data 112 stored in primary storage device 104 by making conventional file system calls via the operating system. Each client computing device 102 is generally associated with and/or in communication with one or more primary storage devices 104 storing corresponding primary data 112. A client computing device 102 is said to be associated with or in communication with a particular primary storage device 104 if it is capable of one or more of: routing and/or storing data (e.g., primary data 112) to the primary storage device 104, coordinating the routing and/or storing of data to the primary storage device 104, retrieving data from the primary storage device 104, coordinating the retrieval of data from the primary storage device 104, and modifying and/or deleting data in the primary storage device 104. Thus, a client computing device 102 may be said to access data stored in an associated storage device 104.

Primary storage device 104 may be dedicated or shared. In some cases, each primary storage device 104 is dedicated to an associated client computing device 102, e.g., a local disk drive. In other cases, one or more primary storage devices 104 can be shared by multiple client computing devices 102, e.g., via a local network, in a cloud storage implementation, etc. As one example, primary storage device 104 can be a storage array shared by a group of client computing devices 102, such as EMC Clariion, EMC Symmetrix, EMC Celerra, Dell EqualLogic, IBM XIV, NetApp FAS, HP EVA, and HP 3PAR.

System 100 may also include hosted services (not shown), which may be hosted in some cases by an entity other than the organization that employs the other components of system 100. For instance, the hosted services may be provided by online service providers. Such service providers can provide social networking services, hosted email services, or hosted productivity applications or other hosted applications such as software-as-a-service (SaaS), platform-as-a-service (PaaS), application service providers (ASPs), cloud services, or other mechanisms for delivering functionality via a network. As it services users, each hosted service may generate additional data and metadata, which may be managed by system 100, e.g., as primary data 112. In some cases, the hosted services may be accessed using one of the applications 110. As an example, a hosted mail service may be accessed via browser running on a client computing device 102.

### Secondary Copies and Example Secondary Storage Devices

Primary data 112 stored on primary storage devices 104 may be compromised in some cases, such as when an employee deliberately or accidentally deletes or overwrites primary data 112. Or primary storage devices 104 can be damaged, lost, or otherwise corrupted. For recovery and/or regulatory compliance purposes, it is therefore useful to generate and maintain copies of primary data 112. Accordingly, system 100 includes one or more secondary storage computing devices 106 and one or more secondary storage devices 108 configured to create and store one or more secondary copies 116 of primary data 112 including its associated metadata. The secondary storage computing devices 106 and the secondary storage devices 108 may be referred to as secondary storage subsystem 118.

Secondary copies 116 can help in search and analysis efforts and meet other information management goals as well, such as: restoring data and/or metadata if an original version is lost (e.g., by deletion, corruption, or disaster); allowing point-in-time recovery; complying with regulatory data retention and electronic discovery (e-discovery) requirements; reducing utilized storage capacity in the production system and/or in secondary storage; facilitating organization and search of data; improving user access to data files across multiple computing devices and/or hosted services; and implementing data retention and pruning policies.

A secondary copy 116 can comprise a separate stored copy of data that is derived from one or more earlier-created stored copies (e.g., derived from primary data 112 or from another secondary copy 116). Secondary copies 116 can include point-in-time data and may be intended for relatively long-term retention before some or all of the data is moved to other storage or discarded. In some cases, a secondary copy 116 may be in a different storage device than other previously stored copies; and/or may be remote from other previously stored copies. Secondary copies 116 can be stored in the same storage device as primary data 112. For example, a disk array capable of performing hardware snapshots stores primary data 112 and creates and stores hardware snapshots of the primary data 112 as secondary copies 116. Secondary copies 116 may be stored in relatively slow and/or lower cost storage (e.g., magnetic tape). A secondary copy 116 may be stored in a backup or archive format, or in some other format different from the native source application format or other format of primary data 112.

Secondary storage computing devices 106 may index secondary copies 116 (e.g., using a media agent 144), enabling users to browse and restore at a later time and further enabling the lifecycle management of the indexed data. After creation of a secondary copy 116 that represents certain primary data 112, a pointer or other location indicia (e.g., a stub) may be placed in primary data 112, or be otherwise associated with primary data 112, to indicate the current location of a particular secondary copy 116. Since an instance of a data object or metadata in primary data 112 may change over time as it is modified by application 110 (or hosted service or the operating system), system 100 may create and manage multiple secondary copies 116 of a particular data object or metadata, each copy representing the state of the data object in primary data 112 at a particular point in time. Moreover, since an instance of a data object in primary data 112 may eventually be deleted from primary storage device 104 and the file system, system 100 may continue to manage point-in-time representations of that data object, even though the instance in primary data 112 no longer exists. For virtual machines, the operating system and other applications 110 of client computing device(s) 102 may execute within or under the management of virtualization software (e.g., a VMM), and the primary storage device(s) 104 may comprise a virtual disk created on a physical storage device. System 100 may create secondary copies 116 of the files or other data objects in a virtual disk file and/or secondary copies 116 of the entire virtual disk file itself (e.g., of an entire .vmdk file).

Secondary copies 116 are distinguishable from corresponding primary data 112. First, secondary copies 116 can be stored in a different format from primary data 112 (e.g., backup, archive, or another non-native format). For this or other reasons, secondary copies 116 may not be directly usable by applications 110 or client computing device 102 (e.g., via standard system calls or otherwise) without modification, processing, or other intervention by system 100 which may be referred to as “restore” operations. Secondary copies 116 may have been processed by data agent 142 and/or media agent 144 in the course of being created (e.g., compression, deduplication, encryption, integrity markers, indexing, formatting, application-aware metadata, etc.), and thus secondary copy 116 may represent source primary data 112 without necessarily being exactly identical to the source.

Second, secondary copies 116 may be stored on a secondary storage device 108 that is inaccessible to application 110 running on client computing device 102 and/or hosted service. Some secondary copies 116 may be “offline copies,” in that they are not readily available (e.g., not mounted to tape or disk). Offline copies can include copies of data that system 100 can access without human intervention (e.g., tapes within an automated tape library, but not yet mounted in a drive), and copies that the system 100 can access only with some human intervention (e.g., tapes located at an offsite storage site).

### Using Intermediate Devices for Creating Secondary Copies—Secondary Storage Computing Devices

Creating secondary copies can be challenging when hundreds or thousands of client computing devices 102 continually generate large volumes of primary data 112 to be protected. Also, there can be significant overhead involved in the creation of secondary copies 116. Moreover, specialized programmed intelligence and/or hardware capability is generally needed for accessing and interacting with secondary storage devices 108. Client computing devices 102 may interact directly with a secondary storage device 108 to create secondary copies 116, but in view of the factors described above, this approach can negatively impact the ability of client computing device 102 to serve/service application 110 and produce primary data 112. Further, any given client computing device 102 may not be optimized for interaction with certain secondary storage devices 108.

Thus, system 100 may include one or more software and/or hardware components which generally act as intermediaries between client computing devices 102 (that generate primary data 112) and secondary storage devices 108 (that store secondary copies 116). In addition to off-loading certain responsibilities from client computing devices 102, these intermediate components provide other benefits. For instance, as discussed further below with respect to FIG. 1D, distributing some of the work involved in creating secondary copies 116 can enhance scalability and improve system performance. For instance, using specialized secondary storage computing devices 106 and media agents 144 for interfacing with secondary storage devices 108 and/or for performing certain data processing operations can greatly improve the speed with which system 100 performs information management operations and can also improve the capacity of the system to handle large numbers of such operations, while reducing the computational load on the production environment of client computing devices 102. The intermediate components can include one or more secondary storage computing devices 106 as shown in FIG. 1A and/or one or more media agents 144. Media agents are discussed further below (e.g., with respect to FIGS. 1C-1E). These special-purpose components of system 100 comprise specialized programmed intelligence and/or hardware capability for writing to, reading from, instructing, communicating with, or otherwise interacting with secondary storage devices 108.

Secondary storage computing device(s) 106 can comprise any of the computing devices described above, without limitation. In some cases, secondary storage computing device(s) 106 also include specialized hardware componentry and/or software intelligence (e.g., specialized interfaces) for interacting with certain secondary storage device(s) 108 with which they may be specially associated.

To create a secondary copy 116 involving the copying of data from primary storage subsystem 117 to secondary storage subsystem 118, client computing device 102 may communicate the primary data 112 to be copied (or a processed version thereof generated by a data agent 142) to the designated secondary storage computing device 106, via a communication pathway 114. Secondary storage computing device 106 in turn may further process and convey the data or a processed version thereof to secondary storage device 108. One or more secondary copies 116 may be created from existing secondary copies 116, such as in the case of an auxiliary copy operation, described further below.

### Example Primary Data and an Example Secondary Copy

FIG. 1B is a detailed view of some specific examples of primary data stored on primary storage device(s) 104 and secondary copy data stored on secondary storage device(s) 108, with other components of the system removed for the purposes of illustration. Stored on primary storage device(s) 104 are primary data 112 objects including word processing documents 119A-B, spreadsheets 120, presentation documents 122, video files 124, image files 126, email mailboxes 128 (and corresponding email messages 129A-C), HTML/XML or other types of markup language files 130, databases 132 and corresponding tables or other data structures 133A-133C. Some or all primary data 112 objects are associated with corresponding metadata (e.g., “Meta1-11”), which may include file system metadata and/or application-specific metadata. Stored on the secondary storage device(s) 108 are secondary copy 116 data objects 134A-C which may include copies of or may otherwise represent corresponding primary data 112.

Secondary copy data objects 134A-C can individually represent more than one primary data object. For example, secondary copy data object 134A represents three separate primary data objects 133C, 122, and 129C (represented as 133C′, 122′, and 129C′, respectively, and accompanied by corresponding metadata Meta11, Meta3, and Meta8, respectively). Moreover, as indicated by the prime mark (′), secondary storage computing devices 106 or other components in secondary storage subsystem 118 may process the data received from primary storage subsystem 117 and store a secondary copy including a transformed and/or supplemented representation of a primary data object and/or metadata that is different from the original format, e.g., in a compressed, encrypted, deduplicated, or other modified format. For instance, secondary storage computing devices 106 can generate new metadata or other information based on said processing and store the newly generated information along with the secondary copies. Secondary copy data object 1346 represents primary data objects 120, 1336, and 119A as 120′, 1336′, and 119A′, respectively, accompanied by corresponding metadata Meta2, Meta10, and Meta1, respectively. Also, secondary copy data object 134C represents primary data objects 133A, 1196, and 129A as 133A′, 1196′, and 129A′, respectively, accompanied by corresponding metadata Meta9, Meta5, and Meta6, respectively.

### Example Information Management System Architecture

System 100 can incorporate a variety of different hardware and software components, which can in turn be organized with respect to one another in many different configurations, depending on the embodiment. There are critical design choices involved in specifying the functional responsibilities of the components and the role of each component in system 100. Such design choices can impact how system 100 performs and adapts to data growth and other changing circumstances. FIG. 1C shows a system 100 designed according to these considerations and includes: storage manager 140, one or more data agents 142 executing on client computing device(s) 102 and configured to process primary data 112, and one or more media agents 144 executing on one or more secondary storage computing devices 106 for performing tasks involving secondary storage devices 108.

### Storage Manager

Storage manager 140 is a centralized storage and/or information manager that is configured to perform certain control functions and also to store certain critical information about system 100—hence storage manager 140 is said to manage system 100. As noted, the number of components in system 100 and the amount of data under management can be large. Managing the components and data is therefore a significant task, which can grow unpredictably as the number of components and data scale to meet the needs of the organization. For these and other reasons, according to certain embodiments, responsibility for controlling system 100, or at least a significant portion of that responsibility, is allocated to storage manager 140. Storage manager 140 can be adapted independently according to changing circumstances, without having to replace or re-design the remainder of the system. Moreover, a computing device for hosting and/or operating as storage manager 140 can be selected to best suit the functions and networking needs of storage manager 140. These and other advantages are described in further detail below and with respect to FIG. 1D.

Storage manager 140 may be a software module or other application hosted by a suitable computing device. In some embodiments, storage manager 140 is itself a computing device that performs the functions described herein. Storage manager 140 comprises or operates in conjunction with one or more associated data structures such as a dedicated database (e.g., management database 146), depending on the configuration. The storage manager 140 generally initiates, performs, coordinates, and/or controls storage and other information management operations performed by system 100, e.g., to protect and control primary data 112 and secondary copies 116. In general, storage manager 140 is said to manage system 100, which includes communicating with, instructing, and controlling in some circumstances components such as data agents 142 and media agents 144, etc.

As shown by the dashed arrowed lines 114 in FIG. 1C, storage manager 140 may communicate with, instruct, and/or control some or all elements of system 100, such as data agents 142 and media agents 144. In this manner, storage manager 140 manages the operation of various hardware and software components in system 100. In certain embodiments, control information originates from storage manager 140 and status as well as index reporting is transmitted to storage manager 140 by the managed components, whereas payload data and metadata are generally communicated between data agents 142 and media agents 144 (or otherwise between client computing device(s) 102 and secondary storage computing device(s) 106), e.g., at the direction of and under the management of storage manager 140. Control information can generally include parameters and instructions for carrying out information management operations, such as, without limitation, instructions to perform a task associated with an operation, timing information specifying when to initiate a task, data path information specifying what components to communicate with or access in carrying out an operation, and the like. In other embodiments, some information management operations are controlled or initiated by other components of system 100 (e.g., by media agents 144 or data agents 142), instead of or in combination with storage manager 140.

According to certain embodiments, storage manager 140 provides one or more of the following functions:
communicating with data agents 142 and media agents 144, including transmitting instructions, messages, and/or queries, as well as receiving status reports, index information, messages, and/or queries, and responding to same;
initiating execution of information management operations;
initiating restore and recovery operations;
managing secondary storage devices 108 and inventory/capacity of the same;
allocating secondary storage devices 108 for secondary copy operations;
reporting, searching, and/or classification of data in system 100;
monitoring completion of and status reporting related to information management operations and jobs;
tracking movement of data within system 100;
tracking age information relating to secondary copies 116, secondary storage devices 108, comparing the age information against retention guidelines, and initiating data pruning when appropriate;
tracking logical associations between components in system 100;
protecting metadata associated with system 100, e.g., in management database 146;
implementing job management, schedule management, event management, alert management, reporting, job history maintenance, user security management, disaster recovery management, and/or user interfacing for system administrators and/or end users of system 100;
sending, searching, and/or viewing of log files; and
implementing operations management functionality.

Storage manager 140 may maintain an associated database 146 (or “storage manager database 146” or “management database 146”) of management-related data and information management policies 148. Database 146 is stored in computer memory accessible by storage manager 140. Database 146 may include a management index 150 (or “index 150”) or other data structure(s) that may store: logical associations between components of the system; user preferences and/or profiles (e.g., preferences regarding encryption, compression, or deduplication of primary data or secondary copies; preferences regarding the scheduling, type, or other aspects of secondary copy or other operations; mappings of particular information management users or user accounts to certain computing devices or other components, etc.; management tasks; media containerization; other useful data; and/or any combination thereof. For example, storage manager 140 may use index 150 to track logical associations between media agents 144 and secondary storage devices 108 and/or movement of data to/from secondary storage devices 108. For instance, index 150 may store data associating a client computing device 102 with a particular media agent 144 and/or secondary storage device 108, as specified in an information management policy 148.

Administrators and others may configure and initiate certain information management operations on an individual basis. But while this may be acceptable for some recovery operations or other infrequent tasks, it is often not workable for implementing on-going organization-wide data protection and management. Thus, system 100 may utilize information management policies 148 for specifying and executing information management operations on an automated basis. Generally, an information management policy 148 can include a stored data structure or other information source that specifies parameters (e.g., criteria and rules) associated with storage management or other information management operations. Storage manager 140 can process an information management policy 148 and/or index 150 and, based on the results, identify an information management operation to perform, identify the appropriate components in system 100 to be involved in the operation (e.g., client computing devices 102 and corresponding data agents 142, secondary storage computing devices 106 and corresponding media agents 144, etc.), establish connections to those components and/or between those components, and/or instruct and control those components to carry out the operation. In this manner, system 100 can translate stored information into coordinated activity among the various computing devices in system 100.

Management database 146 may maintain information management policies 148 and associated data, although information management policies 148 can be stored in computer memory at any appropriate location outside management database 146. For instance, an information management policy 148 such as a storage policy may be stored as metadata in a media agent database 152 or in a secondary storage device 108 (e.g., as an archive copy) for use in restore or other information management operations, depending on the embodiment. Information management policies 148 are described further below. According to certain embodiments, management database 146 comprises a relational database (e.g., an SQL database) for tracking metadata, such as metadata associated with secondary copy operations (e.g., what client computing devices 102 and corresponding subclient data were protected and where the secondary copies are stored and which media agent 144 performed the storage operation(s)). This and other metadata may additionally be stored in other locations, such as at secondary storage computing device 106 or on the secondary storage device 108, allowing data recovery without the use of storage manager 140 in some cases. Thus, management database 146 may comprise data needed to kick off secondary copy operations (e.g., storage policies, schedule policies, etc.), status and reporting information about completed jobs (e.g., status and error reports on yesterday's backup jobs), and additional information sufficient to enable restore and disaster recovery operations (e.g., media agent associations, location indexing, content indexing, etc.).

Storage manager 140 may include a jobs agent 156, a user interface 158, and a management agent 154, all of which may be implemented as interconnected software modules or application programs. These are described further below.

Jobs agent 156 in some embodiments initiates, controls, and/or monitors the status of some or all information management operations previously performed, currently being performed, or scheduled to be performed by system 100. A job is a logical grouping of information management operations such as daily storage operations scheduled for a certain set of subclients (e.g., generating incremental block-level backup copies 116 at a certain time every day for database files in a certain geographical location). Thus, jobs agent 156 may access information management policies 148 (e.g., in management database 146) to determine when, where, and how to initiate/control jobs in system 100.

Storage Manager User Interfaces

User interface 158 may include information processing and display software, such as a graphical user interface (GUI), an application program interface (API), and/or other interactive interface(s) through which users and system processes can retrieve information about the status of information management operations or issue instructions to storage manager 140 and other components. Via user interface 158, users may issue instructions to the components in system 100 regarding performance of secondary copy and recovery operations. For example, a user may modify a schedule concerning the number of pending secondary copy operations. As another example, a user may employ the GUI to view the status of pending secondary copy jobs or to monitor the status of certain components in system 100 (e.g., the amount of capacity left in a storage device). Storage manager 140 may track information that permits it to select, designate, or otherwise identify content indices, deduplication databases, or similar databases or resources or data sets within its information management cell (or another cell) to be searched in response to certain queries. Such queries may be entered by the user by interacting with user interface 158.

Various embodiments of information management system 100 may be configured and/or designed to generate user interface data usable for rendering the various interactive user interfaces described. The user interface data may be used by system 100 and/or by another system, device, and/or software program (for example, a browser program), to render the interactive user interfaces. The interactive user interfaces may be displayed on, for example, electronic displays (including, for example, touch-enabled displays), consoles, etc., whether direct-connected to storage manager 140 or communicatively coupled remotely, e.g., via an internet connection. The present disclosure describes various embodiments of interactive and dynamic user interfaces, some of which may be generated by user interface agent 158, and which are the result of significant technological development. The user interfaces described herein may provide improved human-computer interactions, allowing for significant cognitive and ergonomic efficiencies and advantages over previous systems, including reduced mental workloads, improved decision-making, and the like. User interface 158 may operate in a single integrated view or console (not shown). The console may support a reporting capability for generating a variety of reports, which may be tailored to a particular aspect of information management.

User interfaces are not exclusive to storage manager 140 and in some embodiments a user may access information locally from a computing device component of system 100. For example, some information pertaining to installed data agents 142 and associated data streams may be available from client computing device 102. Likewise, some information pertaining to media agents 144 and associated data streams may be available from secondary storage computing device 106.

Storage Manager Management Agent

Management agent 154 can provide storage manager 140 with the ability to communicate with other components within system 100 and/or with other information management cells via network protocols and application programming interfaces (APIs) including, e.g., HTTP, HTTPS, FTP, REST, virtualization software APIs, cloud service provider APIs, and hosted service provider APIs, without limitation. Management agent 154 also allows multiple information management cells to communicate with one another. For example, system 100 in some cases may be one information management cell in a network of multiple cells adjacent to one another or otherwise logically related, e.g., in a WAN or LAN. With this arrangement, the cells may communicate with one another through respective management agents 154. Inter-cell communications and hierarchy is described in greater detail in e.g., U.S. Pat. No. 7,343,453.

Information Management Cell

An “information management cell” (or “storage operation cell” or “cell”) may generally include a logical and/or physical grouping of a combination of hardware and software components associated with performing information management operations on electronic data, typically one storage manager 140 and at least one data agent 142 (executing on a client computing device 102) and at least one media agent 144 (executing on a secondary storage computing device 106). For instance, the components shown in FIG. 1C may together form an information management cell. Thus, in some configurations, a system 100 may be referred to as an information management cell or a storage operation cell. A given cell may be identified by the identity of its storage manager 140, which is generally responsible for managing the cell.

Multiple cells may be organized hierarchically, so that cells may inherit properties from hierarchically superior cells or be controlled by other cells in the hierarchy (automatically or otherwise). Alternatively, in some embodiments, cells may inherit or otherwise be associated with information management policies, preferences, information management operational parameters, or other properties or characteristics according to their relative position in a hierarchy of cells. Cells may also be organized hierarchically according to function, geography, architectural considerations, or other factors useful or desirable in performing information management operations. For example, a first cell may represent a geographic segment of an enterprise, such as a Chicago office, and a second cell may represent a different geographic segment, such as a New York City office. Other cells may represent departments within a particular office, e.g., human resources, finance, engineering, etc. Where delineated by function, a first cell may perform one or more first types of information management operations (e.g., one or more first types of secondary copies at a certain frequency), and a second cell may perform one or more second types of information management operations (e.g., one or more second types of secondary copies at a different frequency and under different retention rules). In general, the hierarchical information is maintained by one or more storage managers 140 that manage the respective cells (e.g., in corresponding management database(s) 146).

Data Agents

A variety of different applications 110 can operate on a given client computing device 102, including operating systems, file systems, database applications, e-mail applications, and virtual machines, just to name a few. And, as part of the process of creating and restoring secondary copies 116, the client computing device 102 may be tasked with processing and preparing the primary data 112 generated by these various applications 110. Moreover, the nature of the processing/preparation can differ across application types, e.g., due to inherent structural, state, and formatting differences among applications 110 and/or the operating system of client computing device 102. Each data agent 142 is therefore advantageously configured in some embodiments to assist in the performance of information management operations based on the type of data that is being protected at a client-specific and/or application-specific level.

Data agent 142 is a component of information system 100 and is generally directed by storage manager 140 to participate in creating or restoring secondary copies 116. Data agent 142 may be a software program (e.g., in the form of a set of executable binary files) that executes on the same client computing device 102 as the associated application 110 that data agent 142 is configured to protect. Data agent 142 is generally responsible for managing, initiating, or otherwise assisting in the performance of information management operations in reference to its associated application(s) 110 and corresponding primary data 112 which is generated/accessed by the particular application(s) 110. For instance, data agent 142 may take part in copying, archiving, migrating, and/or replicating of certain primary data 112 stored in the primary storage device(s) 104. Data agent 142 may receive control information from storage manager 140, such as commands to transfer copies of data objects and/or metadata to one or more media agents 144. Data agent 142 also may compress, deduplicate, and encrypt certain primary data 112, as well as capture application-related metadata before transmitting the processed data to media agent 144. Data agent 142 also may receive instructions from storage manager 140 to restore (or assist in restoring) a secondary copy 116 from secondary storage device 108 to primary storage 104, such that the restored data may be properly accessed by application 110 in a suitable format as though it were primary data 112.

Each data agent 142 may be specialized for a particular application 110. For instance, different individual data agents 142 may be designed to handle Microsoft Exchange data, Lotus Notes data, Microsoft Windows file system data, Microsoft Active Directory Objects data, SQL Server data, SharePoint data, Oracle database data, SAP database data, virtual machines and/or associated data, and other types of data. A file system data agent, for example, may handle data files and/or other file system information. If a client computing device 102 has two or more types of data 112, a specialized data agent 142 may be used for each data type. For example, to backup, migrate, and/or restore all of the data on a Microsoft Exchange server, the client computing device 102 may use: (1) a Microsoft Exchange Mailbox data agent 142 to back up the Exchange mailboxes; (2) a Microsoft Exchange Database data agent 142 to back up the Exchange databases; (3) a Microsoft Exchange Public Folder data agent 142 to back up the Exchange Public Folders; and (4) a Microsoft Windows File System data agent 142 to back up the file system of client computing device 102. In this example, these specialized data agents 142 are treated as four separate data agents 142 even though they operate on the same client computing device 102. Other examples may include archive management data agents such as a migration archiver or a compliance archiver, Quick Recovery® agents, and continuous data replication agents. Application-specific data agents 142 can provide improved performance as compared to generic agents. For instance, because application-specific data agents 142 may only handle data for a single software application, the design, operation, and performance of the data agent 142 can be streamlined. The data agent 142 may therefore execute faster and consume less persistent storage and/or operating memory than data agents designed to generically accommodate multiple different software applications 110.

Each data agent 142 may be configured to access data and/or metadata stored in the primary storage device(s) 104 associated with data agent 142 and its host client computing device 102 and process the data appropriately. For example, during a secondary copy operation, data agent 142 may arrange or assemble the data and metadata into one or more files having a certain format (e.g., a particular backup or archive format) before transferring the file(s) to a media agent 144 or another component. The file(s) may include a list of files or other metadata. In some embodiments, a data agent 142 may be distributed between client computing device 102 and storage manager 140 (and any other intermediate components) or may be deployed from a remote location or its functions approximated by a remote process that performs some or all of the functions of data agent 142. In addition, a data agent 142 may perform some functions provided by media agent 144. Other embodiments may employ one or more generic data agents 142 that can handle and process data from two or more different applications 110, or that can handle and process multiple data types, instead of or in addition to using specialized data agents 142. For example, one generic data agent 142 may be used to back up, migrate and restore Microsoft Exchange Mailbox data and Microsoft Exchange Database data, while another generic data agent may handle Microsoft Exchange Public Folder data and Microsoft Windows File System data.

Media Agents

As noted, off-loading certain responsibilities from client computing devices 102 to intermediate components such as secondary storage computing device(s) 106 and corresponding media agent(s) 144 can provide a number of benefits including improved performance of client computing device 102, faster and more reliable information management operations, and enhanced scalability. In one example which will be discussed further below, media agent 144 can act as a local cache of recently-copied data and/or metadata stored to secondary storage device(s) 108, thus improving restore capabilities and performance for the cached data.

Media agent 144 is a component of system 100 and is generally directed by storage manager 140 in creating and restoring secondary copies 116. Whereas storage manager 140 generally manages system 100 as a whole, media agent 144 provides a portal to certain secondary storage devices 108, such as by having specialized features for communicating with and accessing certain associated secondary storage device 108. Media agent 144 may be a software program (e.g., in the form of a set of executable binary files) that executes on a secondary storage computing device 106. Media agent 144 generally manages, coordinates, and facilitates the transmission of data between a data agent 142 (executing on client computing device 102) and secondary storage device(s) 108 associated with media agent 144. For instance, other components in the system may interact with media agent 144 to gain access to data stored on associated secondary storage device(s) 108, (e.g., to browse, read, write, modify, delete, or restore data). Moreover, media agents 144 can generate and store information relating to characteristics of the stored data and/or metadata, or can generate and store other types of information that generally provides insight into the contents of the secondary storage devices 108—generally referred to as indexing of the stored secondary copies 116. Each media agent 144 may operate on a dedicated secondary storage computing device 106, while in other embodiments a plurality of media agents 144 may operate on the same secondary storage computing device 106.

A media agent 144 may be associated with a particular secondary storage device 108 if that media agent 144 is capable of one or more of: routing and/or storing data to the particular secondary storage device 108; coordinating the routing and/or storing of data to the particular secondary storage device 108; retrieving data from the particular secondary storage device 108; coordinating the retrieval of data from the particular secondary storage device 108; and modifying and/or deleting data retrieved from the particular secondary storage device 108. Media agent 144 in certain embodiments is physically separate from the associated secondary storage device 108. For instance, a media agent 144 may operate on a secondary storage computing device 106 in a distinct housing, package, and/or location from the associated secondary storage device 108. In one example, a media agent 144 operates on a first server computer and is in communication with a secondary storage device(s) 108 operating in a separate rack-mounted RAID-based system.

A media agent 144 associated with a particular secondary storage device 108 may instruct secondary storage device 108 to perform an information management task. For instance, a media agent 144 may instruct a tape library to use a robotic arm or other retrieval means to load or eject a certain storage media, and to subsequently archive, migrate, or retrieve data to or from that media, e.g., for the purpose of restoring data to a client computing device 102. As another example, a secondary storage device 108 may include an array of hard disk drives or solid state drives organized in a RAID configuration, and media agent 144 may forward a logical unit number (LUN) and other appropriate information to the array, which uses the received information to execute the desired secondary copy operation. Media agent 144 may communicate with a secondary storage device 108 via a suitable communications link, such as a SCSI or Fibre Channel link.

Each media agent 144 may maintain an associated media agent database 152. Media agent database 152 may be stored to a disk or other storage device (not shown) that is local to the secondary storage computing device 106 on which media agent 144 executes. In other cases, media agent database 152 is stored separately from the host secondary storage computing device 106. Media agent database 152 can include, among other things, a media agent index 153 (see, e.g., FIG. 1C). In some cases, media agent index 153 does not form a part of and is instead separate from media agent database 152.

Media agent index 153 (or “index 153”) may be a data structure associated with the particular media agent 144 that includes information about the stored data associated with the particular media agent and which may be generated in the course of performing a secondary copy operation or a restore. Index 153 provides a fast and efficient mechanism for locating/browsing secondary copies 116 or other data stored in secondary storage devices 108 without having to access secondary storage device 108 to retrieve the information from there. For instance, for each secondary copy 116, index 153 may include metadata such as a list of the data objects (e.g., files/subdirectories, database objects, mailbox objects, etc.), a logical path to the secondary copy 116 on the corresponding secondary storage device 108, location information (e.g., offsets) indicating where the data objects are stored in the secondary storage device 108, when the data objects were created or modified, etc. Thus, index 153 includes metadata associated with the secondary copies 116 that is readily available for use from media agent 144. In some embodiments, some or all of the information in index 153 may instead or additionally be stored along with secondary copies 116 in secondary storage device 108. In some embodiments, a secondary storage device 108 can include sufficient information to enable a “bare metal restore,” where the operating system and/or software applications of a failed client computing device 102 or another target may be automatically restored without manually reinstalling individual software packages (including operating systems).

Because index 153 may operate as a cache, it can also be referred to as an “index cache.” In such cases, information stored in index cache 153 typically comprises data that reflects certain particulars about relatively recent secondary copy operations. After some triggering event, such as after some time elapses or index cache 153 reaches a particular size, certain portions of index cache 153 may be copied or migrated to secondary storage device 108, e.g., on a least-recently-used basis. This information may be retrieved and uploaded back into index cache 153 or otherwise restored to media agent 144 to facilitate retrieval of data from the secondary storage device(s) 108. In some embodiments, the cached information may include format or containerization information related to archives or other files stored on storage device(s) 108.

In some alternative embodiments media agent 144 generally acts as a coordinator or facilitator of secondary copy operations between client computing devices 102 and secondary storage devices 108 but does not actually write the data to secondary storage device 108. For instance, storage manager 140 (or media agent 144) may instruct a client computing device 102 and secondary storage device 108 to communicate with one another directly. In such a case, client computing device 102 transmits data directly or via one or more intermediary components to secondary storage device 108 according to the received instructions, and vice versa. Media agent 144 may still receive, process, and/or maintain metadata related to the secondary copy operations, i.e., may continue to build and maintain index 153. In these embodiments, payload data can flow through media agent 144 for the purposes of populating index 153, but not for writing to secondary storage device 108. Media agent 144 and/or other components such as storage manager 140 may in some cases incorporate additional functionality, such as data classification, content indexing, deduplication, encryption, compression, and the like. Further details regarding these and other functions are described below.

### Distributed, Scalable Architecture

As described, certain functions of system 100 can be distributed amongst various physical and/or logical components. For instance, one or more of storage manager 140, data agents 142, and media agents 144 may operate on computing devices that are physically separate from one another. This architecture can provide a number of benefits. For instance, hardware and software design choices for each distributed component can be targeted to suit its particular function. The secondary computing devices 106 on which media agents 144 operate can be tailored for interaction with associated secondary storage devices 108 and provide fast index cache operation, among other specific tasks. Similarly, client computing device(s) 102 can be selected to effectively service applications 110 in order to efficiently produce and store primary data 112.

Moreover, in some cases, one or more of the individual components of information management system 100 can be distributed to multiple separate computing devices. As one example, for large file systems where the amount of data stored in management database 146 is relatively large, database 146 may be migrated to or may otherwise reside on a specialized database server (e.g., an SQL server) separate from a server that implements the other functions of storage manager 140. This distributed configuration can provide added protection because database 146 can be protected with standard database utilities (e.g., SQL log shipping or database replication) independent from other functions of storage manager 140. Database 146 can be efficiently replicated to a remote site for use in the event of a disaster or other data loss at the primary site. Or database 146 can be replicated to another computing device within the same site, such as to a higher performance machine in the event that a storage manager host computing device can no longer service the needs of a growing system 100.

The distributed architecture also provides scalability and efficient component utilization. FIG. 1D shows an embodiment of information management system 100 including a plurality of client computing devices 102 and associated data agents 142 as well as a plurality of secondary storage computing devices 106 and associated media agents 144. Additional components can be added or subtracted based on the evolving needs of system 100. For instance, depending on where bottlenecks are identified, administrators can add additional client computing devices 102, secondary storage computing devices 106, and/or secondary storage devices 108. Moreover, where multiple fungible components are available, load balancing can be implemented to dynamically address identified bottlenecks. As an example, storage manager 140 may dynamically select which media agents 144 and/or secondary storage devices 108 to use for storage operations based on a processing load analysis of media agents 144 and/or secondary storage devices 108, respectively.

Where system 100 includes multiple media agents 144 (see, e.g., FIG. 1D), a first media agent 144 may provide failover functionality for a second failed media agent 144. In addition, media agents 144 can be dynamically selected to provide load balancing. Each client computing device 102 can communicate with, among other components, any of the media agents 144, e.g., as directed by storage manager 140. And each media agent 144 may communicate with, among other components, any of secondary storage devices 108, e.g., as directed by storage manager 140. Thus, operations can be routed to secondary storage devices 108 in a dynamic and highly flexible manner, to provide load balancing, failover, etc. Further examples of scalable systems capable of dynamic storage operations, load balancing, and failover are provided in U.S. Pat. No. 7,246,207.

While distributing functionality amongst multiple computing devices can have certain advantages, in other contexts it can be beneficial to consolidate functionality on the same computing device. In alternative configurations, certain components may reside and execute on the same computing device. As such, in other embodiments, one or more of the components shown in FIG. 1C may be implemented on the same computing device. In one configuration, a storage manager 140, one or more data agents 142, and/or one or more media agents 144 are all implemented on the same computing device. In other embodiments, one or more data agents 142 and one or more media agents 144 are implemented on the same computing device, while storage manager 140 is implemented on a separate computing device, etc. without limitation.

### Example Types of Information Management Operations, Including Storage Operations

In order to protect and leverage stored data, system 100 can be configured to perform a variety of information management operations, which may also be referred to in some cases as storage management operations or storage operations. These operations can generally include (i) data movement operations, (ii) processing and data manipulation operations, and (iii) analysis, reporting, and management operations.

Data Movement Operations, Including Secondary Copy Operations

Data movement operations are generally storage operations that involve the copying or migration of data between different locations in system 100. For example, data movement operations can include operations in which stored data is copied, migrated, or otherwise transferred from one or more first storage devices to one or more second storage devices, such as from primary storage device(s) 104 to secondary storage device(s) 108, from secondary storage device(s) 108 to different secondary storage device(s) 108, from secondary storage devices 108 to primary storage devices 104, or from primary storage device(s) 104 to different primary storage device(s) 104, or in some cases within the same primary storage device 104 such as within a storage array.

Data movement operations can include by way of example, backup operations, archive operations, information lifecycle management operations such as hierarchical storage management operations, replication operations (e.g., continuous data replication), snapshot operations, deduplication or single-instancing operations, auxiliary copy operations, disaster-recovery copy operations, and the like. As will be discussed, some of these operations do not necessarily create distinct copies. Nonetheless, some or all of these operations are generally referred to as “secondary copy operations” for simplicity because they involve secondary copies. Data movement also comprises restoring secondary copies.

Backup Operations

A backup operation creates a copy of a version of primary data 112 at a particular point in time (e.g., one or more files or other data units). Each subsequent backup copy 116 (which is a form of secondary copy 116) may be maintained independently of the first. A backup generally involves maintaining a version of the copied primary data 112 as well as backup copies 116. Further, a backup copy in some embodiments is generally stored in a form that is different from the native format, e.g., a backup format. This contrasts to the version in primary data 112 which may instead be stored in a format native to the source application(s) 110. In various cases, backup copies can be stored in a format in which the data is compressed, encrypted, deduplicated, and/or otherwise modified from the original native application format. For example, a backup copy may be stored in a compressed backup format that facilitates efficient long-term storage. Backup copies 116 can have relatively long retention periods as compared to primary data 112, which is generally highly changeable. Backup copies 116 may be stored on media with slower retrieval times than primary storage device 104. Some backup copies may have shorter retention periods than some other types of secondary copies 116, such as archive copies (described below). Backups may be stored at an offsite location.

Backup operations can include full backups, differential backups, incremental backups, “synthetic full” backups, and/or creating a “reference copy.” A full backup (or “standard full backup”) in some embodiments is generally a complete image of the data to be protected. However, because full backup copies can consume a relatively large amount of storage, it can be useful to use a full backup copy as a baseline and only store changes relative to the full backup copy afterwards.

A differential backup operation (or cumulative incremental backup operation) tracks and stores changes that occurred since the last full backup. Differential backups can grow quickly in size but can restore relatively efficiently because a restore can be completed in some cases using only the full backup copy and the latest differential copy.

An incremental backup operation generally tracks and stores changes since the most recent backup copy of any type, which can greatly reduce storage utilization. In some cases, however, restoring can be lengthy compared to full or differential backups because completing a restore operation may involve accessing a full backup in addition to multiple incremental backups.

Synthetic full backups generally consolidate data without directly backing up data from the client computing device. A synthetic full backup is created from the most recent full backup (i.e., standard or synthetic) and subsequent incremental and/or differential backups. The resulting synthetic full backup is identical to what would have been created had the last backup for the subclient been a standard full backup. Unlike standard full, incremental, and differential backups, however, a synthetic full backup does not actually transfer data from primary storage to the backup media, because it operates as a backup consolidator. A synthetic full backup extracts the index data of each participating subclient. Using this index data and the previously backed up user data images, it builds new full backup images (e.g., bitmaps), one for each subclient. The new backup images consolidate the index and user data stored in the related incremental, differential, and previous full backups into a synthetic backup file that fully represents the subclient (e.g., via pointers) but does not comprise all its constituent data.

Any of the above types of backup operations can be at the volume level, file level, or block level. Volume level backup operations generally involve copying of a data volume (e.g., a logical disk or partition) as a whole. In a file-level backup, information management system 100 generally tracks changes to individual files and includes copies of files in the backup copy. For block-level backups, files are broken into constituent blocks, and changes are tracked at the block level. Upon restore, system 100 reassembles the blocks into files in a transparent fashion. Far less data may actually be transferred and copied to secondary storage devices 108 during a file-level copy than a volume-level copy. Likewise, a block-level copy may transfer less data than a file-level copy, resulting in faster execution. However, restoring a relatively higher-granularity copy can result in longer restore times. For instance, when restoring a block-level copy, the process of locating and retrieving constituent blocks can sometimes take longer than restoring file-level backups.

A reference copy may comprise copy(ies) of selected objects from backed up data, typically to help organize data by keeping contextual information from multiple sources together, and/or help retain specific data for a longer period of time, such as for legal hold needs. A reference copy generally maintains data integrity, and when the data is restored, it may be viewed in the same format as the source data. In some embodiments, a reference copy is based on a specialized client, individual subclient and associated information management policies (e.g., storage policy, retention policy, etc.) that are administered within system 100.

Archive Operations

Because backup operations generally involve maintaining a version of the copied primary data 112 and also maintaining backup copies in secondary storage device(s) 108, they can consume significant storage capacity. To reduce storage consumption, an archive operation according to certain embodiments creates an archive copy 116 by both copying and removing source data. Or, seen another way, archive operations can involve moving some or all of the source data to the archive destination. Thus, data satisfying criteria for removal (e.g., data of a threshold age or size) may be removed from source storage. The source data may be primary data 112 or a secondary copy 116, depending on the situation. As with backup copies, archive copies can be stored in a format in which the data is compressed, encrypted, deduplicated, and/or otherwise modified from the format of the original application or source copy. In addition, archive copies may be retained for relatively long periods of time (e.g., years) and, in some cases are never deleted. In certain embodiments, archive copies may be made and kept for extended periods in order to meet compliance regulations.

Archiving can also serve the purpose of freeing up space in primary storage device(s) 104 and easing the demand on computational resources on client computing device 102. Similarly, when a secondary copy 116 is archived, the archive copy can therefore serve the purpose of freeing up space in the source secondary storage device(s) 108. Examples of data archiving operations are provided in U.S. Pat. No. 7,107,298.

Snapshot Operations

Snapshot operations can provide a relatively lightweight, efficient mechanism for protecting data. From an end-user viewpoint, a snapshot may be thought of as an “instant” image of primary data 112 at a given point in time and may include state and/or status information relative to an application 110 that creates/manages primary data 112. In one embodiment, a snapshot may generally capture the directory structure of an object in primary data 112 such as a file or volume or other data set at a particular moment in time and may also preserve file attributes and contents. A snapshot in some cases is created relatively quickly, e.g., substantially instantly, using a minimum amount of file space, but may still function as a conventional file system backup.

A “hardware snapshot” (or “hardware-based snapshot”) operation occurs where a target storage device (e.g., a primary storage device 104 or a secondary storage device 108) performs the snapshot operation in a self-contained fashion, substantially independently, using hardware, firmware and/or software operating on the storage device itself. For instance, the storage device may perform snapshot operations generally without intervention or oversight from any of the other components of the system 100, e.g., a storage array may generate an “array-created” hardware snapshot and may also manage its storage, integrity, versioning, etc. In this manner, hardware snapshots can off-load other components of system 100 from snapshot processing. An array may receive a request from another component to take a snapshot and then proceed to execute the “hardware snapshot” operations autonomously, preferably reporting success to the requesting component.

A “software snapshot” (or “software-based snapshot”) operation, on the other hand, occurs where a component in system 100 (e.g., client computing device 102, etc.) implements a software layer that manages the snapshot operation via interaction with the target storage device. For instance, the component executing the snapshot management software layer may derive a set of pointers and/or data that represents the snapshot. The snapshot management software layer may then transmit the same to the target storage device, along with appropriate instructions for writing the snapshot. One example of a software snapshot product is Microsoft Volume Snapshot Service (VSS), which is part of the Microsoft Windows operating system.

Some types of snapshots do not actually create another physical copy of all the data as it existed at the particular point in time, but may simply create pointers that map files and directories to specific memory locations (e.g., to specific disk blocks) where the data resides as it existed at the particular point in time. For example, a snapshot copy may include a set of pointers derived from the file system or from an application. In some other cases, the snapshot may be created at the block-level, such that creation of the snapshot occurs without awareness of the file system. Each pointer points to a respective stored data block, so that collectively, the set of pointers reflect the storage location and state of the data object (e.g., file(s) or volume(s) or data set(s)) at the point in time when the snapshot copy was created.

An initial snapshot may use only a small amount of disk space needed to record a mapping or other data structure representing or otherwise tracking the blocks that correspond to the current state of the file system. Additional disk space is usually required only when files and directories change later on. Furthermore, when files change, typically only the pointers which map to blocks are copied, not the blocks themselves. For example, for “copy-on-write” snapshots, when a block changes in primary storage, the block is copied to secondary storage or cached in primary storage before the block is overwritten in primary storage, and the pointer to that block is changed to reflect the new location of that block. The snapshot mapping of file system data may also be updated to reflect the changed block(s) at that particular point in time. In some other cases, a snapshot includes a full physical copy of all or substantially all of the data represented by the snapshot. Further examples of snapshot operations are provided in U.S. Pat. No. 7,529,782. A snapshot copy in many cases can be made quickly and without significantly impacting primary computing resources because large amounts of data need not be copied or moved. In some embodiments, a snapshot may exist as a virtual file system, parallel to the actual file system. Users in some cases gain read-only access to the record of files and directories of the snapshot. By electing to restore primary data 112 from a snapshot taken at a given point in time, users may also return the current file system to the state of the file system that existed when the snapshot was taken.

Replication Operations

Replication is another type of secondary copy operation. Some types of secondary copies 116 periodically capture images of primary data 112 at particular points in time (e.g., backups, archives, and snapshots). However, it can also be useful for recovery purposes to protect primary data 112 in a more continuous fashion, by replicating primary data 112 substantially as changes occur. In some cases, a replication copy can be a mirror copy, for instance, where changes made to primary data 112 are mirrored or substantially immediately copied to another location (e.g., to secondary storage device(s) 108). By copying each write operation to the replication copy, two storage systems are kept synchronized or substantially synchronized so that they are virtually identical at approximately the same time. Where entire disk volumes are mirrored, however, mirroring can require significant amount of storage space and utilizes a large amount of processing resources.

According to some embodiments, secondary copy operations are performed on replicated data that represents a recoverable state, or “known good state” of a particular application running on the source system. For instance, in certain embodiments, known good replication copies may be viewed as copies of primary data 112. This feature allows the system to directly access, copy, restore, back up, or otherwise manipulate the replication copies as if they were the “live” primary data 112. This can reduce access time, storage utilization, and impact on source applications 110, among other benefits. Based on known good state information, system 100 can replicate sections of application data that represent a recoverable state rather than rote copying of blocks of data. Examples of replication operations (e.g., continuous data replication) are provided in U.S. Pat. No. 7,617,262.

Deduplication/Single-Instancing Operations

Deduplication or single-instance storage is useful to reduce the amount of non-primary data. For instance, some or all of the above-described secondary copy operations can involve deduplication in some fashion. New data is read, broken down into data portions of a selected granularity (e.g., sub-file level blocks, files, etc.), compared with corresponding portions that are already in secondary storage, and only new/changed portions are stored. Portions that already exist are represented as pointers to the already-stored data. Thus, a deduplicated secondary copy 116 may comprise actual data portions copied from primary data 112 and may further comprise pointers to already-stored data, which is generally more storage-efficient than a full copy.

In order to streamline the comparison process, system 100 may calculate and/or store signatures (e.g., hashes or cryptographically unique IDs) corresponding to the individual source data portions and compare the signatures to already-stored data signatures, instead of comparing entire data portions. In some cases, only a single instance of each data portion is stored, and deduplication operations may therefore be referred to interchangeably as “single-instancing” operations. Depending on the implementation, however, deduplication operations can store more than one instance of certain data portions, yet still significantly reduce stored-data redundancy. Depending on the embodiment, deduplication portions such as data blocks can be of fixed or variable length. Using variable length blocks can enhance deduplication by responding to changes in the data stream but can involve more complex processing. In some cases, system 100 utilizes a technique for dynamically aligning deduplication blocks based on changing content in the data stream, as described in U.S. Pat. No. 8,364,652.

System 100 can deduplicate in a variety of manners at a variety of locations. For instance, in some embodiments, system 100 implements “target-side” deduplication by deduplicating data at the media agent 144 after being received from data agent 142. In some such cases, media agents 144 are generally configured to manage the deduplication process. For instance, one or more of the media agents 144 maintain a corresponding deduplication database that stores deduplication information (e.g., data block signatures). Examples of such a configuration are provided in U.S. Pat. No. 9,020,900. Instead of or in combination with “target-side” deduplication, “source-side” (or “client-side”) deduplication can also be performed, e.g., to reduce the amount of data to be transmitted by data agent 142 to media agent 144. Storage manager 140 may communicate with other components within system 100 via network protocols and cloud service provider APIs to facilitate cloud-based deduplication/single instancing, as exemplified in U.S. Pat. No. 8,954,446. Some other deduplication/single instancing techniques are described in U.S. Pat. Pub. No. 2006/0224846 and in U.S. Pat. No. 9,098,495.

Information Lifecycle Management and Hierarchical Storage Management

In some embodiments, files and other data over their lifetime move from more expensive quick-access storage to less expensive slower-access storage. Operations associated with moving data through various tiers of storage are sometimes referred to as information lifecycle management (ILM) operations.

One type of ILM operation is a hierarchical storage management (HSM) operation, which generally automatically moves data between classes of storage devices, such as from high-cost to low-cost storage devices. For instance, an HSM operation may involve movement of data from primary storage devices 104 to secondary storage devices 108, or between tiers of secondary storage devices 108. With each tier, the storage devices may be progressively cheaper, have relatively slower access/restore times, etc. For example, movement of data between tiers may occur as data becomes less important over time. In some embodiments, an HSM operation is similar to archiving in that creating an HSM copy may (though not always) involve deleting some of the source data, e.g., according to one or more criteria related to the source data. For example, an HSM copy may include primary data 112 or a secondary copy 116 that exceeds a given size threshold or a given age threshold. Often, and unlike some types of archive copies, HSM data that is removed or aged from the source is replaced by a logical reference pointer or stub. The reference pointer or stub can be stored in the primary storage device 104 or other source storage device, such as a secondary storage device 108 to replace the deleted source data and to point to or otherwise indicate the new location in (another) secondary storage device 108.

For example, files are generally moved between higher and lower cost storage depending on how often the files are accessed. When a user requests access to HSM data that has been removed or migrated, system 100 uses the stub to locate the data and can make recovery of the data appear transparent, even though the HSM data may be stored at a location different from other source data. In this manner, the data appears to the user (e.g., in file system browsing windows and the like) as if it still resides in the source location (e.g., in a primary storage device 104). The stub may include metadata associated with the corresponding data, so that a file system and/or application can provide some information about the data object and/or a limited-functionality version (e.g., a preview) of the data object.

An HSM copy may be stored in a format other than the native application format (e.g., compressed, encrypted, deduplicated, and/or otherwise modified). In some cases, copies which involve the removal of data from source storage and the maintenance of stub or other logical reference information on source storage may be referred to generally as “online archive copies.” On the other hand, copies which involve the removal of data from source storage without the maintenance of stub or other logical reference information on source storage may be referred to as “off-line archive copies.” Examples of HSM and ILM techniques are provided in U.S. Pat. No. 7,343,453.

Auxiliary Copy Operations

An auxiliary copy is generally a copy of an existing secondary copy 116. For instance, an initial secondary copy 116 may be derived from primary data 112 or from data residing in secondary storage subsystem 118, whereas an auxiliary copy is generated from the initial secondary copy 116. Auxiliary copies provide additional standby copies of data and may reside on different secondary storage devices 108 than the initial secondary copies 116. Thus, auxiliary copies can be used for recovery purposes if initial secondary copies 116 become unavailable. Example auxiliary copy techniques are described in further detail in U.S. Pat. No. 8,230,195.

Disaster-Recovery Copy Operations

System 100 may also make and retain disaster recovery copies, often as secondary, high-availability disk copies. System 100 may create secondary copies and store them at disaster recovery locations using auxiliary copy or replication operations, such as continuous data replication technologies. Depending on the particular data protection goals, disaster recovery locations can be remote from the client computing devices 102 and primary storage devices 104, remote from some or all of the secondary storage devices 108, or both.

Data Manipulation, Including Encryption and Compression

Data manipulation and processing may include encryption and compression as well as integrity marking and checking, formatting for transmission, formatting for storage, etc. Data may be manipulated “client-side” by data agent 142 as well as “target-side” by media agent 144 in the course of creating secondary copy 116, or conversely in the course of restoring data from secondary to primary.

Encryption Operations

System 100 in some cases is configured to process data (e.g., files or other data objects, primary data 112, secondary copies 116, etc.), according to an appropriate encryption algorithm (e.g., Blowfish, Advanced Encryption Standard (AES), Triple Data Encryption Standard (3-DES), etc.) to limit access and provide data security. System 100 in some cases encrypts the data at the client level, such that client computing devices 102 (e.g., data agents 142) encrypt the data prior to transferring it to other components, e.g., before sending the data to media agents 144 during a secondary copy operation. In such cases, client computing device 102 may maintain or have access to an encryption key or passphrase for decrypting the data upon restore. Encryption can also occur when media agent 144 creates auxiliary copies or archive copies. Encryption may be applied in creating a secondary copy 116 of a previously unencrypted secondary copy 116, without limitation. In further embodiments, secondary storage devices 108 can implement built-in, high performance hardware-based encryption.

Compression Operations

Similar to encryption, system 100 may also or alternatively compress data in the course of generating a secondary copy 116. Compression encodes information such that fewer bits are needed to represent the information as compared to the original representation. Compression techniques are well known in the art. Compression operations may apply one or more data compression algorithms. Compression may be applied in creating a secondary copy 116 of a previously uncompressed secondary copy, e.g., when making archive copies or disaster recovery copies. The use of compression may result in metadata that specifies the nature of the compression, so that data may be uncompressed on restore if appropriate.

Data Analysis, Reporting, and Management Operations

Data analysis, reporting, and management operations can differ from data movement operations in that they do not necessarily involve copying, migration or other transfer of data between different locations in the system. For instance, data analysis operations may involve processing (e.g., offline processing) or modification of already stored primary data 112 and/or secondary copies 116. However, in some embodiments data analysis operations are performed in conjunction with data movement operations. Some data analysis operations include content indexing operations and classification operations which can be useful in leveraging data under management to enhance search and other features.

Classification Operations/Content Indexing

In some embodiments, information management system 100 analyzes and indexes characteristics, content, and metadata associated with primary data 112 (“online content indexing”) and/or secondary copies 116 (“off-line content indexing”). Content indexing can identify files or other data objects based on content (e.g., user-defined keywords or phrases, other keywords/phrases that are not defined by a user, etc.), and/or metadata (e.g., email metadata such as “to,” “from,” “cc,” “bcc,” attachment name, received time, etc.). Content indexes may be searched, and search results may be restored.

System 100 generally organizes and catalogues the results into a content index, which may be stored within media agent database 152, for example. The content index can also include the storage locations of or pointer references to indexed data in primary data 112 and/or secondary copies 116. Results may also be stored elsewhere in system 100 (e.g., in primary storage device 104 or in secondary storage device 108). Such content index data provides storage manager 140 or other components with an efficient mechanism for locating primary data 112 and/or secondary copies 116 of data objects that match particular criteria, thus greatly increasing the search speed capability of system 100. For instance, search criteria can be specified by a user through user interface 158 of storage manager 140. Moreover, when system 100 analyzes data and/or metadata in secondary copies 116 to create an “off-line content index,” this operation has no significant impact on the performance of client computing devices 102 and thus does not take a toll on the production environment. Examples of content indexing techniques are provided in U.S. Pat. No. 8,170,995.

One or more components, such as a content index engine, can be configured to scan data and/or associated metadata for classification purposes to populate a database (or other data structure) of information, which can be referred to as a “data classification database” or a “metabase.” Depending on the embodiment, the data classification database(s) can be organized in a variety of different ways, including centralization, logical sub-divisions, and/or physical sub-divisions. For instance, one or more data classification databases may be associated with different subsystems or tiers within system 100. As an example, there may be a first metabase associated with primary storage subsystem 117 and a second metabase associated with secondary storage subsystem 118. In other cases, metabase(s) may be associated with individual components, e.g., client computing devices 102 and/or media agents 144. In some embodiments, a data classification database may reside as one or more data structures within management database 146, may be otherwise associated with storage manager 140, and/or may reside as a separate component. In some cases, metabase(s) may be included in separate database(s) and/or on separate storage device(s) from primary data 112 and/or secondary copies 116, such that operations related to the metabase(s) do not significantly impact performance on other components of system 100. In other cases, metabase(s) may be stored along with primary data 112 and/or secondary copies 116. Files or other data objects can be associated with identifiers (e.g., tag entries, etc.) to facilitate searches of stored data objects. Among a number of other benefits, the metabase can also allow efficient, automatic identification of files or other data objects to associate with secondary copy or other information management operations. For instance, a metabase can dramatically improve the speed with which system 100 can search through and identify data as compared to other approaches that involve scanning an entire file system. Examples of metabases and data classification operations are provided in U.S. Pat. Nos. 7,734,669 and 7,747,579.

Management and Reporting Operations

Certain embodiments leverage the integrated ubiquitous nature of system 100 to provide useful system-wide management and reporting. Operations management can generally include monitoring and managing the health and performance of system 100 by, without limitation, performing error tracking, generating granular storage/performance metrics (e.g., job success/failure information, deduplication efficiency, etc.), generating storage modeling and costing information, and the like. As an example, storage manager 140 or another component in system 100 may analyze traffic patterns and suggest and/or automatically route data to minimize congestion. In some embodiments, the system can generate predictions relating to storage operations or storage operation information. Such predictions, which may be based on a trending analysis, may predict various network operations or resource usage, such as network traffic levels, storage media use, use of bandwidth of communication links, use of media agent components, etc. Further examples of traffic analysis, trend analysis, prediction generation, and the like are described in U.S. Pat. No. 7,343,453.

In some configurations having a hierarchy of storage operation cells, a master storage manager 140 may track the status of subordinate cells, such as the status of jobs, system components, system resources, and other items, by communicating with storage managers 140 (or other components) in the respective storage operation cells. Moreover, the master storage manager 140 may also track status by receiving periodic status updates from the storage managers 140 (or other components) in the respective cells regarding jobs, system components, system resources, and other items. In some embodiments, a master storage manager 140 may store status information and other information regarding its associated storage operation cells and other system information in its management database 146 and/or index 150 (or in another location). The master storage manager 140 or other component may also determine whether certain storage-related or other criteria are satisfied, and may perform an action or trigger event (e.g., data migration) in response to the criteria being satisfied, such as where a storage threshold is met for a particular volume, or where inadequate protection exists for certain data. For instance, data from one or more storage operation cells is used to mitigate recognized risks dynamically and automatically, and/or to advise users of risks or suggest actions to mitigate these risks. For example, an information management policy may specify certain requirements (e.g., that a storage device should maintain a certain amount of free space, that secondary copies should occur at a particular interval, that data should be aged and migrated to other storage after a particular period, that data on a secondary volume should always have a certain level of availability and be restorable within a given time period, that data on a secondary volume may be mirrored or otherwise migrated to a specified number of other volumes, etc.). If a risk condition or other criterion is triggered, the system may notify the user of these conditions and may suggest (or automatically implement) a mitigation action to address the risk. For example, the system may indicate that data from a primary copy 112 should be migrated to a secondary storage device 108 to free up space on primary storage device 104. Examples of the use of risk factors and other triggering criteria are described in U.S. Pat. No. 7,343,453.

In some embodiments, system 100 may also determine whether a metric or other indication satisfies particular storage criteria sufficient to perform an action. For example, a storage policy or other definition might indicate that a storage manager 140 should initiate a particular action if a storage metric or other indication drops below or otherwise fails to satisfy specified criteria such as a threshold of data protection. In some embodiments, risk factors may be quantified into certain measurable service or risk levels. For example, certain applications and associated data may be considered to be more important relative to other data and services. Financial compliance data, for example, may be of greater importance than marketing materials, etc. Network administrators may assign priority values or “weights” to certain data and/or applications corresponding to the relative importance. The level of compliance of secondary copy operations specified for these applications may also be assigned a certain value. Thus, the health, impact, and overall importance of a service may be determined, such as by measuring the compliance value and calculating the product of the priority value and the compliance value to determine the “service level” and comparing it to certain operational thresholds to determine whether it is acceptable. Further examples of the service level determination are provided in U.S. Pat. No. 7,343,453.

System 100 may additionally calculate data costing and data availability associated with information management operation cells. For instance, data received from a cell may be used in conjunction with hardware-related information and other information about system elements to determine the cost of storage and/or the availability of particular data. Example information generated could include how fast a particular department is using up available storage space, how long data would take to recover over a particular pathway from a particular secondary storage device, costs over time, etc. Moreover, in some embodiments, such information may be used to determine or predict the overall cost associated with the storage of certain information. The cost associated with hosting a certain application may be based, at least in part, on the type of media on which the data resides, for example. Storage devices may be assigned to a particular cost categories, for example. Further examples of costing techniques are described in U.S. Pat. No. 7,343,453.

Any of the above types of information (e.g., information related to trending, predictions, job, cell or component status, risk, service level, costing, etc.) can generally be provided to users via user interface 158 in a single integrated view or console (not shown). Report types may include: scheduling, event management, media management and data aging. Available reports may also include backup history, data aging history, auxiliary copy history, job history, library and drive, media in library, restore history, and storage policy, etc., without limitation. Such reports may be specified and created at a certain point in time as a system analysis, forecasting, or provisioning tool. Integrated reports may also be generated that illustrate storage and performance metrics, risks and storage costing information. Moreover, users may create their own reports based on specific needs. User interface 158 can include an option to graphically depict the various components in the system using appropriate icons. As one example, user interface 158 may provide a graphical depiction of primary storage devices 104, secondary storage devices 108, data agents 142 and/or media agents 144, and their relationship to one another in system 100.

In general, the operations management functionality of system 100 can facilitate planning and decision-making. For example, in some embodiments, a user may view the status of some or all jobs as well as the status of each component of information management system 100. Users may then plan and make decisions based on this data. For instance, a user may view high-level information regarding secondary copy operations for system 100, such as job status, component status, resource status (e.g., communication pathways, etc.), and other information. The user may also drill down or use other means to obtain more detailed information regarding a particular component, job, or the like. Further examples are provided in U.S. Pat. No. 7,343,453.

System 100 can also be configured to perform system-wide e-discovery operations in some embodiments. In general, e-discovery operations provide a unified collection and search capability for data in the system, such as data stored in secondary storage devices 108 (e.g., backups, archives, or other secondary copies 116). For example, system 100 may construct and maintain a virtual repository for data stored in system 100 that is integrated across source applications 110, different storage device types, etc. According to some embodiments, e-discovery utilizes other techniques described herein, such as data classification and/or content indexing.

### Information Management Policies

An information management policy 148 can include a data structure or other information source that specifies a set of parameters (e.g., criteria and rules) associated with secondary copy and/or other information management operations.

One type of information management policy 148 is a “storage policy.” According to certain embodiments, a storage policy generally comprises a data structure or other information source that defines (or includes information sufficient to determine) a set of preferences or other criteria for performing information management operations. Storage policies can include one or more of the following: (1) what data will be associated with the storage policy, e.g., subclient; (2) a destination to which the data will be stored; (3) datapath information specifying how the data will be communicated to the destination; (4) the type of secondary copy operation to be performed; and (5) retention information specifying how long the data will be retained at the destination (see, e.g., FIG. 1E). Data associated with a storage policy can be logically organized into subclients, which may represent primary data 112 and/or secondary copies 116. A subclient may represent static or dynamic associations of portions of a data volume. Subclients may represent mutually exclusive portions. Thus, in certain embodiments, a portion of data may be given a label and the association is stored as a static entity in an index, database or other storage location. Subclients may also be used as an effective administrative scheme of organizing data according to data type, department within the enterprise, storage preferences, or the like. Depending on the configuration, subclients can correspond to files, folders, virtual machines, databases, etc. In one example scenario, an administrator may find it preferable to separate e-mail data from financial data using two different subclients.

A storage policy can define where data is stored by specifying a target or destination storage device (or group of storage devices). For instance, where the secondary storage device 108 includes a group of disk libraries, the storage policy may specify a particular disk library for storing the subclients associated with the policy. As another example, where the secondary storage devices 108 include one or more tape libraries, the storage policy may specify a particular tape library for storing the subclients associated with the storage policy, and may also specify a drive pool and a tape pool defining a group of tape drives and a group of tapes, respectively, for use in storing the subclient data. While information in the storage policy can be statically assigned in some cases, some or all of the information in the storage policy can also be dynamically determined based on criteria set forth in the storage policy. For instance, based on such criteria, a particular destination storage device(s) or other parameter of the storage policy may be determined based on characteristics associated with the data involved in a particular secondary copy operation, device availability (e.g., availability of a secondary storage device 108 or a media agent 144), network status and conditions (e.g., identified bottlenecks), user credentials, and the like.

Datapath information can also be included in the storage policy. For instance, the storage policy may specify network pathways and components to utilize when moving the data to the destination storage device(s). In some embodiments, the storage policy specifies one or more media agents 144 for conveying data associated with the storage policy between the source and destination. A storage policy can also specify the type(s) of associated operations, such as backup, archive, snapshot, auxiliary copy, or the like. Furthermore, retention parameters can specify how long the resulting secondary copies 116 will be kept (e.g., a number of days, months, years, etc.), perhaps depending on organizational needs and/or compliance criteria.

When adding a new client computing device 102, administrators can manually configure information management policies 148 and/or other settings, e.g., via user interface 158. However, this can be an involved process resulting in delays, and it may be desirable to begin data protection operations quickly, without awaiting human intervention. Thus, in some embodiments, system 100 automatically applies a default configuration to client computing device 102. As one example, when one or more data agent(s) 142 are installed on a client computing device 102, the installation script may register the client computing device 102 with storage manager 140, which in turn applies the default configuration to the new client computing device 102. In this manner, data protection operations can begin substantially immediately. The default configuration can include a default storage policy, for example, and can specify any appropriate information sufficient to begin data protection operations. This can include a type of data protection operation, scheduling information, a target secondary storage device 108, data path information (e.g., a particular media agent 144), and the like.

Another type of information management policy 148 is a “scheduling policy,” which specifies when and how often to perform operations. Scheduling parameters may specify with what frequency (e.g., hourly, weekly, daily, event-based, etc.) or under what triggering conditions secondary copy or other information management operations are to take place. Scheduling policies in some cases are associated with particular components, such as a subclient, client computing device 102, and the like.

Another type of information management policy 148 is an “audit policy” (or “security policy”), which comprises preferences, rules and/or criteria that protect sensitive data in system 100. For example, an audit policy may define “sensitive objects” which are files or data objects that contain particular keywords (e.g., “confidential,” or “privileged”) and/or are associated with particular keywords (e.g., in metadata) or particular flags (e.g., in metadata identifying a document or email as personal, confidential, etc.). An audit policy may further specify rules for handling sensitive objects. As an example, an audit policy may require that a reviewer approve the transfer of any sensitive objects to a cloud storage site, and that if approval is denied for a particular sensitive object, the sensitive object should be transferred to a local primary storage device 104 instead. To facilitate this approval, the audit policy may further specify how a secondary storage computing device 106 or other system component should notify a reviewer that a sensitive object is slated for transfer.

Another type of information management policy 148 is a “provisioning policy,” which can include preferences, priorities, rules, and/or criteria that specify how client computing devices 102 (or groups thereof) may utilize system resources, such as available storage on cloud storage and/or network bandwidth. A provisioning policy specifies, for example, data quotas for particular client computing devices 102 (e.g., a number of gigabytes that can be stored monthly, quarterly or annually). Storage manager 140 or other components may enforce the provisioning policy. For instance, media agents 144 may enforce the policy when transferring data to secondary storage devices 108. If a client computing device 102 exceeds a quota, a budget for the client computing device 102 (or associated department) may be adjusted accordingly or an alert may trigger.

While the above types of information management policies 148 are described as separate policies, one or more of these can be generally combined into a single information management policy 148. For instance, a storage policy may also include or otherwise be associated with one or more scheduling, audit, or provisioning policies or operational parameters thereof. Moreover, while storage policies are typically associated with moving and storing data, other policies may be associated with other types of information management operations. The following is a non-exhaustive list of items that information management policies 148 may specify:
schedules or other timing information, e.g., specifying when and/or how often to perform information management operations;
the type of secondary copy 116 and/or copy format (e.g., snapshot, backup, archive, HSM, etc.);
a location or a class or quality of storage for storing secondary copies 116 (e.g., one or more particular secondary storage devices 108);
preferences regarding whether and how to encrypt, compress, deduplicate, or otherwise modify or transform secondary copies 116;
which system components and/or network pathways (e.g., preferred media agents 144) should be used to perform secondary storage operations;
resource allocation among different computing devices or other system components used in performing information management operations (e.g., bandwidth allocation, available storage capacity, etc.);
whether and how to synchronize or otherwise distribute files or other data objects across multiple computing devices or hosted services; and
retention information specifying the length of time primary data 112 and/or secondary copies 116 should be retained, e.g., in a particular class or tier of storage devices, or within the system 100.

Information management policies 148 can additionally specify or depend on historical or current criteria that may be used to determine which rules to apply to a particular data object, system component, or information management operation, such as:
frequency with which primary data 112 or a secondary copy 116 of a data object or metadata has been or is predicted to be used, accessed, or modified;
time-related factors (e.g., aging information such as time since the creation or modification of a data object);
deduplication information (e.g., hashes, data blocks, deduplication block size, deduplication efficiency or other metrics);
an estimated or historic usage or cost associated with different components (e.g., with secondary storage devices 108);
the identity of users, applications 110, client computing devices 102 and/or other computing devices that created, accessed, modified, or otherwise utilized primary data 112 or secondary copies 116;
a relative sensitivity (e.g., confidentiality, importance) of a data object, e.g., as determined by its content and/or metadata;
the current or historical storage capacity of various storage devices;
the current or historical network capacity of network pathways connecting various components within the storage operation cell;
access control lists or other security information; and
the content of a particular data object (e.g., its textual content) or of metadata associated with the data object.

Example Storage Policy and Secondary Copy Operations

FIG. 1E includes a data flow diagram depicting performance of secondary copy operations by an embodiment of information management system 100, according to an example storage policy 148A. System 100 includes a storage manager 140, a client computing device 102 having a file system data agent 142A and an email data agent 142B operating thereon, a primary storage device 104, two media agents 144A, 144B, and two secondary storage devices 108: a disk library 108A and a tape library 108B. As shown, primary storage device 104 includes primary data 112A, which is associated with a logical grouping of data associated with a file system (“file system subclient”), and primary data 112B, which is a logical grouping of data associated with email (“email subclient”). The techniques described with respect to FIG. 1E can be utilized in conjunction with data that is otherwise organized as well.

As indicated by the dashed box, the second media agent 144B and tape library 108B are “off-site,” and may be remotely located from the other components in system 100 (e.g., in a different city, office building, etc.). Indeed, “off-site” may refer to a magnetic tape located in remote storage, which must be manually retrieved and loaded into a tape drive to be read. In this manner, information stored on the tape library 108B may provide protection in the event of a disaster or other failure at the main site(s) where data is stored.

The file system subclient 112A in certain embodiments generally comprises information generated by the file system and/or operating system of client computing device 102, and can include, for example, file system data (e.g., regular files, file tables, mount points, etc.), operating system data (e.g., registries, event logs, etc.), and the like. The e-mail subclient 112B can include data generated by an e-mail application operating on client computing device 102, e.g., mailbox information, folder information, emails, attachments, associated database information, and the like. As described above, the subclients can be logical containers, and the data included in the corresponding primary data 112A and 112B may or may not be stored contiguously.

The example storage policy 148A includes backup copy preferences or rule set 160, disaster recovery copy preferences or rule set 162, and compliance copy preferences or rule set 164. Backup copy rule set 160 specifies that it is associated with file system subclient 166 and email subclient 168. Each of subclients 166 and 168 are associated with the particular client computing device 102. Backup copy rule set 160 further specifies that the backup operation will be written to disk library 108A and designates a particular media agent 144A to convey the data to disk library 108A. Finally, backup copy rule set 160 specifies that backup copies created according to rule set 160 are scheduled to be generated hourly and are to be retained for 30 days. In some other embodiments, scheduling information is not included in storage policy 148A and is instead specified by a separate scheduling policy.

Disaster recovery copy rule set 162 is associated with the same two subclients 166 and 168. However, disaster recovery copy rule set 162 is associated with tape library 108B, unlike backup copy rule set 160. Moreover, disaster recovery copy rule set 162 specifies that a different media agent, namely 144B, will convey data to tape library 108B. Disaster recovery copies created according to rule set 162 will be retained for 60 days and will be generated daily. Disaster recovery copies generated according to disaster recovery copy rule set 162 can provide protection in the event of a disaster or other catastrophic data loss that would affect the backup copy 116A maintained on disk library 108A.

Compliance copy rule set 164 is only associated with the email subclient 168, and not the file system subclient 166. Compliance copies generated according to compliance copy rule set 164 will therefore not include primary data 112A from the file system subclient 166. For instance, the organization may be under an obligation to store and maintain copies of email data for a particular period of time (e.g., 10 years) to comply with state or federal regulations, while similar regulations do not apply to file system data. Compliance copy rule set 164 is associated with the same tape library 108B and media agent 144B as disaster recovery copy rule set 162, although a different storage device or media agent could be used in other embodiments. Finally, compliance copy rule set 164 specifies that the copies it governs will be generated quarterly and retained for 10 years.

Secondary Copy Jobs

A logical grouping of secondary copy operations governed by a rule set and being initiated at a point in time may be referred to as a “secondary copy job” (and sometimes may be called a “backup job,” even though it is not necessarily limited to creating only backup copies). Secondary copy jobs may be initiated on demand as well. Steps 1-9 below illustrate three secondary copy jobs based on storage policy 148A.

Referring to FIG. 1E, at step 1, storage manager 140 initiates a backup job according to the backup copy rule set 160, which logically comprises all the secondary copy operations necessary to effectuate rules 160 in storage policy 148A every hour, including steps 1-4 occurring hourly. For instance, a scheduling service running on storage manager 140 accesses backup copy rule set 160 or a separate scheduling policy associated with client computing device 102 and initiates a backup job on an hourly basis. Thus, at the scheduled time, storage manager 140 sends instructions to client computing device 102 (i.e., to both data agent 142A and data agent 142B) to begin the backup job.

At step 2, file system data agent 142A and email data agent 142B on client computing device 102 respond to instructions from storage manager 140 by accessing and processing the respective subclient primary data 112A and 112B involved in the backup copy operation, which can be found in primary storage device 104. Because the secondary copy operation is a backup copy operation, the data agent(s) 142A, 142B may format the data into a backup format or otherwise process the data suitable for a backup copy.

At step 3, client computing device 102 communicates the processed file system data (e.g., using file system data agent 142A) and the processed email data (e.g., using email data agent 142B) to the first media agent 144A according to backup copy rule set 160, as directed by storage manager 140. Storage manager 140 may further keep a record in management database 146 of the association between media agent 144A and one or more of: client computing device 102, file system subclient 112A, file system data agent 142A, email subclient 112B, email data agent 142B, and/or backup copy 116A.

The target media agent 144A receives the data-agent-processed data from client computing device 102, and at step 4 generates and conveys backup copy 116A to disk library 108A to be stored as backup copy 116A, again at the direction of storage manager 140 and according to backup copy rule set 160. Media agent 144A can also update its index 153 to include data and/or metadata related to backup copy 116A, such as information indicating where the backup copy 116A resides on disk library 108A, where the email copy resides, where the file system copy resides, data and metadata for cache retrieval, etc. Storage manager 140 may similarly update its index 150 to include information relating to the secondary copy operation, such as information relating to the type of operation, a physical location associated with one or more copies created by the operation, the time the operation was performed, status information relating to the operation, the components involved in the operation, and the like. In some cases, storage manager 140 may update its index 150 to include some or all of the information stored in index 153 of media agent 144A. At this point, the backup job may be considered complete. After the 30-day retention period expires, storage manager 140 instructs media agent 144A to delete backup copy 116A from disk library 108A and indexes 150 and/or 153 are updated accordingly.

At step 5, storage manager 140 initiates another backup job for a disaster recovery copy according to the disaster recovery rule set 162. Illustratively this includes steps 5-7 occurring daily for creating disaster recovery copy 116B. Illustratively, and by way of illustrating the scalable aspects and off-loading principles embedded in system 100, disaster recovery copy 116B is based on backup copy 116A and not on primary data 112A and 112B.

At step 6, illustratively based on instructions received from storage manager 140 at step 5, the specified media agent 1446 retrieves the most recent backup copy 116A from disk library 108A.

At step 7, again at the direction of storage manager 140 and as specified in disaster recovery copy rule set 162, media agent 144B uses the retrieved data to create a disaster recovery copy 1166 and store it to tape library 1086. In some cases, disaster recovery copy 116B is a direct, mirror copy of backup copy 116A, and remains in the backup format. In other embodiments, disaster recovery copy 116B may be further compressed or encrypted, or may be generated in some other manner, such as by using primary data 112A and 1126 from primary storage device 104 as sources. The disaster recovery copy operation is initiated once a day and disaster recovery copies 1166 are deleted after 60 days; indexes 153 and/or 150 are updated accordingly when/after each information management operation is executed and/or completed. The present backup job may be considered completed.

At step 8, storage manager 140 initiates another backup job according to compliance rule set 164, which performs steps 8-9 quarterly to create compliance copy 116C. For instance, storage manager 140 instructs media agent 144B to create compliance copy 116C on tape library 1086, as specified in the compliance copy rule set 164.

At step 9 in the example, compliance copy 116C is generated using disaster recovery copy 1166 as the source. This is efficient, because disaster recovery copy resides on the same secondary storage device and thus no network resources are required to move the data. In other embodiments, compliance copy 116C is instead generated using primary data 112B corresponding to the email subclient or using backup copy 116A from disk library 108A as source data. As specified in the illustrated example, compliance copies 116C are created quarterly, and are deleted after ten years, and indexes 153 and/or 150 are kept up-to-date accordingly.

Example Applications of Storage Policies—Information Governance Policies and Classification

Again referring to FIG. 1E, storage manager 140 may permit a user to specify aspects of storage policy 148A. For example, the storage policy can be modified to include information governance policies to define how data should be managed in order to comply with a certain regulation or business objective. The various policies may be stored, for example, in management database 146. An information governance policy may align with one or more compliance tasks that are imposed by regulations or business requirements. Examples of information governance policies might include a Sarbanes-Oxley policy, a HIPAA policy, an electronic discovery (e-discovery) policy, and so on.

Information governance policies allow administrators to obtain different perspectives on an organization's online and offline data, without the need for a dedicated data silo created solely for each different viewpoint. As described previously, the data storage systems herein build an index that reflects the contents of a distributed data set that spans numerous clients and storage devices, including both primary data and secondary copies, and online and offline copies. An organization may apply multiple information governance policies in a top-down manner over that unified data set and indexing schema in order to view and manipulate the data set through different lenses, each of which is adapted to a particular compliance or business goal. Thus, for example, by applying an e-discovery policy and a Sarbanes-Oxley policy, two different groups of users in an organization can conduct two very different analyses of the same underlying physical set of data/copies, which may be distributed throughout the information management system.

An information governance policy may comprise a classification policy, which defines a taxonomy of classification terms or tags relevant to a compliance task and/or business objective. A classification policy may also associate a defined tag with a classification rule. A classification rule defines a particular combination of criteria, such as users who have created, accessed or modified a document or data object; file or application types; content or metadata keywords; clients or storage locations; dates of data creation and/or access; review status or other status within a workflow (e.g., reviewed or un-reviewed); modification times or types of modifications; and/or any other data attributes in any combination, without limitation. A classification rule may also be defined using other classification tags in the taxonomy. The various criteria used to define a classification rule may be combined in any suitable fashion, for example, via Boolean operators, to define a complex classification rule. As an example, an e-discovery classification policy might define a classification tag “privileged” that is associated with documents or data objects that (1) were created or modified by legal department staff, or (2) were sent to or received from outside counsel via email, or (3) contain one of the following keywords: “privileged” or “attorney” or “counsel,” or other like terms. Accordingly, all these documents or data objects will be classified as “privileged.”

One specific type of classification tag, which may be added to an index at the time of indexing, is an “entity tag.” An entity tag may be, for example, any content that matches a defined data mask format. Examples of entity tags might include, e.g., social security numbers (e.g., any numerical content matching the formatting mask XXX-XX-XXXX), credit card numbers (e.g., content having a 13-16 digit string of numbers), SKU numbers, product numbers, etc. A user may define a classification policy by indicating criteria, parameters or descriptors of the policy via a graphical user interface, such as a form or page with fields to be filled in, pull-down menus or entries allowing one or more of several options to be selected, buttons, sliders, hypertext links or other known user interface tools for receiving user input, etc. For example, a user may define certain entity tags, such as a particular product number or project ID. In some implementations, the classification policy can be implemented using cloud-based techniques. For example, the storage devices may be cloud storage devices, and the storage manager 140 may execute cloud service provider API over a network to classify data stored on cloud storage devices.

Restore Operations from Secondary Copies

While not shown in FIG. 1E, at some later point in time, a restore operation can be initiated involving one or more of secondary copies 116A, 116B, and 116C. A restore operation logically takes a selected secondary copy 116, reverses the effects of the secondary copy operation that created it, and stores the restored data to primary storage where a client computing device 102 may properly access it as primary data. A media agent 144 and an appropriate data agent 142 (e.g., executing on the client computing device 102) perform the tasks needed to complete a restore operation. For example, data that was encrypted, compressed, and/or deduplicated in the creation of secondary copy 116 will be correspondingly rehydrated (reversing deduplication), uncompressed, and unencrypted into a format appropriate to primary data. Metadata stored within or associated with the secondary copy 116 may be used during the restore operation. In general, restored data should be indistinguishable from other primary data 112. Preferably, the restored data has fully regained the native format that may make it immediately usable by application 110.

As one example, a user may manually initiate a restore of backup copy 116A, e.g., by interacting with user interface 158 of storage manager 140 or with a web-based console with access to system 100. Storage manager 140 may accesses data in its index 150 and/or management database 146 (and/or the respective storage policy 148A) associated with the selected backup copy 116A to identify the appropriate media agent 144A and/or secondary storage device 108A where the secondary copy resides. The user may be presented with a representation (e.g., stub, thumbnail, listing, etc.) and metadata about the selected secondary copy, in order to determine whether this is the appropriate copy to be restored, e.g., date that the original primary data was created. Storage manager 140 will then instruct media agent 144A and an appropriate data agent 142 on the target client computing device 102 to restore secondary copy 116A to primary storage device 104. A media agent may be selected for use in the restore operation based on a load balancing algorithm, an availability based algorithm, or other criteria. The selected media agent, e.g., 144A, retrieves secondary copy 116A from disk library 108A. For instance, media agent 144A may access its index 153 to identify a location of backup copy 116A on disk library 108A or may access location information residing on disk library 108A itself.

In some cases, a backup copy 116A that was recently created or accessed, may be cached to speed up the restore operation. In such a case, media agent 144A accesses a cached version of backup copy 116A residing in index 153, without having to access disk library 108A for some or all of the data. Once it has retrieved backup copy 116A, the media agent 144A communicates the data to the requesting client computing device 102. Upon receipt, file system data agent 142A and email data agent 142B may unpack (e.g., restore from a backup format to the native application format) the data in backup copy 116A and restore the unpackaged data to primary storage device 104. In general, secondary copies 116 may be restored to the same volume or folder in primary storage device 104 from which the secondary copy was derived; to another storage location or client computing device 102; to shared storage, etc. In some cases, the data may be restored so that it may be used by an application 110 of a different version/vintage from the application that created the original primary data 112.

### Example Secondary Copy Formatting

The formatting and structure of secondary copies 116 can vary depending on the embodiment. In some cases, secondary copies 116 are formatted as a series of logical data units or “chunks” (e.g., 512 MB, 1 GB, 2 GB, 4 GB, or 8 GB chunks). This can facilitate efficient communication and writing to secondary storage devices 108, e.g., according to resource availability. For example, a single secondary copy 116 may be written on a chunk-by-chunk basis to one or more secondary storage devices 108. In some cases, users can select different chunk sizes, e.g., to improve throughput to tape storage devices. Generally, each chunk can include a header and a payload. The payload can include files (or other data units) or subsets thereof included in the chunk, whereas the chunk header generally includes metadata relating to the chunk, some or all of which may be derived from the payload. For example, during a secondary copy operation, media agent 144, storage manager 140, or other component may divide files into chunks and generate headers for each chunk by processing the files. Headers can include a variety of information such as file and/or volume identifier(s), offset(s), and/or other information associated with the payload data items, a chunk sequence number, etc. Importantly, in addition to being stored with secondary copy 116 on secondary storage device 108, chunk headers can also be stored to index 153 of the associated media agent(s) 144 and/or to index 150 associated with storage manager 140. This can be useful for providing faster processing of secondary copies 116 during browsing, restores, or other operations. In some cases, once a chunk is successfully transferred to a secondary storage device 108, the secondary storage device 108 returns an indication of receipt, e.g., to media agent 144 and/or storage manager 140, which may update their respective indexes 153, 150 accordingly. During restore, chunks may be processed (e.g., by media agent 144) according to the information in the chunk header to reassemble the files.

Data can also be communicated within system 100 in data channels that connect client computing devices 102 to secondary storage devices 108. These data channels can be referred to as “data streams,” and multiple data streams can be employed to parallelize an information management operation, improving data transfer rate, among other advantages. Example data formatting techniques including techniques involving data streaming, chunking, and the use of other data structures in creating secondary copies are described in U.S. Pat. Nos. 7,315,923, 8,156,086, and 8,578,120.

FIGS. 1F and 1G are diagrams of example data streams 170 and 171, respectively, which may be employed for performing information management operations. Referring to FIG. 1F, data agent 142 forms data stream 170 from source data associated with a client computing device 102 (e.g., primary data 112). Data stream 170 is composed of multiple pairs of stream header 172 and stream data (or stream payload) 174. Data streams 170 and 171 shown in the illustrated example are for a single-instanced storage operation, and a stream payload 174 therefore may include both single-instance (SI) data and/or non-SI data. A stream header 172 includes metadata about the stream payload 174. This metadata may include, for example, a length of the stream payload 174, an indication of whether the stream payload 174 is encrypted, an indication of whether the stream payload 174 is compressed, an archive file identifier (ID), an indication of whether the stream payload 174 is single instanceable, and an indication of whether the stream payload 174 is a start of a block of data.

Referring to FIG. 1G, data stream 171 has the stream header 172 and stream payload 174 aligned into multiple data blocks. In this example, the data blocks are of size 64 KB. The first two stream header 172 and stream payload 174 pairs comprise a first data block of size 64 KB. The first stream header 172 indicates that the length of the succeeding stream payload 174 is 63 KB and that it is the start of a data block. The next stream header 172 indicates that the succeeding stream payload 174 has a length of 1 KB and that it is not the start of a new data block. Immediately following stream payload 174 is a pair comprising an identifier header 176 and identifier data 178. The identifier header 176 includes an indication that the succeeding identifier data 178 includes the identifier for the immediately previous data block. The identifier data 178 includes the identifier that the data agent 142 generated for the data block. The data stream 171 also includes other stream header 172 and stream payload 174 pairs, which may be for SI data and/or non-SI data.

FIG. 1H is a diagram illustrating data structures 180 that may be used to store blocks of SI data and non-SI data on a storage device (e.g., secondary storage device 108). According to certain embodiments, data structures 180 do not form part of a native file system of the storage device. Data structures 180 include one or more volume folders 182, one or more chunk folders 184/185 within the volume folder 182, and multiple files within chunk folder 184. Each chunk folder 184/185 includes a metadata file 186/187, a metadata index file 188/189, one or more container files 190/191/193, and a container index file 192/194. Metadata file 186/187 stores non-SI data blocks as well as links to SI data blocks stored in container files. Metadata index file 188/189 stores an index to the data in the metadata file 186/187. Container files 190/191/193 store SI data blocks. Container index file 192/194 stores an index to container files 190/191/193. Among other things, container index file 192/194 stores an indication of whether a corresponding block in a container file 190/191/193 is referred to by a link in a metadata file 186/187. For example, data block B2 in the container file 190 is referred to by a link in metadata file 187 in chunk folder 185. Accordingly, the corresponding index entry in container index file 192 indicates that data block B2 in container file 190 is referred to. As another example, data block B1 in container file 191 is referred to by a link in metadata file 187, and so the corresponding index entry in container index file 192 indicates that this data block is referred to.

As an example, data structures 180 illustrated in FIG. 1H may have been created as a result of separate secondary copy operations involving two client computing devices 102. For example, a first secondary copy operation on a first client computing device 102 could result in the creation of the first chunk folder 184, and a second secondary copy operation on a second client computing device 102 could result in the creation of the second chunk folder 185. Container files 190/191 in the first chunk folder 184 would contain the blocks of SI data of the first client computing device 102. If the two client computing devices 102 have substantially similar data, the second secondary copy operation on the data of the second client computing device 102 would result in media agent 144 storing primarily links to the data blocks of the first client computing device 102 that are already stored in the container files 190/191. Accordingly, while a first secondary copy operation may result in storing nearly all of the data subject to the operation, subsequent secondary storage operations involving similar data may result in substantial data storage space savings, because links to already stored data blocks can be stored instead of additional instances of data blocks.

If the operating system of the secondary storage computing device 106 on which media agent 144 operates supports sparse files, then when media agent 144 creates container files 190/191/193, it can create them as sparse files. A sparse file is a type of file that may include empty space (e.g., a sparse file may have real data within it, such as at the beginning of the file and/or at the end of the file, but may also have empty space in it that is not storing actual data, such as a contiguous range of bytes all having a value of zero). Having container files 190/191/193 be sparse files allows media agent 144 to free up space in container files 190/191/193 when blocks of data in container files 190/191/193 no longer need to be stored on the storage devices. In some examples, media agent 144 creates a new container file 190/191/193 when a container file 190/191/193 either includes 100 blocks of data or when the size of the container file 190 exceeds 50 MB. In other examples, media agent 144 creates a new container file 190/191/193 when a container file 190/191/193 satisfies other criteria (e.g., it contains from approx. 100 to approx. 1000 blocks or when its size exceeds approximately 50 MB to 1 GB). In some cases, a file on which a secondary copy operation is performed may comprise a large number of data blocks. For example, a 100 MB file may comprise 400 data blocks of size 256 KB. If such a file is to be stored, its data blocks may span more than one container file, or even more than one chunk folder. As another example, a database file of 20 GB may comprise over 40,000 data blocks of size 512 KB. If such a database file is to be stored, its data blocks will likely span multiple container files, multiple chunk folders, and potentially multiple volume folders. Restoring such files may require accessing multiple container files, chunk folders, and/or volume folders to obtain the requisite data blocks.

### Using Backup Data for Replication and Disaster Recovery (“Live Synchronization”)

There is an increased demand to off-load resource intensive information management tasks (e.g., data replication tasks) away from production devices (e.g., physical or virtual client computing devices) in order to maximize production efficiency. At the same time, enterprises expect access to readily-available up-to-date recovery copies in the event of failure, with little or no production downtime.

FIG. 2A illustrates a system 200 configured to address these and other issues by using backup or other secondary copy data to synchronize a source subsystem 201 (e.g., a production site) with a destination subsystem 203 (e.g., a failover site). Such a technique can be referred to as “live synchronization” and/or “live synchronization replication.” In the illustrated embodiment, the source client computing devices 202a include one or more virtual machines (or “VMs”) executing on one or more corresponding VM host computers 205a, though the source need not be virtualized. The destination site 203 may be at a location that is remote from the production site 201, or may be located in the same data center, without limitation. One or more of the production site 201 and destination site 203 may reside at data centers at known geographic locations, or alternatively may operate “in the cloud.”

The synchronization can be achieved by generally applying an ongoing stream of incremental backups from the source subsystem 201 to the destination subsystem 203, such as according to what can be referred to as an “incremental forever” approach. FIG. 2A illustrates an embodiment of a data flow which may be orchestrated at the direction of one or more storage managers (not shown). At step 1, the source data agent(s) 242a and source media agent(s) 244a work together to write backup or other secondary copies of the primary data generated by the source client computing devices 202a into the source secondary storage device(s) 208a. At step 2, the backup/secondary copies are retrieved by the source media agent(s) 244a from secondary storage. At step 3, source media agent(s) 244a communicate the backup/secondary copies across a network to the destination media agent(s) 244b in destination subsystem 203.

As shown, the data can be copied from source to destination in an incremental fashion, such that only changed blocks are transmitted, and in some cases multiple incremental backups are consolidated at the source so that only the most current changed blocks are transmitted to and applied at the destination. An example of live synchronization of virtual machines using the “incremental forever” approach is found in U.S. Patent Application No. 62/265,339 entitled “Live Synchronization and Management of Virtual Machines across Computing and Virtualization Platforms and Using Live Synchronization to Support Disaster Recovery.” Moreover, a deduplicated copy can be employed to further reduce network traffic from source to destination. For instance, the system can utilize the deduplicated copy techniques described in U.S. Pat. No. 9,239,687, entitled “Systems and Methods for Retaining and Using Data Block Signatures in Data Protection Operations.”

At step 4, destination media agent(s) 244b write the received backup/secondary copy data to the destination secondary storage device(s) 208b. At step 5, the synchronization is completed when the destination media agent(s) and destination data agent(s) 242b restore the backup/secondary copy data to the destination client computing device(s) 202b. The destination client computing device(s) 202b may be kept “warm” awaiting activation in case failure is detected at the source. This synchronization/replication process can incorporate the techniques described in U.S. patent application Ser. No. 14/721,971, entitled “Replication Using Deduplicated Secondary Copy Data.”

Where the incremental backups are applied on a frequent, on-going basis, the synchronized copies can be viewed as mirror or replication copies. Moreover, by applying the incremental backups to the destination site 203 using backup or other secondary copy data, the production site 201 is not burdened with the synchronization operations. Because the destination site 203 can be maintained in a synchronized “warm” state, the downtime for switching over from the production site 201 to the destination site 203 is substantially less than with a typical restore from secondary storage. Thus, the production site 201 may flexibly and efficiently fail over, with minimal downtime and with relatively up-to-date data, to a destination site 203, such as a cloud-based failover site. The destination site 203 can later be reverse synchronized back to the production site 201, such as after repairs have been implemented or after the failure has passed.

### Integrating With the Cloud Using File System Protocols

Given the ubiquity of cloud computing, it can be increasingly useful to provide data protection and other information management services in a scalable, transparent, and highly plug-able fashion. FIG. 2B illustrates an information management system 200 having an architecture that provides such advantages and incorporates use of a standard file system protocol between primary and secondary storage subsystems 217, 218. As shown, the use of the network file system (NFS) protocol (or any another appropriate file system protocol such as that of the Common Internet File System (CIFS)) allows data agent 242 to be moved from the primary storage subsystem 217 to the secondary storage subsystem 218. For instance, as indicated by the dashed box 206 around data agent 242 and media agent 244, data agent 242 can co-reside with media agent 244 on the same server (e.g., a secondary storage computing device such as component 106), or in some other location in secondary storage subsystem 218.

Where NFS is used, for example, secondary storage subsystem 218 allocates an NFS network path to the client computing device 202 or to one or more target applications 210 running on client computing device 202. During a backup or other secondary copy operation, the client computing device 202 mounts the designated NFS path and writes data to that NFS path. The NFS path may be obtained from NFS path data 215 stored locally at the client computing device 202, and which may be a copy of or otherwise derived from NFS path data 219 stored in the secondary storage subsystem 218.

Write requests issued by client computing device(s) 202 are received by data agent 242 in secondary storage subsystem 218, which translates the requests and works in conjunction with media agent 244 to process and write data to a secondary storage device(s) 208, thereby creating a backup or other secondary copy. Storage manager 240 can include a pseudo-client manager 217, which coordinates the process by, among other things, communicating information relating to client computing device 202 and application 210 (e.g., application type, client computing device identifier, etc.) to data agent 242, obtaining appropriate NFS path data from the data agent 242 (e.g., NFS path information), and delivering such data to client computing device 202.

Conversely, during a restore or recovery operation client computing device 202 reads from the designated NFS network path, and the read request is translated by data agent 242. The data agent 242 then works with media agent 244 to retrieve, re-process (e.g., re-hydrate, decompress, decrypt), and forward the requested data to client computing device 202 using NFS.

By moving specialized software associated with system 200 such as data agent 242 off the client computing devices 202, the illustrative architecture effectively decouples the client computing devices 202 from the installed components of system 200, improving both scalability and plug-ability of system 200. Indeed, the secondary storage subsystem 218 in such environments can be treated simply as a read/write NFS target for primary storage subsystem 217, without the need for information management software to be installed on client computing devices 202. As one example, an enterprise implementing a cloud production computing environment can add VM client computing devices 202 without installing and configuring specialized information management software on these VMs. Rather, backups and restores are achieved transparently, where the new VMs simply write to and read from the designated NFS path. An example of integrating with the cloud using file system protocols or so-called “infinite backup” using NFS share is found in U.S. Patent Application No. 62/294,920, entitled “Data Protection Operations Based on Network Path Information.” Examples of improved data restoration scenarios based on network-path information, including using stored backups effectively as primary data sources, may be found in U.S. Patent Application No. 62/297,057, entitled “Data Restoration Operations Based on Network Path Information.”

### Highly Scalable Managed Data Pool Architecture

Enterprises are seeing explosive data growth in recent years, often from various applications running in geographically distributed locations. FIG. 2C shows a block diagram of an example of a highly scalable, managed data pool architecture useful in accommodating such data growth. The illustrated system 200, which may be referred to as a “web-scale” architecture according to certain embodiments, can be readily incorporated into both open compute/storage and common-cloud architectures.

The illustrated system 200 includes a grid 245 of media agents 244 logically organized into a control tier 231 and a secondary or storage tier 233. Media agents assigned to the storage tier 233 can be configured to manage a secondary storage pool 208 as a deduplication store and be configured to receive client write and read requests from the primary storage subsystem 217 and direct those requests to the secondary tier 233 for servicing. For instance, media agents CMA1-CMA3 in the control tier 231 maintain and consult one or more deduplication databases 247, which can include deduplication information (e.g., data block hashes, data block links, file containers for deduplicated files, etc.) sufficient to read deduplicated files from secondary storage pool 208 and write deduplicated files to secondary storage pool 208. For instance, system 200 can incorporate any of the deduplication systems and methods shown and described in U.S. Pat. No. 9,020,900, entitled “Distributed Deduplicated Storage System,” and U.S. Pat. Pub. No. 2014/0201170, entitled “High Availability Distributed Deduplicated Storage System.”

Media agents SMA1-SMA6 assigned to the secondary tier 233 receive write and read requests from media agents CMA1-CMA3 in control tier 231, and access secondary storage pool 208 to service those requests. Media agents CMA1-CMA3 in control tier 231 can also communicate with secondary storage pool 208 and may execute read and write requests themselves (e.g., in response to requests from other control media agents CMA1-CMA3) in addition to issuing requests to media agents in secondary tier 233. Moreover, while shown as separate from the secondary storage pool 208, deduplication database(s) 247 can in some cases reside in storage devices in secondary storage pool 208.

As shown, each of the media agents 244 (e.g., CMA1-CMA3, SMA1-SMA6, etc.) in grid 245 can be allocated a corresponding dedicated partition 251A-2511, respectively, in secondary storage pool 208. Each partition 251 can include a first portion 253 containing data associated with (e.g., stored by) media agent 244 corresponding to the respective partition 251. System 200 can also implement a desired level of replication, thereby providing redundancy in the event of a failure of a media agent 244 in grid 245. Along these lines, each partition 251 can further include a second portion 255 storing one or more replication copies of the data associated with one or more other media agents 244 in the grid.

System 200 can also be configured to allow for seamless addition of media agents 244 to grid 245 via automatic configuration. As one illustrative example, a storage manager (not shown) or other appropriate component may determine that it is appropriate to add an additional node to control tier 231, and perform some or all of the following: (i) assess the capabilities of a newly added or otherwise available computing device as satisfying a minimum criteria to be configured as or hosting a media agent in control tier 231; (ii) confirm that a sufficient amount of the appropriate type of storage exists to support an additional node in control tier 231 (e.g., enough disk drive capacity exists in storage pool 208 to support an additional deduplication database 247); (iii) install appropriate media agent software on the computing device and configure the computing device according to a pre-determined template; (iv) establish a partition 251 in the storage pool 208 dedicated to the newly established media agent 244; and (v) build any appropriate data structures (e.g., an instance of deduplication database 247). An example of highly scalable managed data pool architecture or so-called web-scale architecture for storage and data management is found in U.S. Patent Application No. 62/273,286 entitled “Redundant and Robust Distributed Deduplication Data Storage System.”

The embodiments and components thereof disclosed in FIGS. 2A, 2B, and 2C, as well as those in FIGS. 1A-1H, may be implemented in any combination and permutation to satisfy data storage management and information management needs at one or more locations and/or data centers.

### Illustrative Expandable Data Storage Management System

When customer data originates or terminates (in the form of secondary copies) in a cloud computing environment, special needs arise to support these configurations.

Cloud Computing. The National Institute of Standards and Technology (NIST) provides the following definition of Cloud Computing characteristics, service models, and deployment models:
Cloud computing is a model for enabling ubiquitous, convenient, on-demand network access to a shared pool of configurable computing resources (e.g., networks, servers, storage, applications, and services) that can be rapidly provisioned and released with minimal management effort or service provider interaction. This cloud model is composed of five essential characteristics, three service models, and four deployment models.

Essential Characteristics:
On-demand self-service. A consumer can unilaterally provision computing capabilities, such as server time and network storage, as needed automatically without requiring human interaction with each service provider.
Broad network access. Capabilities are available over the network and accessed through standard mechanisms that promote use by heterogeneous thin or thick client platforms (e.g., mobile phones, tablets, laptops, and workstations).
Resource pooling. The provider's computing resources are pooled to serve multiple consumers using a multi-tenant model, with different physical and virtual resources dynamically assigned and reassigned according to consumer demand. There is a sense of location independence in that the customer generally has no control or knowledge over the exact location of the provided resources but may be able to specify location at a higher level of abstraction (e.g., country, state, or datacenter). Examples of resources include storage, processing, memory, and network bandwidth.
Rapid elasticity. Capabilities can be elastically provisioned and released, in some cases automatically, to scale rapidly outward and inward commensurate with demand. To the consumer, the capabilities available for provisioning often appear to be unlimited and can be appropriated in any quantity at any time.
Measured service. Cloud systems automatically control and optimize resource use by leveraging a metering capability¹ at some level of abstraction appropriate to the type of service (e.g., storage, processing, bandwidth, and active user accounts). Resource usage can be monitored, controlled, and reported, providing transparency for both the provider and consumer of the utilized service.

Service Models:
Software as a Service (SaaS). The capability provided to the consumer is to use the provider's applications running on a cloud infrastructure². The applications are accessible from various client devices through either a thin client interface, such as a web browser (e.g., web-based email), or a program interface. The consumer does not manage or control the underlying cloud infrastructure including network, servers, operating systems, storage, or even individual application capabilities, with the possible exception of limited user-specific application configuration settings.
Platform as a Service (PaaS). The capability provided to the consumer is to deploy onto the cloud infrastructure consumer-created or acquired applications created using programming languages, libraries, services, and tools supported by the provider.³ The consumer does not manage or control the underlying cloud infrastructure including network, servers, operating systems, or storage, but has control over the deployed applications and possibly configuration settings for the application-hosting environment.
Infrastructure as a Service (IaaS). The capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, and deployed applications; and possibly limited control of select networking components (e.g., host firewalls).

Deployment Models:
Private cloud. The cloud infrastructure is provisioned for exclusive use by a single organization comprising multiple consumers (e.g., business units). It may be owned, managed, and operated by the organization, a third party, or some combination of them, and it may exist on or off premises.
Community cloud. The cloud infrastructure is provisioned for exclusive use by a specific community of consumers from organizations that have shared concerns (e.g., mission, security requirements, policy, and compliance considerations). It may be owned, managed, and operated by one or more of the organizations in the community, a third party, or some combination of them, and it may exist on or off premises.
Public cloud. The cloud infrastructure is provisioned for open use by the general public. It may be owned, managed, and operated by a business, academic, or government organization, or some combination of them. It exists on the premises of the cloud provider.
Hybrid cloud. The cloud infrastructure is a composition of two or more distinct cloud infrastructures (private, community, or public) that remain unique entities, but are bound together by standardized or proprietary technology that enables data and application portability (e.g., cloud bursting for load balancing between clouds). ¹ Typically this is done on a pay-per-use or charge-per-use basis.² A cloud infrastructure is the collection of hardware and software that enables the five essential characteristics of cloud computing. The cloud infrastructure can be viewed as containing both a physical layer and an abstraction layer. The physical layer consists of the hardware resources that are necessary to support the cloud services being provided, and typically includes server, storage and network components. The abstraction layer consists of the software deployed across the physical layer, which manifests the essential cloud characteristics. Conceptually the abstraction layer sits above the physical layer.³ This capability does not necessarily preclude the use of compatible programming languages, libraries, services, and tools from other sources.
   Source: Peter Mell, Timothy Grance (September 2011). The NIST Definition of Cloud Computing, National Institute of Standards and Technology: U.S. Department of Commerce. Special publication 800-145. nvlpubs.nist.govinistpubs/Legacy/SP/nistspecialpublication800-145.pdf (accessed 26 Apr. 2019). Cloud computing aims to allow those who consume the services (whether individuals or organizations) to benefit from the available technologies without the need for deep knowledge about or expertise with each of them. Wikipedia, Cloud Computing, en.wikipedia.org/wiki/Cloud computing (accessed 26 Apr. 2019). “Cloud computing metaphor: the group of networked elements providing services need not be individually addressed or managed by users; instead, the entire provider-managed suite of hardware and software can be thought of as an amorphous cloud.” Id.

Cloud Service Accounts and Variability in Cloud Services. Cloud service providers such as Amazon, Microsoft, Alibaba, Google, Salesforce, Cisco, Oracle, etc. provide access to their particular cloud services via cloud service accounts, such as corporate accounts, departmental accounts, individual user accounts, etc. Each cloud service account typically has authentication features, e.g., passwords, certificates, etc., to restrict and control access to the cloud service. Each account also might have service level guarantees and/or other terms and conditions between the cloud service provider and the service subscriber, e.g., a company, a government agency, an individual user. A subscribing entity might have multiple accounts with a cloud service provider, such as an account for the Engineering department, an account for the Finance department, an account for the Human Resources department, other accounts for individual company users, etc., without limitation. Each cloud service account carries different authentication, even though the services subscriber is the same entity.

Different cloud service accounts might differ in service level guarantees and might include different services. For example, one account might include long-term storage resources, whereas another account might be limited to ordinary data storage. For example, some accounts might have access to data processing functions supplied by the cloud service provider, such as machine learning algorithms, statistical analysis packages, etc., whereas other accounts might lack such features. Accordingly, the resources available to the user(s) of cloud service accounts can vary as between accounts, even if the accounts have the same subscriber and the same cloud service provider. Thus, the user experience and the technologies available as between cloud service accounts can vary significantly. When considering cloud computing, the specifics of cloud service accounts can play a role in the availability and/or portability of resources. Crossing account boundaries can pose technological barriers when considering migration of data.

A “cloud computing environment” as used herein comprises a collection (or suite) of resources provided as a service by the cloud service provider to a cloud service account. A cloud computing environment is accessed via the cloud service account that entitles the subscriber to a suite of services in a given cloud service supplied by a cloud service provider. Cloud computing environments vary among cloud services, among cloud availability zones, and even among cloud service accounts from the same cloud service provider. A cloud computing environment as used herein need not comprise data processing (computing) resources and can be limited to data storage and retrieval features.

Cloud Availability Zones. “Availability zones (AZs) are isolated locations within . . . regions from which public cloud services originate and operate. Regions are geographic locations in which public cloud service providers' data centers reside. Businesses choose one or multiple worldwide availability zones for their services depending on business needs. Businesses select availability zones for a variety of reasons, including compliance and proximity to end customers. Cloud administrators can also choose to replicate services across multiple availability zones to decrease latency or protect resources. Admins can move resources to another availability zone in the event of an outage. Certain cloud services may also be limited to particular regions or AZs.” Source: Margaret Rouse, Definition of Availability Zones, TechTarget, searchaws.techtarget.com/definition/availability-zones (accessed 26 Apr. 2019).

Here is a vendor-specific example of how cloud service availability zones are organized in the Google Cloud: “Certain [Google] Compute Engine resources live in regions or zones. A region is a specific geographical location where you can run your resources. Each region has one or more zones; most regions have three or more zones. For example, the us-central1 region denotes a region in the Central United States that has zones us-central1-a, us-central1-b, us-central1-c, and us-central1-f. Resources that live in a zone, such as instances or persistent disks, are referred to as zonal resources. Other resources, like static external IP addresses, are regional. Regional resources can be used by any resources in that region, regardless of zone, while zonal resources can only be used by other resources in the same zone. For example, disks and instances are both zonal resources. To attach a disk to an instance, both resources must be in the same zone. Similarly, if you want to assign a static IP address to an instance, the instance must be in the same region as the static IP. Only certain resources are region- or zone-specific. Other resources, such as images, are global resources that can be used by any other resources across any location. For information on global, regional, and zonal Compute Engine resources, see Global, Regional, and Zonal Resources.” Source: Google Cloud Regions and Zones, cloud.google.com/compute/docs/regions-zones/ (accessed 26 Apr. 2019) (emphasis added).

Accordingly, when considering cloud computing in general and cloud storage in particular, availability zones can play a role in the availability and/or portability of resources. Crossing zone boundaries can pose technological barriers when considering migration of data, even when the different availability zones are supplied by the same cloud service provider.

Traditional Non-Cloud (“On-Premises”) Data Centers are Distinguishable from Cloud Computing. Traditional data centers generally do not have cloud computing characteristics. The user experience is generally different, for example in regard to the name space(s) used for the storage, computing, and network resources. Moreover, substantial increases in resources (e.g., storage arrays, file servers, virtual machine hosts, etc.) needed by a user are not provisioned on demand. A traditional data center is physically located within the enterprise/organization that owns it. A traditional non-cloud data center might comprise computing resources such as servers, mainframes, virtual servers/clusters, etc.; and/or data storage resources, such as network-attached storage, storage area networks, tape libraries, etc. The owner of the traditional data center procures hardware, software, and network infrastructure (including making the associated capital investments); and manages going-forward planning for the data center. A traditional data center is staffed by professional Information Technology (IT) personnel, who are responsible for the data center's configuration, operation, upgrades, and maintenance. Thus, a traditional non-cloud data center can be thought of as self-managed by its owner/operator for the benefit of in-house users, as compared to cloud computing, which is managed by the cloud service provider and supplied as a service to outside subscribers. Clearly, a cloud computing service also has hardware, software, networking infrastructure, data storage resources, and professionals staffing it, as well as having an owner responsible for housing and paying for the infrastructure. However, the cloud computing/storage service is consumed differently, served differently, and deployed differently compared to non-cloud data centers. Traditional non-cloud data centers are sometimes referred to as “on-premises” data centers because their facilities are literally within the bounds of the organization that owns the data center. Cloud service providers' data centers generally are not within the bounds of the subscriber organization and are consumed “at a distance” “in the cloud.”

Accordingly, when considering cloud computing versus non-cloud data center deployment, the choice can play a role in the availability and/or portability of resources. Crossing boundaries between non-cloud data centers and cloud computing can pose technological barriers. For example, storing data at a non-cloud data center might require different resources and/or access features/controls than storing the data in a cloud computing environment. Thus, moving the data from the non-cloud data center to a cloud service account may require data conversion, re-configuration, and/or adaptation that go above and beyond merely copying the data. Conversely, moving data, applications, and/or web services from cloud computing to a non-cloud data center also can involve data conversion, re-configuration, and/or adaptation to ensure success. Protecting data from/to cloud computing environments also requires specially-configures hardware, software, and feature functionality.

FIG. 3 is a block diagram illustrating some salient portions of an expandable data storage management system 300 according to an illustrative embodiment. The present figure depicts a many-to-many relationship between customers (e.g., A, B, C . . . M) and storage service cells 301 (e.g., 301-1 . . . 301-N) that protect these customers' various data sources. The many-to-many relationship is made possible by storage hub manager 350.

System 300 is an illustrative embodiment of an expandable storage management system comprising storage hub manager 350 and any number of storage service cells 301 serving any number of distinct customers and respective customer accounts. Each customer is an entity (e.g., company, organization, enterprise, government agency, etc.) that has an account or subscription for using system 300 to protect its various primary data 112. Accordingly, in the present context, each customer is distinct from every other customer and customers lack access to each other's data and storage management information. System 300 is expandable, because as customers add new data sources and/or new customers join/subscribe to system 300, more storage service cells 301 are added to system 300 as needed. Likewise, growth of customers' existing data requires new storage service cells 301 to be added to system 300. According to the illustrative embodiments, additions, changes, and removals of storage service cells 301 are not expressly visible to customers. Each customer of system 300, e.g., A, B . . . M, has one or more customer-associated accounts, e.g., for multiple authorized users. System 300 provides a unified “single-system” view to each customer using their one or more accounts and blocks accessing and//or viewing of other customers' information, administrative preferences, secondary copies, etc. within system 300.

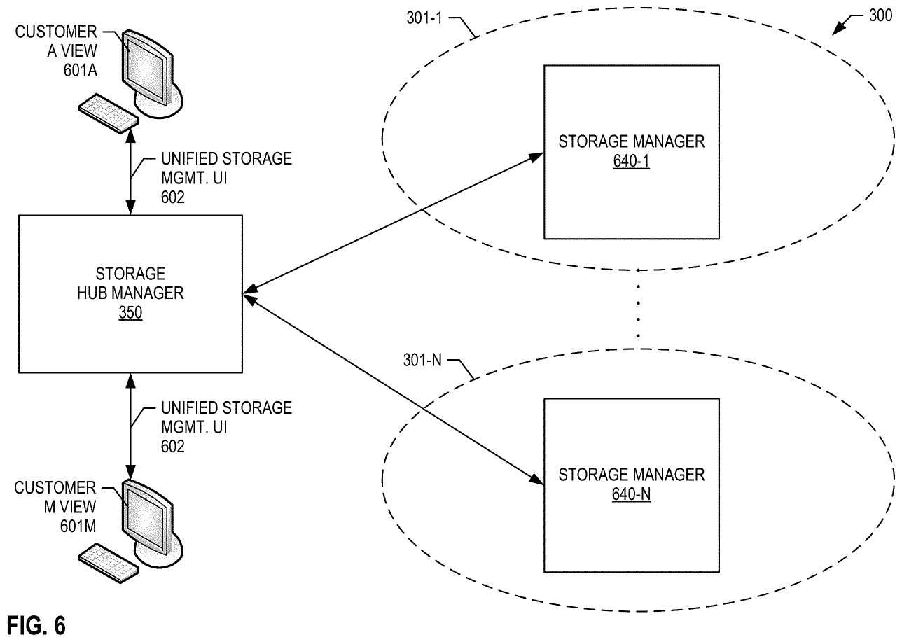

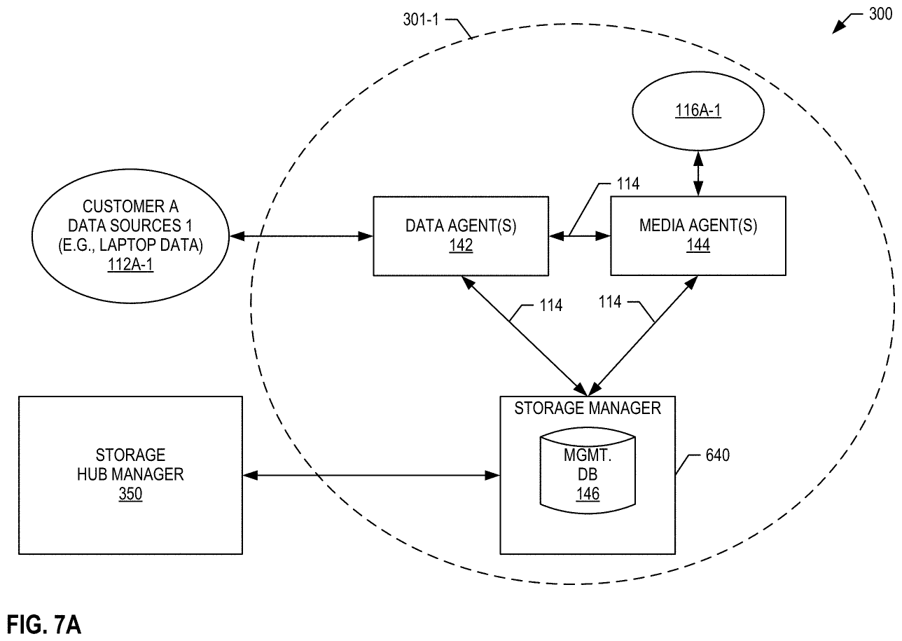

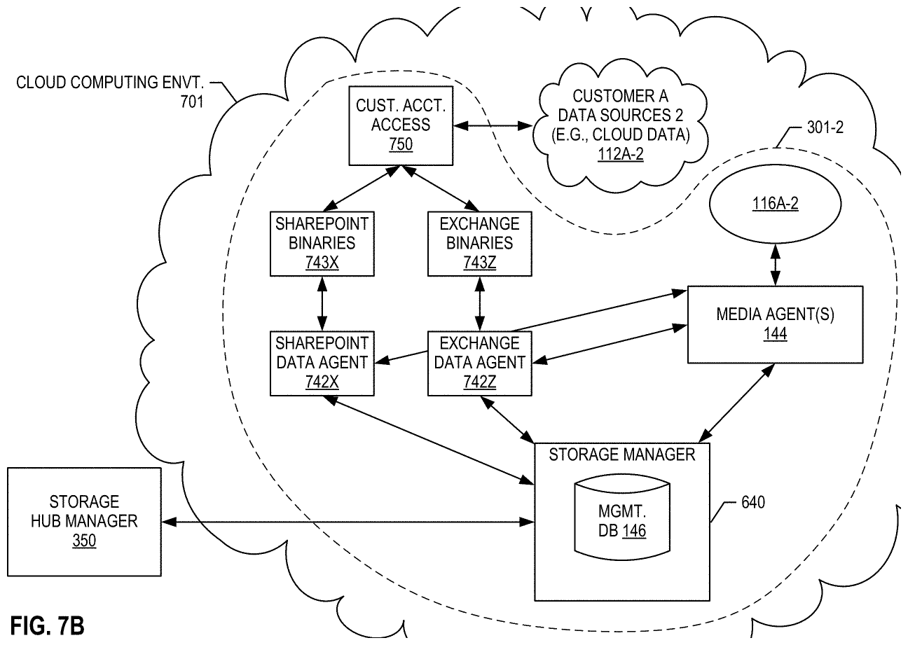

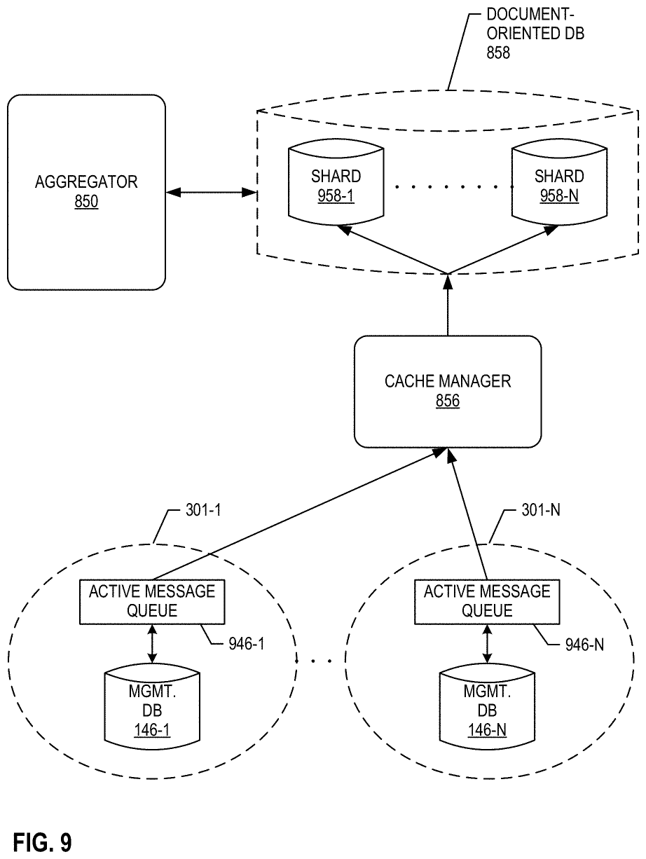

Storage service cell 301 is analogous to a storage operation cell in system 100/200 described in more detail elsewhere herein, and further comprises additional features for operating within expandable system 300, e.g., features for enabling storage hub manager 350 to communicate with cells' individual storage managers to tap into an active message queue for detecting key changes therein, collecting information from each storage service cell, responding to queries/instructions from storage hub manager 350, receiving administrative data from storage hub manager 350, etc. See also FIG. 9. Each storage service cell 301 has resources/components for performing and autonomously performs storage operations within the storage service cell. Each storage service cell 301 is said to be subtending to storage hub manager 350, because customers access is moderated by storage hub manager 350, e.g., via user interface 602. See also FIGS. 6-7B.

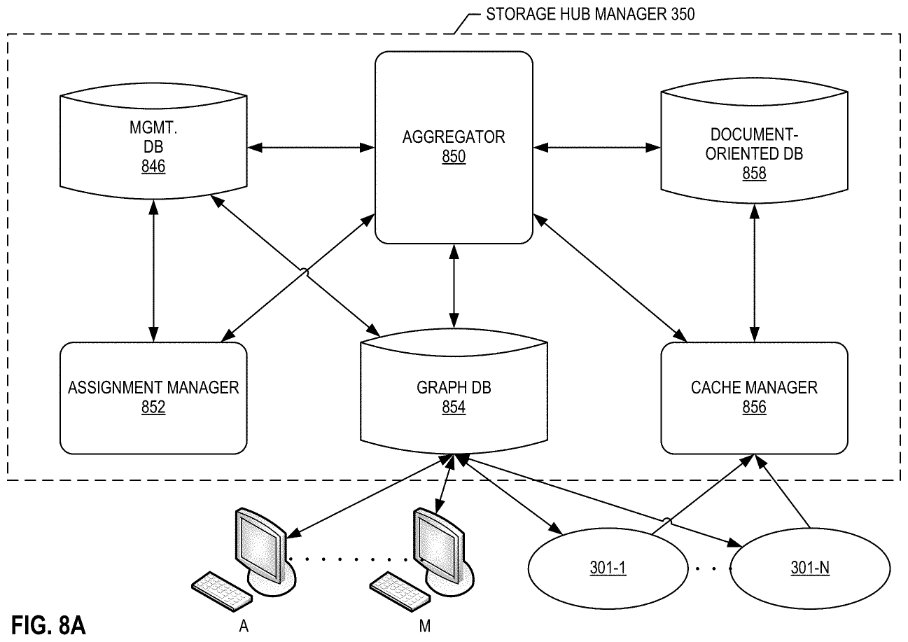

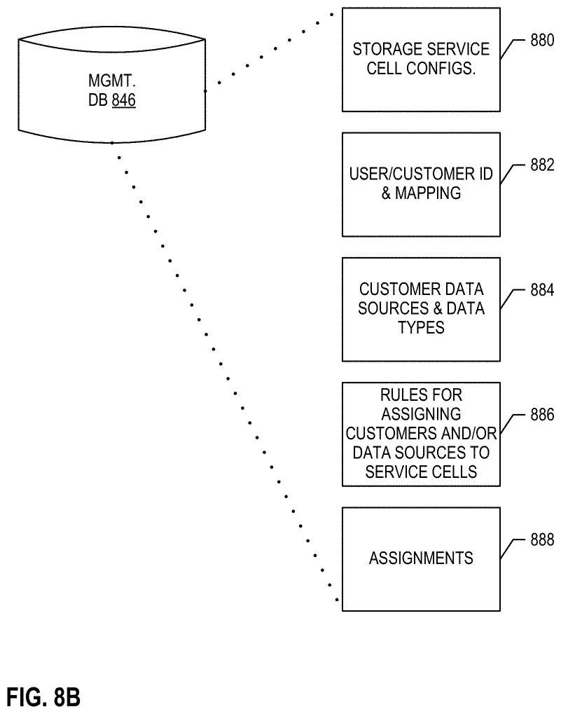

Storage hub manager 350 (or “hub manager” or “hub”) is a component of system 300. In some embodiments storage hub manager 350 is implemented as software that executes on a computing device comprising hardware processors and computer memory for executing storage hub manager 350. In other embodiments, storage hub manager 350 is a computing device comprising hardware processors and computer memory that perform the features of storage hub manager 350 described herein. In some embodiments, storage hub manager 350 logically comprises some components that are implemented outside the hosting computing device. See, e.g., FIGS. 8A, 8B, and 9 for more details on sub-components, data structures, and features of storage hub manager 350.

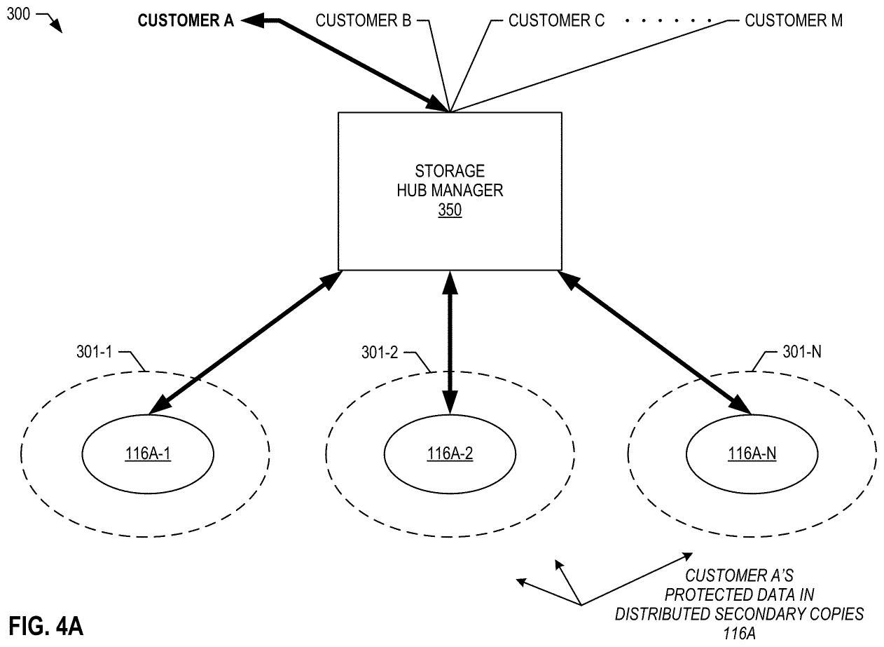

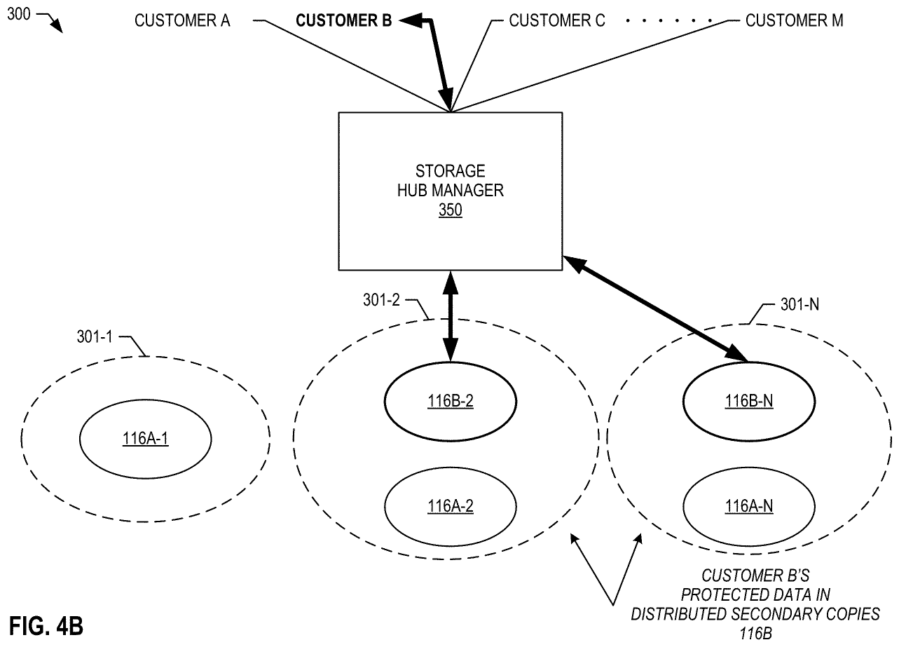

FIG. 4A is a block diagram illustrating a customer's secondary copies 116 distributed among a plurality of storage service cells 301 according to an illustrative embodiment. In this configuration, customer A's protected data is stored in and distributed among secondary copies 116A. The present figure depicts: customer A having access to storage hub manager 350, which has N subtending storage service cells 301 (e.g., 301-1, 301-2 . . . 301-N). Customer A's secondary copies are illustratively stored in cell 301-1 (see, e.g., 116A-1), in cell 301-2 (see, e.g., 116A-2), and in cell 301-N (see, e.g., 116A-N). Notably, elements 116A-1, 116A-2, and 116A-N are umbrella labels, i.e., any number of individual secondary copies 116, associated with customer A, having various characteristics, attributes, formats, and/or types, and generated at various points in time, are included in each umbrella label 116A. For example, umbrella label 116A-1 may comprise any number and types of secondary copies such as backup copies (e.g., full, incremental, differential, reference, etc.), archive copies, deduplicated copies, block-level copies, file-level copies, etc., without limitation. Furthermore, umbrella label 116A-1 may include any number and types of storage devices where the secondary copies reside, e.g., tape libraries, disk libraries, cloud-based storage resources, etc., without limitation. In sum, FIG. 4A depicts the distributed nature of secondary copies 116 in system 300, including the distribution of secondary copies 116 belonging to a single customer and/or associated with a given customer account, depicted here by customer A, across a plurality of storage service cells 301. There is no limit on how many storage service cells 301 can generate, manage, and/or store secondary copies 116 belonging to a given customer and/or associated with a given customer account.

FIG. 4B is a block diagram illustrating a customer's secondary copies distributed among a plurality of storage service cells, some of which also comprise other customers' secondary copies, according to an illustrative embodiment. In this configuration, customer B's protected data is stored in and distributed among secondary copies 116B. The present figure depicts: customer B having access to storage hub manager 350, which has N subtending storage service cells 301 (e.g., 301-1, 301-2 . . . 301-N). Customer B's secondary copies 116B are illustratively stored in cell 301-2 (see, e.g., 116B-2) and in cell 301-N (see, e.g., 116B-N). As in a preceding figure, elements 116B-2 and 116B-N are umbrella labels, i.e., any number of individual secondary copies 116, associated with customer B, having various characteristics, attributes, formats, and/or types, and generated at various points in time, are included in each umbrella label 116B.

Notably, the present figure further illustrates “soft separation” within a storage service cell 301 of secondary copies 116 belonging to different customers, e.g., A and B. Illustratively, cell 301-2 comprises secondary copies 116A-2 belonging to customer A and further comprises secondary copies 116B-2 belong to customer B. Likewise, cell 301-N comprises secondary copies 116A-N belonging to customer A and further comprises secondary copies 116B-N belonging to customer B. Although they are generated and managed (at least in part) by a given storage service cell 301, the secondary copies 116 therein are maintained in strict logical separation so that each customer has access and visibility to their own secondary copies 116 and not to other customers' secondary copies. In some configurations, a storage service cell 301 (e.g., 301-1) is configured to provide storage management exclusively to one customer (e.g., A), in order to enforce “hard separation,” but the invention is not so limited. In fact, the “matrix management” model employed by system 300 derives advantages from using a given storage service cell 301 to service multiple customers, e.g., through specialization. See also FIGS. 7A and 7B.

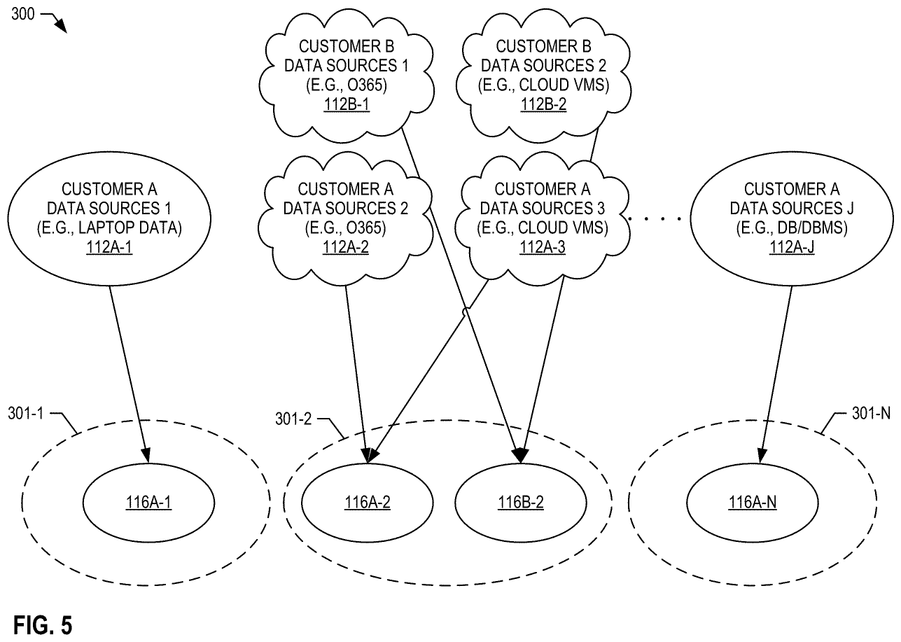

FIG. 5 is a block diagram illustrating a customer's primary data sources being protected by different storage service cells according to an illustrative embodiment. This figure depicts an illustrative specialization feature of system 300 in which diverse data sources are assigned, depending on type and/or other attributes, to different storage service cells 301 that are specially configured to optimize data protection for the assigned types/attributes of data sources. The present figure depicts: customer A's first data sources (e.g., laptop data) assigned to cell 301-1, which comprises customer A's secondary copies 116A-1; customer A's second data sources (e.g., cloud-based Office 365 data) and third data sources (e.g., cloud-based virtual machine data) assigned to cell 301-2, which comprises customer A's secondary copies 116A-2; customer B's first data sources (e.g., cloud-based Office 365 data) and second data sources (e.g., cloud-based virtual machine data) assigned to cell 301-2, which comprises customer B's secondary copies 116B-2; and customer A's Jth data sources (e.g., database and database management system data) assigned to cell 301-N, which comprises customer A's secondary copies 116A-N. In this illustrative depiction, storage service cell 301-1 is configured for protecting laptop data; cell 301-2 is configured for protecting cloud-based data such as Microsoft Office 365 and virtual machines; and cell 301-N is configured for protecting database data in a traditional data center (non-cloud) database management systems (DBMS). The invention is not limited to the configurations depicted here. In other embodiments, any number of customers, data types/attributes, and storage service cells 301 can be arranged and organized to optimally protect customers' data. For example, cloud-based source data in a Microsoft Azure cloud computing environment may be protected by a cell 301 configured for Microsoft Azure access and data storage, while cloud-based source data in a Google Cloud Platform cloud computing environment may be protected by another distinct storage service cell configured for Google Cloud Platform access and data storage. Thus, the specialized implementation and unique configuration choices for each storage service cell 301 are left to the implementers of system 300. See also FIGS. 7A and 7B.

FIG. 6 is a block diagram illustrating that in system 300 each customer receives a customer-specific “single system” view 601 via a unified storage management user interface supplied by storage hub manager 350, even when a plurality of storage service cells 301 are protecting each customer's data, according to an illustrative embodiment. The present figure depicts customer A receiving a view 601A provided by storage hub manager 350 via a unified storage management user interface 602; likewise, customer M receives a view 601M provided by storage hub manager 350 via the unified storage management user interface 602. Storage hub manager 350 is communicatively coupled with a storage manager 640 in each subtending storage service cell 301-1 through 301-N (e.g., storage managers 640-1 . . . 640-N). Storage hub manager 350 assigns each customer's data protection duties to one or more storage service cells 301 and collects information therefrom for reporting to customers via the unified user interface 602, e.g., customer views 601A, 601M, etc. See also FIGS. 8A, 8B, and 9.

Customer view 601 (e.g., 601A . . . 601M) is for each distinct customer their own “single-system” view of system 300 provided by user interface 602. Customer view 601 excludes information about other customers, e.g., administrative preferences, data sources, and/or secondary copies.

Unified storage management user interface 602 is a user interface designed to provide each customer with their own “single-system” view 601 within system 300. User interface 602 is supplied by storage hub manager 350. To provide customer view 601, user interface 602/storage hub manager 350 filters out other customers' information as well details about system 300 that are not for customer consumption, e.g., cell 301 configurations, rules for making assignments and assignments, other customers' profiles, preferences, and data, etc. Thus, user interface 602 is used for performing any customer-driven operation available in a system 100/200, including administering storage operation preferences, defining clients and subclients, adding new backup entities, modifications thereto, and deletion thereof, without limitation.

Furthermore, to provide customer view 601, user interface 602/storage hub manager 350 aggregates information from the plurality of storage service cells 301 that have been assigned to service the present customer, so that cell boundaries and contours are not apparent in customer view 601, e.g., aggregating views of servers, hypervisors, jobs, events, alerts, company-related information, identity provider, etc. User interface 602 comprises drill-down features that enable a customer to obtain details about certain entities in the “single-system” customer account facilitated/managed by storage hub manager 350. In some drill-down scenarios, the customer is actually in communication with a storage manager 640 at a storage service cell 301, but the storage service cell identity is not provided in user interface 602; rather, user interface 602/storage hub manager 350 controls and limits the customer's view/access to their own administrative parameters (e.g., storage policies, schedules, etc.) and secondary copies (backup data) 116. This aspect enforces separation of different customers' views of system 300. User interface 602 is provided by aggregator 850 (see FIG. 8A) executing on storage hub manager 350 and/or by a user interface server module (not shown) in communication with aggregator 850 and also executing on storage hub manager 350. The customer-specific restrictions that keep one customer from seeing other customers' data is based at least in part on relationship information in graph database 854. Likewise, some users associated with a customer (or with a customer account) are authorized to use the customer's account but have limited permissions. User interface 602 manages those limited permissions as well, based at least in part on information in graph database 854. See also FIG. 8A.

User interface 602 supports global searching by customers, ensuring that the search is applied across storage service cells 301, whether through the document-oriented database at storage hub manager 350 and/or through polling of individual storage service cells 301. Notably, the user has visibility into their own administrative information and secondary copies across the system and may search accordingly, without visibility into which cell 301 hosts the searched-for information and/or secondary copies within system 300. Drill-down does not require logged in customers to log in again, even if the drill-down leads the user to an individual storage service cell 301. In such a scenario, storage hub manager 350 handles the access into the individual storage service cell 301. Thus, storage hub manager 350 is configured to provide a user interface 602 for global searching across the data storage management system 300 for each distinct customer, for finding secondary copies 116 associated with the distinct customer, wherein each secondary copy 116 was generated by storage operations at one of the storage service cells 301 among the plurality of storage service cells of the system, and wherein the user interface 602 is supplied by the storage hub manager and is not supplied by the storage managers 640 in the plurality of storage service cells 301. Furthermore, storage hub manager 350 is configured to block each distinct customer from viewing other customers' storage operation preferences and secondary copies 116 at any of the plurality of storage service cells 301.

Storage manager 640 is analogous to storage manager 140 and manages storage operations in a storage service cell 301 (e.g., 301-1 . . . 301-N) with the aid of a management database 146. See also FIG. 7A. Storage manager 640 additionally comprises features for operating in system 300, e.g., enabling storage hub manager 350 to tap into one or more active message queues at the storage manager's local management database, e.g., management database 146. See also FIG. 9.

FIG. 7A is a block diagram illustrating some salient portions of system 300, including some components of a storage service cell 301-1 protecting customer laptop data according to an illustrative embodiment. The present figure depicts: customer A's data sources 112A-1 (e.g., laptop data on any number of laptop/mobile computing devices); storage service cell 301-1 comprising secondary copies 116A-1, data agents 142, media agents 144, storage manager 640 and associated/local management database 146; and storage hub manager 350. Storage manager 640, data agents 142, and media agents 144 are communicatively coupled via communication pathways 114. According to an illustrative embodiment, storage service cell 301-1 is configured for protecting laptop data and therefore can accommodate several customers' laptop data, even though only customer A's laptop data is shown here for simplicity.

Storage service cell 301-1 comprises a number of components, including data agents 142, media agents 144, and storage manager 640, which logically comprises management database 146. Secondary copies 116 (e.g., 116A-1) are generated by storage service cell 301 (e.g., 301-1) and are not necessarily part thereof. Likewise, data storage resources for storing secondary copies 116 are not necessarily part of storage service cell 301.

Data sources 112A-1 belong to customer A and are protected by storage service cell 301-1. In some embodiments, a snapshot (not shown here) of the customer's original primary data is used as a data source for storage operations performed by storage service cell 301-1. The snapshot is not necessarily part of storage service cell 301-1.

Data agents 142 are components of storage service cell 301-1. In some configurations, data agents 142 are co-located with the data source, e.g., on a laptop client computing device 102. To protect laptop data, a data agent 142 (e.g., a file system data agent) is installed and executes on each laptop computing device (not shown here). See, e.g., FIGS. 1A and 1C. Media agents 144 are installed on and execute on a secondary storage computing device (e.g., 106 not shown here) and generate secondary copies 116A-1, which are stored thereby to one or more destination storage resources 108 (not shown here). Destination storage resources 108 can be tape libraries, disk libraries, and/or cloud-based storage resources, without limitation. The present figure does not depict access to/from cloud-based storage resources, but the invention is not so limited, and in some embodiments data sources that are not cloud-based, such as the laptop data depicted here, is protected by secondary copies 116 stored in cloud-based storage.

Storage hub manager 350 is communicatively coupled with each subtending storage service cell 301 (e.g., 301-1) via its storage manager 640. More details are given in FIG. 9.

FIG. 7B is a block diagram illustrating some salient portions of system 300, including a data protection scenario in which data sources and storage service cell 301-2 operate in a cloud computing environment 701 according to an illustrative embodiment. The present figure depicts: cloud-based data sources 112A-2; storage service cell 301-2 comprising secondary copies 116A-2, media agents 144, storage manager 640, data agents 742, binaries 743, and customer account access module 750; storage hub manager 350; and cloud computing environment 701, which comprises the customer's data sources 112A-2 and storage service cell 301-2. In this configuration, cloud-based data sources are protected by cloud-based resources in storage service cell 301-2 operating in the same cloud computing environment 701. However, the invention is not limited to same-cloud implementations, and in some embodiments, data sources from one cloud computing environment are protected by secondary copies stored in another cloud computing environment and/or in a non-cloud data center. According to an illustrative embodiment, storage service cell 301-2 is configured for protecting cloud-based data and therefore can accommodate several customers' cloud-based data, even though only customer A's data is shown here for simplicity. See also FIG. 5.

Data sources 112A-2 belong to customer A and are protected by storage service cell 301-2. These data sources comprise data that is generated by cloud-based applications such as Microsoft Office 365, SharePoint Online, Exchange Online, OneDrive, Google Drive, etc. without limitation. Customer A may have other cloud-based data sources 112A in the same cloud service account in cloud computing environment 701, such as virtual machine data, serverless applications, databases-as-a-service, etc. In some embodiments, a snapshot (not shown here) of the customer's original primary data is used as a data source for storage operations performed by storage service cell 301-2 and is not necessarily part of storage service cell 301-2.

Media agents 144 execute on a host computing device that comprises one or more hardware processors, and in cloud computing environment 701 each media agent 144 executes on a virtual machine (not shown here) that is active in environment 701. Each media agent 144 is in communication with one or more data agents 742. In some embodiments, a media agent 144 executes on the same virtual machine as a media agent 742. Each media agent 144 generates secondary copies 116 and stores them to suitable storage resources, such as cloud-based storage resources for secondary copies 116A-2. Cloud-based computing resources, cloud-based virtual machines, and cloud-based storage resources are well known in the art.

In some embodiments a media agent 144 is configured outside cloud computing environment 701 in a configuration that is “proximate” (from a data networking perspective) to destination data storage resources for storing secondary copies 116A-2, e.g., in another cloud computing environment, in another cloud availability zone, or in a non-cloud data center. In such configurations, the customer's source data 112 is protected in an environment different from the source, which may be desirable for risk reduction and/or cost reasons. Thus, a storage service cell 301 may comprise components that are physically distributed in a multi-cloud environment, in a multi-zone environment, or in a hybrid computing environment that combines cloud and non-cloud resources, without limitation. In some embodiments, a first round of secondary copies 116 are stored in cloud computing environment 701 and auxiliary copies, reference copies, and/or archive copies are stored outside cloud computing environment 701, without limitation. In all these scenarios, media agents 144 communicate with storage manager 640, which is responsible for managing storage operations in storage service cell 301-2.

Storage service cell 301-2 is delineated by the curved dashed outline and comprises a number of components for protecting data sources 112A-2 and other data sources 112 in the present cloud computing environment 701. Preferably, data sources in another cloud computing environment or in another cloud availability zone are protected by a storage service cell 301 deployed in that other cloud computing environment/zone. This kind of specialized configuration provides one of the advantages of the present solution, i.e., servicing a plurality of customers using a specially-configured storage service cell 301. Components 742, 743, and 750 represent that specialized configuration, at least in part. The specialized configuration comprises source-specific components (e.g., 742, 743) as well as access interfaces for reaching data sources in the various customer cloud service accounts (e.g., element 750) that include security measures and features for interoperating with the particular cloud computing environment hosting the source data. Arranging specialized storage service cells geographically to be closer to the data sources being protected, e.g., in the same cloud availability zone, in the same cloud service provider's cloud computing environment, in network proximity, etc. advantageously minimizes network complexity and cloud access costs.

Storage hub manager 350 is depicted here outside cloud computing environment 701, but the invention is not so limited. Storage hub manager 350 is, in some embodiments, implemented in cloud computing environment 701, without limitation. More details on storage hub manager 350 are given in subsequent figures, e.g., FIG. 8A, 8B, 9.

Cloud computing environment 701, e.g., Microsoft Azure, Amazon Web Services (AWS), etc., is provided by a cloud service provider as described in more detail above. Cloud computing environment 701 is well known in the art. Each customer discussed in the present application (e.g., A, B, C . . . M) may have one or more cloud service accounts with the cloud service provider of environment 701. Each cloud service account may comprise one or more data sources 112, such as the depicted customer A's data sources 112A-2. As explained earlier, different customers' data sources 112 are distinct from each other even if they all reside in the same cloud computing environment 701.

Storage manager 640 is communicatively coupled (e.g., using communication pathways 114 not labeled in the present figure) with any number of media agents 144 and data agents 742, and is also in communication with storage hub manager 350, which may be deployed in the present cloud computing environment 701, in another cloud computing environment, or in a non-cloud data center, without limitation.

Data agents 742 (e.g., 742X, 742Z) are analogous to data agent 142, and additionally comprise features for operating in a cloud computing environment for protecting cloud data sources. Thus, each data agent 742 interfaces with corresponding binaries 743 that can access a particular cloud-based data source. Accordingly, SharePoint data agent 742X interfaces with SharePoint binaries 743 for accessing SharePoint data in a cloud service account. Each data agent 742 executes on a host computing device that comprises one or more hardware processors, and in cloud computing environment 701 data agent 742 executes on a virtual machine (not shown here) that is active in environment 701. In some embodiments, data agent 742 also comprises binaries 743 and access module 750, thereby providing the complete functionality for accessing and obtaining customers' data, for processing data protection operations, and conversely for restoring data to customers' cloud service accounts, but the invention is not so limited.

Binaries 743 (e.g., 743X, 743Z) comprise one or more executable files and/or libraries for executing an application within storage service cell 301-2 that is specially adapted for extracting source data 112 from a corresponding application executing in a customer cloud service account, e.g., by using application-native APIs to extract data from the targeted customer application. For example, binaries 743X execute SharePoint Online for accessing (e.g., using SharePoint-native APIs) data generated by a customer's SharePoint Online account in cloud computing environment 701. For example, binaries 743Z execute Exchange Online for accessing (e.g., using Exchange-native APIs) data generated by a customer's Exchange Online account in cloud computing environment 701. Access to each customer's cloud service account(s) is managed by one or more modules 750. Any number of distinct binaries 743 can be used in each storage service cell 301, e.g., binaries for Microsoft Office 365, Microsoft One Drive, Google Drive, etc., without limitation. Each binaries 743 executes on a host computing device that comprises one or more hardware processors, and in cloud computing environment 701 binaries 743 execute on a virtual machine (not shown here) that is active in environment 701.

Module 750 (or customer account access module 750) is a functional component of storage service cell 301-2, which is specially configured to provide secure access from cell 301-2 to customer data in customers' cloud service account(s) in environment 701. For example, module 750 manages passwords and other access interfaces for obtaining access to customers' cloud service account(s), and is well known in the art. Each module 750 executes on a host computing device that comprises one or more hardware processors, and in cloud computing environment 701 module 750 executes on a virtual machine (not shown here) that is active in environment 701. As noted above, in some embodiments module 750 is configured as a functional component of data agent 742 and/or is accompanied therein by binaries 743 in any combination, without limitation. In some embodiments, module 750 obtains authentication information and/or credentials from storage hub manager 350 (e.g., information 882).

In some embodiments, a combination of components 742, 743, and 750 are collectively referred to as an “access node” for accessing cloud-based data. The access node is implemented as a computing device having one or more processors and executing components 742, 743, and 750. In other embodiments, the access node is implemented on one or more virtual machines, e.g., in a cloud computing environment, wherein each virtual machine is executed by a computing device having one or more processors. In some other embodiments, the access node additionally comprises a media agent 144.

FIG. 8A is a block diagram illustrating some salient logical components of a storage hub manager 350 according to an illustrative embodiment. Storage hub manager 350 comprises a number of functional components and data structures, some of which are depicted in the present figure: management database 846; aggregator 850; assignment manager 852; graph database 854; cache manager 856; and document-oriented database 858. As depicted in other figures, storage hub manager 350 is in communication with customers A . . . M and with storage service cells 301-1 . . . 301-N via their respective storage managers 640. Storage hub manager 350 executes on a computing device that comprises one or more processors and computer memory and which may be implemented as a virtual machine or as a traditional non-virtualized computing device, without limitation. In some embodiments, storage hub manager 350 comprises a computing device that comprises one or more processors and computer memory. In some embodiments, database 846 and/or database 854 are stored on an associated computing device, database server, and/or storage resource but are not physically in storage hub manager 350, yet they remain logical components of storage hub manager 350.

Management database 846 is analogous to management database 146, which is a local part of every storage service cell 301, but database 846 comprises distinct information necessary for storage hub manager 350 to operate in system 300. For example, assignment rules, customer/user information, storage service cell attributes, configuration settings, and system preferences, etc., are key information needed by storage hub manager 350 and are maintained in database 846. On the other hand, administrative details needed by each storage service cell 301, e.g., storage operation preferences, storage policies, entity definitions, client definitions, subclient definitions, backup schedules and schedule policies, backup job status and pointers, etc., are not kept at management database 846 and are kept instead by the local management databases 146 configured in each storage service cell 301. Management database 846 is analogous to management databases 146 in the sense that it is illustratively a Microsoft SQL database having a schema consistent with a database 146 schema, but the invention is not so limited. Management database 846 stores information pertinent to storage hub manager 350 in reference to system 300, while leaving detailed cell-by-cell administrative details to the local management databases 146. See also FIG. 8B.

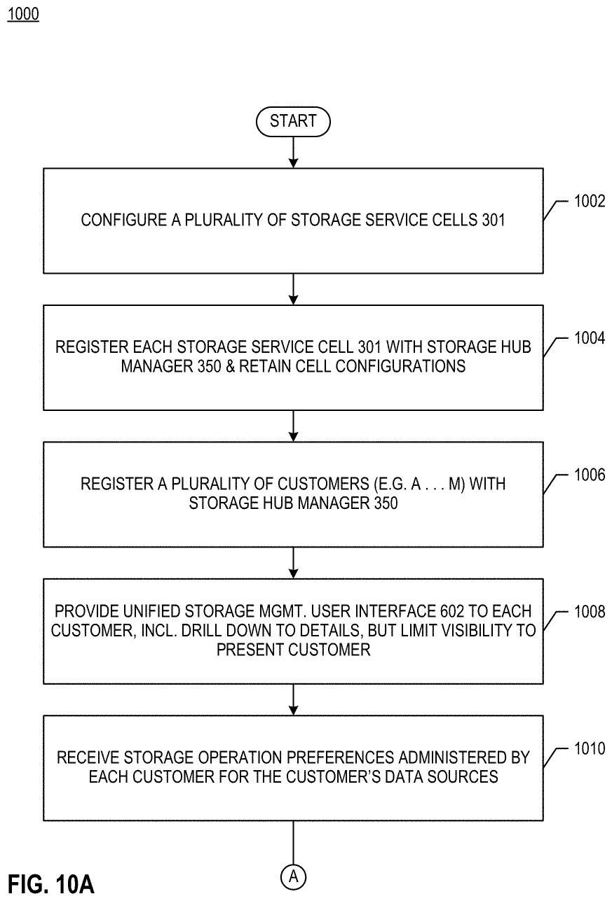

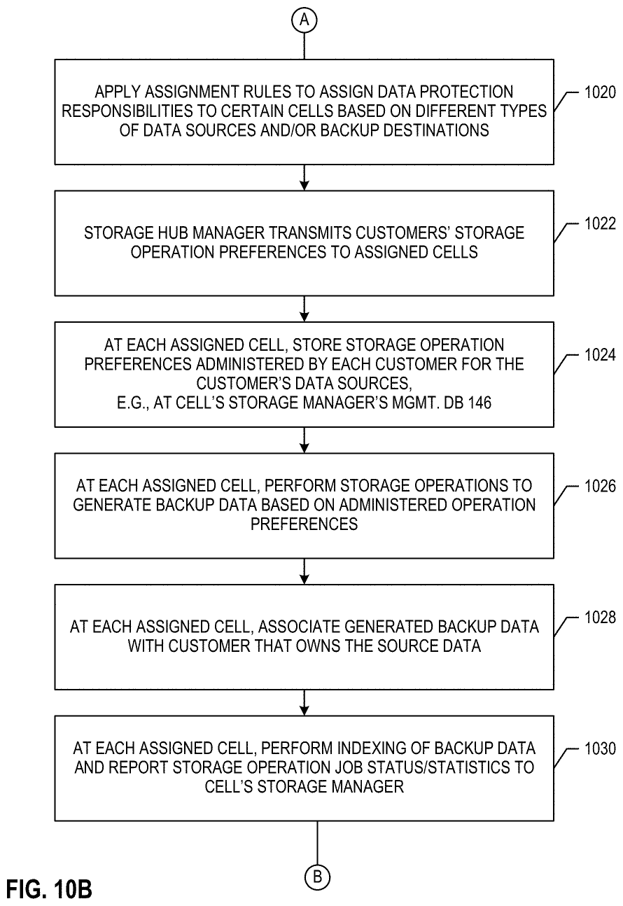

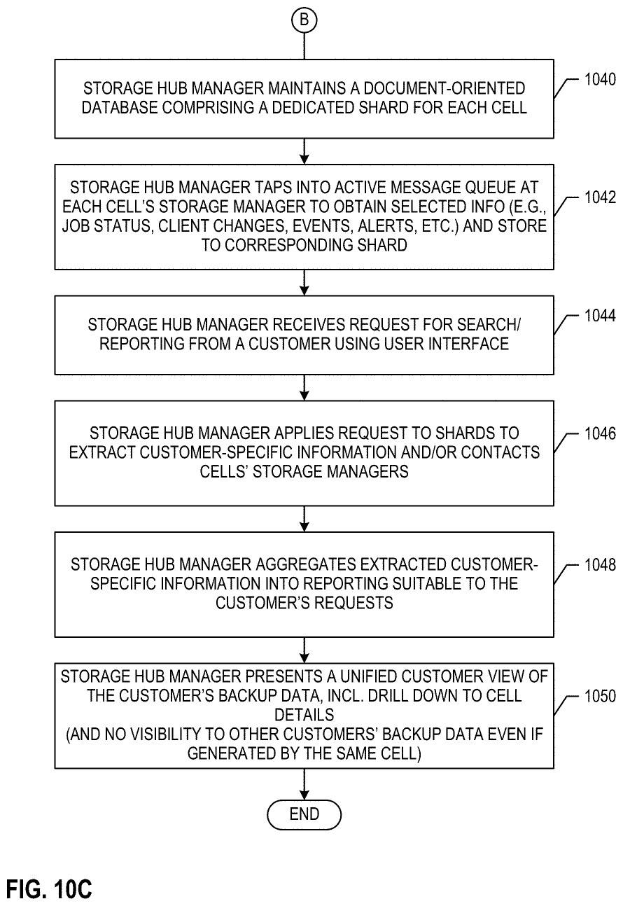

Aggregator 850 is a functional component of storage hub manager 350. Aggregator 850 performs a number of key functions, including but not limited to: executing user interface 602 for presenting a unified “single-system” view 601 to each customer that enables the customer to administer their data protection preferences, search for information and/or for backup data (secondary copies) 116, and obtain reports on data protection services performed by system 300. Aggregator 850 interoperates with other functional components and data structures in storage hub manager 350. See also FIGS. 10A-10C. User interface 602 is provided by aggregator 850 executing on storage hub manager 350 and/or by a user interface server module (not shown) in communication with aggregator 850 and also executing on storage hub manager 350. The customer-specific restrictions that keep one customer from seeing other distinct customers' data is based at least in part on relationship information in graph database 854. Likewise, some authorized users associated with a customer (or with a customer account) have limited permissions. User interface 602 manages those limited permissions as well, based at least in part on information in graph database 854.

Assignment manager 852 is a functional component of storage hub manager 350. Assignment manager 852 is generally responsible for assigning certain data sources 112 to be protected by certain storage service cells 301, i.e., assigns data protection responsibilities for each data source of a distinct customer to one or more storage service cells 301. To perform the assigning, assignment manager 852 uses assignment rules obtained from management database 846. For example, an assignment rule specifies that certain data sources (e.g., Office 365, SharePoint) in a certain Microsoft Azure cloud availability zone are to be assigned to a storage service cell 301 that is specially configured for protecting those kinds of data sources in that availability zone, e.g., has suitable data agents 742, suitable binaries 743, and suitable cloud access. See, e.g., FIG. 7B. For example, another assignment rule specifies that desktop and laptop data sources are to be assigned to a storage service cell 301 that is specially configured for protecting these kinds of data sources, e.g., has suitable data agents 142 (e.g., file system data agents) and destination storage resources for secondary copies 116 in the same or proximate data network. See, e.g., FIG. 7A. For example, another assignment rule specifies that virtual machines (VMs) based in a data center (e.g., VMWare) are to be protected by a storage service cell 301 equipped with suitable virtual server data agents in the data center, but VMs based in a cloud computing environment are to be protected by another storage service cell 301 that is equipped with virtual server data agents in the cloud computing environment.

In some embodiments, the assignment rules match attributes of data sources (e.g., type of data, type of data location, cloud service provider, availability zone, geography, etc.) to attributes of storage service cells 301 (e.g., type of data agents, type of network, type of destination location, cloud service provider, availability zone, geography, etc.) and assignment manager 852 uses other data structures in database 846 (e.g., storage cell configuration information and/or attributes) to make the assignments, matching sources and cells according to their attributes. In other embodiments, the assignment operation further includes other considerations, such as whether the customer signed up for exclusive storage cells or shared cells. Assignment manager 852 also is responsible for making re-assignments, such when new cells 301 are added to system 300, when cells 301 are taken out of service, when cells 301 are re-configured, e.g., with additional data agents and/or network connectivity, when load balancing is needed based on performance characteristics of certain cells 301, etc. Assignments, once they are made, are stored in management database 846.

Graph database 854 is a database data structure that stores information and relationships. A graph database “uses graph structures for semantic queries with nodes, edges, and properties to represent and store data. A key concept of the system is the graph (or edge or relationship). The graph relates the data items in the store to a collection of nodes and edges, the edges representing the relationships between the nodes. The relationships allow data in the store to be linked together directly and, in many cases, retrieved with one operation.” Wikipedia, Graph database, en.wikipedia.org/wiki/Graph database (accessed Dec. 19, 2019). Accordingly, graph database 854 as illustratively implemented in and/or associated with storage hub manager 350 comprises security-related information, such as authorization data for managing which customers are given access to which information in system 300. This enables each customer to receive secure access to system 300 and to view their own—and only their own—backed up data (e.g., secondary copies 116), reports, administered information, storage operation preferences, etc. In some embodiments, graph database 854 registers with active message queues 946 to “listen to” changes in security settings that might be implemented directly at storage managers 640, rather than being implemented centrally through storage hub manager 350. This additional aspect ensures that all security/permissions are safely managed by graph database 854. Assignments 888 (or information therein) are stored in whole or in part in graph database 854 in some embodiments. In some embodiments, graph database 854 is organized into portions that correspond to each storage service cell 301, but the invention is not so limited.

Cache manager 856 is a functional component of storage hub manager 350. Cache manager collects information from management databases 146 in storage service cells 301 and populates the information appropriately to database 858, which is then accessed by aggregator 850 to support searches and reports from/to customers A . . . M. For example, when populating entries into database 858, cache manager 856 adds customer identifiers and timestamps to the data entries. To obtain certain relevant information, cache manager 856 interoperates with one or more active message queues 946 at each management database 146, which comprise update information coming in from various components of the respective cell 301, e.g., from media agents, data agents, network components, etc. Only certain information is collected from each cell 301 and the databases 146 are not duplicated into database 858 at storage hub manager 350. More details are given in FIG. 9.

Document-oriented database 858 is a data structure that stores certain selected information collected from cells 301 which is readily available for customer searching and reporting at storage hub manager 350. “A document-oriented database, or document store, is a computer program designed for storing, retrieving and managing document-oriented information, also known as semi-structured data. Document-oriented databases are one of the main categories of NoSQL databases . . . .” Wikipedia, Document-oriented database, en.wikipedia.org/wiki/Document-oriented database (accessed Dec. 19, 2019.) An illustrative embodiment for database 858 is MongoDB (www.mogodb.com/what-is-mongodb (accessed Dec. 19, 2019)), but the invention is not limited to MongoDB implementations. Database 858 is implemented with shards such that each shard corresponds to a storage service cell 301. Accordingly, to respond rapidly to a query from a customer, aggregator 850 queries database 858, navigating across the shards to collect the responsive information needed for the querying customer. Information associated with other customers served by the same storage service cell 301 also may be present in the database shard but is not used to respond to the query as it does not belong to the querying customer. Database 858 is used as a cache, i.e., for locally stored information to produce speedy data queries and responses of selected information. In the event sought-after information is not available from database 858, aggregator 850 obtains the information directly from the subject cell or cells 301 (e.g., accessing management database 146). This is accomplished by aggregator 850 invoking cache manager 856, another functional component (not shown), or directly accessing without an intermediary component the subject cell(s) 301. More details are given in FIG. 9.

Other functional components of storage hub manager 350 are not shown here, e.g., a user interface server, network interfaces, etc.

FIG. 8B is a block diagram illustrating some salient data structures stored at management database 846 configured in an illustrative storage hub manager 350 according to an illustrative embodiment. The present figure comprises: management database 846, cell configurations 880, user/customer ID 882, customer data sources and data types 884, assignment rules 886, and assignments 888.

Management database 846 is a logical part of storage hub manager 350 and comprises various information needed for managing system 300. Management database 846 is a central repository of information and is updated by storage hub manager 350 as relevant information is added, updated, and/or deleted. Some of the updates to database 846 are performed by administrators of system 300, whereas other updates are entered automatically through electronic communications between components, e.g., between storage hub manager 350 and storage service cells 301. Information in database 846 is organized illustratively in a Microsoft SQL relational database, but the invention is not so limited; the data structures and information described in regard to the present figure can be organized in any fashion within database 846 without limitation.

Information 880 comprises a catalog of the storage service cells 301 that are active in system 300. Each storage service cell 301 is accompanied by attributes such as cell configuration details, settings, and/or preferences such as cell ID, storage manager 640 address, available resources (e.g., media agents, data agents, binaries, data storage destinations, cloud access nodes), networking capabilities (e.g., internet, intranet, cloud computing environment, cloud availability zone), geography, etc. Some cells 301 may be flagged “for exclusive use” by a single customer, though the preferable default is to allow data from multiple customers to be protected by a single cell 301. Collectively, information 880 provides details on the infrastructure available in system 300.

Information 882 comprises a catalog of distinct customers and customers' users who are authorized to access system 300. For example, information 882 includes company/customer IDs, lists/mappings of authorized users for each customer, user permissions, authentication information, credentials for cloud computing environment access, subscription terms, etc. Some users have “landlord” permissions, meaning that a user has administrative access for a plurality of “tenant” customers. Such a “landlord” user is distinguishable from the operator of system 300, because the landlord user has privileges limited to only the tenants associated with the landlord, wherein the operator of system 300 has universal privileges for configuring system 300. At least some of the relationships in information 882 are reflected in graph database 854 for controlling access between customers and system 300.

Information 884 comprises information about customers, such as identifying data sources and/or type of data sources (e.g., file data in a data center in New Jersey, USA; Office 365 data in Azure cloud Eastern US zone; DBaaS in Oracle cloud Western Europe zone; VMs in a VMWare data center in Washington D.C., USA; cloud-based VMs in AWS Eastern US zone; etc.). Customer preferences such as whether certain or all customer data requires exclusive use of cells 301 (i.e., no sharing with other customers) also are included in information 884. Collectively, information 882 provides details on customers' data sources sufficient to allow assigning each customer to one or more storage service cells 301 throughout system 300, e.g., data types, host and/or destination cloud computing environments, availability zones, geography, network/subnetwork identifiers, etc.

Assignment rules 886 comprise a number of rules for matching customers' data sources to suitably configured and suitably situated storage service cells 301. System 300 advantageously applies rules 886 to data sources (e.g., 884) using details about system 300 infrastructure (e.g., 880) to determine what assignments are suitable. Illustratively, assignment manager 852 in storage hub manager 350 performs the assignment operations. Preferably, the assignment process is dynamic such that assignment manager 852, on becoming aware of changes in cells 301 (e.g., information 880), determines whether to change assignments.

Example Assignment Rules. While there are no limitations on assignment rules 886, some illustrative examples are presented here to enhance the reader's understanding of the present disclosure:
Match geography of data sources 112 and destination storage for backup data 116, i.e., use the same geography, but for auxiliary and/or archive copies use a different destination geography.
Match cloud availability zone of data sources 112 and destination storage for backup data 116, i.e., use the same cloud service provider and availability zone, but for auxiliary and/or archive copies, use a different cloud availability zone and/or a different cloud computing environment (different cloud service provider).
For a cloud-based data source, use a storage service cell equipped with access node(s) that are configured for the cloud data source (e.g., binaries 743 matching and/or compatible with the data source(s), access module 750 for the source cloud computing environment, data agents 742 for the data source(s), etc.).
For cloud-based virtual machine data, use a storage service cell equipped with access node(s) that are configured for the cloud data source (e.g., access module 750 for the source cloud computing environment, virtual server data agents 742 for the VM data source(s), etc.).
For non-cloud data sources, use a storage service cell equipped with suitable data agents 142.
For cloud-based secondary copy destinations, use a storage service cell equipped with access nodes(s) for accessing the cloud-based destination (e.g., access module 750), media agents 144 configured on the destination cloud computing environment, etc.
For legal hold copies, use a storage service cell configured in a data center and/or cloud computing environment specially designated for handling the legal matter at hand.
For certain customer accounts, assign a storage service cell 301 dedicated exclusively to the customer account.
   See other examples in the text accompanying assignment manager 852 in FIG. 8A. All these examples are illustrative. In other embodiments, other combinations and permutations are implemented and enforced via rules 886.

Assignments 888 is a data structure that stores results of the assignment operations made by assignment manager 852. System 300 provides its operator with the flexibility to add and/or change rules 886, and further to modify assignments 888 if need be to suit configurations that the rules do not anticipate. Assignments 888 are used for directing administration performed by customers to certain assigned cells 301, e.g., via graph database 854. Thus, in some embodiments, at least some of the relationships reflected by the assignments are included in graph database 854.

The information depicted here, as well as other data stored in management database 846 at storage hub manager 350 may be arranged and organized as shown here or in any other combination, permutation, portion, etc., without limitation. Furthermore, any and all information in management database 846 is available to all functional modules of storage hub manager 350, including aggregator 850, assignment manager 852, cache manager 856, etc., without limitation.

FIG. 9 is a block diagram illustrating the use of a document-oriented database in system 300 according to an illustrative embodiment. The present figure depicts: storage service cells 301, each cell comprising management database 146 and active message queue 946; aggregator 850; cache manager 856; and document-oriented database 858 comprising shards 958.

Active message queue 946 is a data structure maintained by storage manager 640, which includes updates received from various components of a storage service cell 301 to be incorporated into the storage service cell's management database 146 in the storage service cell. The queue 946 effectively operates as a change tracker for cell 301. As information is administered into cell 301, the transactions are added to queue 946, e.g., new clients, deleted clients, new mount paths, new subclients, new backup sets, new disk libraries, etc. Additionally, storage operations in cell 301 also generate entries in queue 946, e.g., new jobs submitted, job completion status, error/status messages, alerts, events, etc. According to the illustrative embodiments, cache manager 856 is configured to tap into (e.g., subscribe) to queue 946 and to selectively collect updates carried by certain messages in queue 946. Thus, cache manager 856 is said to subscribe to certain channels of each queue 946 in order to collect some but not necessarily all information being fed into management database 146. Illustratively, cache manager 856 collects the following types of messages from queues 946 throughout system 300: information on new, changed, and/or deleted clients; information on newly submitted requests for storage jobs (e.g., backup jobs, restore jobs, etc.) being submitted for execution; events, and alerts, without limitation. Other information that passes through queue 946 is not collected by cache manager 856 and resides in management database 146, whence it can be extracted if need be. The information collected from queues 946 is populated by cache manager 856 into a database shard 958 that corresponds to the storage service cell 301 that originated the collected information.

Shards 958 are portions of database 858. Shards are well known in the art. For example, MongoDB supports sharding. According to the illustrative embodiments, a shard 958 is configured for each storage service cell 301 in system 300. In some embodiments, Since each cell 301 comprises secondary copies 116 for one or more customers, the information populated into corresponding shard 958 could be associated with more than one customer. Cache manager 856 adds customer identification to each entry it makes in shards 958 so that customer-specific information can be properly extracted from database 858. In some embodiments, shards 958 reside on separate database servers, but the invention is not so limited. In some embodiments, shards 958 reside on separate database servers at the associated storage service cell 301, but the invention is not so limited. Shards 958 and database 858 are logical components on storage hub manager 350 and their physical implementation and/or location is not limiting.

FIGS. 10A-10C depict some salient operations of a method 1000 according to an illustrative embodiment. Method 1000 is performed by components of system 300 as described in more detail below.

At block 1002, a plurality of storage service cells 301 are configured in system 300. Each storage service cell 301 comprises a storage manager 640 and access to any number of storage destination(s) for storing secondary copies 116, e.g., one or more cloud computing environments, one or more cloud availability zones, one or more non-cloud data centers, etc. Each storage service cell 301 further comprises computing devices and/or cloud computing resources for executing any number of media agents 144 with access to the storage destinations. Furthermore, each storage service cell 301 further comprises computing devices and/or cloud computing resources for executing any number of data agents 142/742, binaries 743, access modules 750, and/or access nodes, without limitation. Preferably, cells 301 are specialized and accordingly each cell 301 has a limited variety of resources, e.g., access nodes for AWS cloud computing environment, but no access nodes for Microsoft Azure; access nodes for AWS Eastern US cloud availability zone but not for other AWS availability zones; data agents 142 for protecting virtual machines in non-cloud data centers; data agents for file system data on laptops; cloud storage destinations; non-cloud storage destinations; etc., without limitation. Illustratively the operator of system 300 is responsible for performing block 1002.

At block 1004, each storage service cell 301 (e.g., using storage manager 640) registers with storage hub manager 350. This operation ensures that networking connections are made between storage hub manager 350 and each cell 301 in system 300. Furthermore, storage hub manager 350 obtains cell configuration information from each storage service cell 301 and populates management database 846 (e.g., information 880) accordingly. For, example, storage hub manager 350 queries each storage manager 640 for information, which storage manager 640 extracts from management database 146 and/or from other cell components, e.g., media agents 144.

At block 1006, a plurality of distinct customers (e.g., A, B . . . M) register with storage hub manager 350. This operation includes an exchange of credentials for authentication and authorization purposes. New distinct customers and/or new authorized users thereof are added by storage hub manager 350 to information 882 in management database 846. Custom authorizations also take place here, depending on the customer's needs, e.g., users allowed to view but not to make changes to administrative information; users allowed to administer laptop data but not cloud-based data; users allowed to manage virtual machines but not databases; users allowed to activate backups but not to restore backed up data; users allowed to add/administer hardware but not allowed to view data and/or administer storage operation preferences such as storage policies; etc., without limitation. Relationships are added to graph database 854, e.g., associating each distinct customer with a set of authorized users, associating each user with allowed operations (permissions), associating customer accounts with credentials for accessing cloud computing environments 701, etc.

At block 1008, storage hub manager 350 provides to each customer a storage management interface 602. Thus, a user interface feature in storage hub manager 350 (e.g., in aggregator 850, in another module, etc.) provides a suitable user interface 602 for each authorized user that gives a customer-specific view 601, which simulates a single data storage management system, even if the customer's data is protected by a plurality of storage service cells 301. User-specific permissions are also factored in, limiting a user's view or disabling a user's features to comply with permissions. The view and administrative access exclude all other customer's data. The view generally does not present a plurality of storage service cells 301 to the user but does allow the user to drill down for additional details, which might involve accessing resources at one or more cells 301, e.g., storage managers 640. However, at no time does a user have access or visibility to information and/or backup data (secondary copies) for which the user lacks permissions. Thanks in part of graph database 854, the permission relationships are readily available to the user interface feature and are employed for maintaining security and control.

At block 1010, each distinct customer is given administrative privileges for setting up their data protection preferences, e.g., specifying data sources, data attributes, backup sets, preferred destinations, backup schedules, storage operation preferences, retention preferences, etc., without limitation. This information is retained at storage hub manager 350 until such time as assignments are completed (block 1020) and information can be disseminated to the relevant cells 301 (block 1022). In some embodiments, storage hub manager 350 (e.g., using assignment manager 852) organizes information intake from customers such that data sources and desired backup destinations are identified first and are immediately followed by making assignments (block 1020) to one or more cells 301. In some embodiments, when control returns to the user for further administrative operations, e.g., adding schedules, retention times, etc., the administrative tasks are cut through to the individual cell 301 (block 1024), all the while limiting the user's view from other aspects of cell 301. Thus, blocks 1010, 1020, 1022, and 1024 operate iteratively in some embodiments until all administrative storage operation preferences and any other administrative information has been entered by the customer/user and propagated to the affected assigned cells 301. Accordingly, storage hub manager 350 provides a user interface that provides each distinct customer with access to their own storage operation preferences and secondary copies, and blocks each customer from viewing other customers' storage operation preferences and secondary copies at the same storage service cell. Thus each customer views their own data storage management environment but not others'.

At block 1020, storage hub manager 350 (e.g., using assignment manager 852) applies assignment rules 886 to assign data protection responsibilities to certain cells 301, based on different types of data sources and/or backup destinations administered by customers. Examples of assignment rules were given in an earlier figure. In some configurations, a certain cell 301 is assigned because it has access (e.g., access nodes) to the source data. In other embodiments, the destination will drive the assignment decision, e.g., storage of secondary copies to a certain cloud computing environment, non-cloud data center, and/or storage technology (e.g., tape libraries) that is not universally available in every cell 301.

At block 1022, storage hub manager 350 transmits customers' storage operation preferences to each assigned cell 301. As noted, some embodiments permit users to directly access each cell 301 for entering administrative parameters and information, thereby bypassing block 1022.

At block 1024, at each assigned cell 301, storage operation preferences and other information administered for a distinct customer's data sources are stored at the storage service cell's storage manager 640 and/or in management database 146. As noted, some embodiments permit users to directly access each cell 301 for entering administrative parameters and information. Users can add clients, backup groups, subclients, storage policies, schedule policies, deduplication preferences, backup destinations, etc., without limitation. Features available in system 100 are available here in each cell 301, with the proviso that cell configurations limit what features are feasible in the storage service cell.

At block 1026, each assigned cell 301 performs storage operations to generate secondary copies 116 according to administered system preferences, e.g., full backups, incremental backups, archiving, reference copies, legal hold, pruning, synthetic-full backups, health-check reporting, etc. Storage manager 640 of the assigned cell 301 manages the storage operations. Thus, schedules and storage policies stored in the storage service cell's management database 146 drive the initiation of storage operations in each cell 301. Job status, job results, and performance statistics are stored in management database 146 as well. Events and alerts also are stored in management database 146. As noted in FIG. 9, each update is queued up in an active message queue 946 that feeds management database 146. Some of the updates in message queue 946 are trapped by storage hub manager 350 (e.g., using cache manager 856) and brought to storage hub manager 350 and added to a shard 958 that corresponds to cell 301. See also FIG. 9. Thus, in system 300 storage operations are performed by specially-assigned storage service cells 301 that are assigned according to assignment rules. Storage operations back up one or more customers' data in a given storage service cell and associate each resulting secondary copy 116 with the distinct customer whose data was backed up to the secondary copy. Storage operations are based on permissions and privileges of each customer, and each customer's data sources may be backed up by a plurality of distinct storage service cells 301.

At block 1028, when secondary copies 116 are generated, each copy 116 is associated with a customer identifier. This operation is well known in the art but is especially important for the multi-customer cells 301 in the illustrative embodiments, so that different customers' backup data can be properly and securely separated from others'. Associations between backup data 116 and customer identifiers are stored with each backup copy 116 and are also stored in indexes, such as media agent index 153.

At block 1030, indexing is performed for the backup data 116 as is well known in the art, e.g., updating media agent index 153. Media agents 144 and/or data agents 142/742 report job status, job results, and job statistics to the storage service cell's storage manager 640, which updates management database 146 accordingly. Some of this information is extracted by storage hub manager 350 from active message queue 946 for uploading to corresponding shard 958.

At block 1040, storage hub manager 350 maintains a document-oriented database 858, e.g., using cache manager 856 and aggregator 850. As explained in more detail earlier (see, e.g., FIG. 9), database 858 comprises a dedicated shard 958 for each corresponding cell 301. When a new cell 301 is added to system 300, aggregator 850 adds a corresponding shard 958 to database 858. When a cell is taken out of service, the corresponding shard 958 is also retired, though not necessarily deleted, as the information therein may be needed for historical reasons or when the storage service cell 301 is reinstated.

At block 1042, storage hub manager 350 (e.g., using cache manager 856) taps into (e.g., subscribes, polls, etc.) the active message queue 946 at each cell's storage manager 640 to obtain selected information (e.g., job status, client changes, events, alerts, etc.). Certain selected information from active message queue 946 is extracted therefrom (e.g., by cache manager 856) and populated into shard 958. Thus, as storage operations proceed in cell 301 (e.g., backups, restores, migration, pruning, administrative changes, etc.) information destined for management database 146 is queued up at queue 946. Some of that information is added to shard 958 by cache manager 856. Thus, shards 958 receive new information as the various cells 301 go about performing storage operations by virtue of “push” operations from the queue 946. In some scenarios, cache manager 856 performs a “pull” operation by querying and/or polling queue 946 and/or storage manager 640 for particular information not available in the shard 958. Sometimes a query from user interface 602 causes cache manager 856 to “pull” information from one or more storage service cells 301.

At block 1044, storage hub manager 350 receives a request for search/reporting by a customer using the user interface 602. For example, the user is searching for data backed up at a certain point in time; or clicks on a standard report available in the system.

At blocks 1046, 1048, and 1050, storage hub manager 350 (e.g., aggregator 850) formulates a search limited to the user's identity and permissions and applies the search to database 858 to extract information available from one or more shards 958 therein. Aggregator 850 processes the search responses into a unified view 601 and presents it to the user using the user interface 602, thereby hiding the fact that the search might have touched information from a plurality of cells 301. Because document-oriented database 858 contains only selected information, the sought-after information may not be entirely available there. In such a case, aggregator 850 reaches out (e.g., via cache manager 856) to storage managers 640 in cells 301. Each storage manager 640 obtains information from its management database 146 and/or from other components such as media agents 144 to respond to storage hub manager 350. Aggregator 850 collects the information and process it into an integrated single-system view 601 presented to the user via the user interface 602. In some scenarios, the user may want more details. The illustrative user interface 602 has drill-down features that provide the user with access to the individual storage managers 640, yet without revealing information associated with other customers. Likewise, information that is only accessible to administrators of system 300 is generally not visible to customers/users. Thus, at block 1046, the storage hub manager 350 applies the request/query to shards to extract customer-specific information and/or contacts the storage service cells' storage managers to do so. At block 1048, the storage hub manager aggregates extracted customer-specific information into reporting (e.g., data structures, presentation screens, reports, etc.) suitable to the user's requests. At block 1050, the storage hub manager presents a unified customer view of the customer's backup data, which may include drill-down to cell details, but which excludes and provides no visibility to other customers' backup data even if generated by the same cell 301. Likewise, other customers' storage operation preferences and administrative details in storage manager 640/management database 146 also are not visible/accessible to the present customer.

In regard to the figures described herein, other embodiments are possible within the scope of the present invention, such that the above-recited components, steps, blocks, operations, messages, requests, queries, and/or instructions are differently arranged, sequenced, sub-divided, organized, and/or combined. In some embodiments, a different component may initiate or execute a given operation.

### Example Embodiments

Some example enumerated embodiments of the present invention are recited in this section in the form of methods, systems, and non-transitory computer-readable media, without limitation.

According to an illustrative embodiment, a data storage management system comprises: a plurality of storage service cells, wherein each storage service cell comprises a storage manager for managing storage operations within the storage service cell; and a storage hub manager in communication with each storage manager at the plurality of storage service cells; wherein at least one storage service cell among the plurality of storage service cells in the data storage management system is assigned data protection responsibilities for data sources of at least two distinct customers. The above-recited embodiment wherein the storage hub manager is configured to: receive storage operation preferences administered for distinct customers of the data storage management system, wherein each storage operation preference is associated with a data source of a distinct customer. The above-recited embodiment wherein the storage hub manager is configured to: store configuration information about each storage service cell received from each storage manager at the plurality of storage service cells. The above-recited embodiment wherein the storage hub manager is configured to: for each data source of a distinct customer, assign data protection responsibilities to one of the plurality of storage service cells based on: configuration information about the one storage service cell, attributes of the data source, and storage operation preferences administered for the data source. The above-recited embodiment wherein the storage hub manager is configured to: distribute one or more storage operation preferences of one or more distinct customers to each storage service cell based on data protection responsibilities assigned to each storage service cell, wherein each storage manager at a given storage service cell stores each received storage operation preference in association with a distinct customer, and wherein the storage manager manages storage operations within the given storage service cell according to the one or more storage operation preferences received from the storage hub manager.

The above-recited embodiment wherein a first data source of a first customer is backed up at a first storage service cell among the plurality of storage service cells and wherein a second data source of the first customer is backed up at a second storage service cell among the plurality of storage service cells. The above-recited embodiment wherein a first customer's data sources are backed up by at least two storage service cells among the plurality of storage service cells, based on respective data protection responsibilities assigned thereto. The above-recited embodiment wherein a first customer's data sources are backed up into secondary copies based on a storage operation preference associated with each first customer's respective data source; and wherein the first customer's secondary copies are generated by at least two storage service cells among the plurality of storage service cells, based on respective data protection responsibilities assigned thereto. The above-recited embodiment wherein to assign data protection responsibilities to one of the plurality of storage service cells, the storage hub manager is further configured to: identify among the plurality of storage service cells the one storage service cell with a configuration suitable for backing up the data source according to the attributes of the data source. The above-recited embodiment wherein to assign data protection responsibilities to one of the plurality of storage service cells, the storage hub manager is further configured to: identify among the plurality of storage service cells the one storage service cell with a configuration comprising components for backing up the data source according to the attributes of the data source. The above-recited embodiment wherein to assign data protection responsibilities to one of the plurality of storage service cells based on attributes of the data source of the distinct customer indicating that the data source is hosted by a cloud computing environment, and storage operation preferences administered for the data source of the distinct customer, the storage hub manager is further configured to: identify among the plurality of storage service cells the one storage service cell with a configuration comprising access to the cloud computing environment that hosts the data source. The above-recited embodiment wherein the system maintains a many-to-many relationship between distinct customers and storage service cells among the plurality of storage service cells, wherein data sources of a first customer are protected by at least two distinct storage service cells, and further wherein a first storage service cell protects data sources of at least two distinct customers; and wherein the storage hub manager is further configured to block each distinct customer from viewing other customers' storage operation preferences and secondary copies resulting from storage operations in the plurality of storage service cells. The above-recited embodiment wherein the storage hub manager is configured to: provide a user interface, which provides for each distinct customer, features for administering storage operation preferences for the distinct customer's data sources and for accessing the distinct customer's secondary copies resulting from storage operations at one or more storage service cells among the plurality of storage service cells; and block each distinct customer from viewing other customers' storage operation preferences and secondary copies at the one or more storage service cells. The above-recited embodiment wherein the storage hub manager is configured to: provide a user interface for global searching across the data storage management system, for each distinct customer, for finding secondary copies associated with the distinct customer, wherein each secondary copy was generated by storage operations at one of the storage service cells among the plurality of storage service cells, and wherein the user interface is supplied by the storage hub manager and not supplied by the storage managers in the plurality of storage service cells; and block each distinct customer from viewing other customers' storage operation preferences and secondary copies at the plurality of storage service cells. The above-recited embodiment wherein administration of the storage operation preferences is performed via a user interface supplied by the storage hub manager and not supplied by the storage managers in the plurality of storage service cells. The above-recited embodiment wherein the storage hub manager is configured to: maintain a document-oriented database comprising a respective shard dedicated to each storage service cell in the plurality of storage service cells; and add to a given shard dedicated to a respective storage service cell activity information about the respective storage service cell obtained from an active message queue at a storage manager of the respective storage service cell. The above-recited embodiment wherein the storage hub manager is configured to: maintain a document-oriented database comprising a respective shard dedicated to each storage service cell in the plurality of storage service cells; and add to a given shard dedicated to a respective storage service cell activity information about the respective storage service cell obtained from an active message queue at a storage manager of the respective storage service cell; and respond to queries from a customer by aggregating customer-associated information from the shards of the document-oriented database, wherein query responses exclude information associated with other customers of the data storage management system. The above-recited embodiment wherein the activity information of the respective storage service cell obtained from the active message queue comprises one or more of: job status, information about secondary copies generated at the respective storage service cell, client changes, events, and alerts at the given storage service cell.

The above-recited embodiment wherein the storage hub manager is configured to: for a data source of a distinct customer, assign data protection responsibility to a second storage service cell and unassign the responsibility from a previously-assigned storage service cell without notice to the customer. The above-recited embodiment wherein the system expands by adding new storage service cells to the plurality of storage service cells. The above-recited embodiment wherein after the system adds a new storage service cell the storage hub manager is configured to: for a data source of a distinct customer, assign data protection responsibility to the new storage service cell and unassign the responsibility from a previously-assigned storage service cell without notice to the customer. The above-recited embodiment wherein after the system adds a new storage service cell the storage hub manager is configured to: for a data source of a distinct customer, move the secondary copies associated with the data source to the new storage service cell without notice to the customer. The above-recited embodiment wherein after the system adds a new storage service cell the storage hub manager is configured to: for a new data source of a distinct customer, assign data protection responsibility to the new storage service cell even though the new data source has similar attributes to an other data source of the distinct customer for which data protection responsibility was assigned to an other storage service cell, thereby distributing data protection responsibility for certain data source attributes across more than one storage service cell.

According to another illustrative embodiment, a data storage management system comprises: a plurality of storage service cells, wherein each storage service cell comprises a storage manager for managing storage operations within the storage service cell; and a storage hub manager in communication with each storage manager at the plurality of storage service cells; wherein the system maintains a many-to-many relationship between distinct customers and storage service cells among the plurality of storage service cells, wherein data sources of a first customer are protected by at least two distinct storage service cells, and further wherein a first storage service cell protects data sources of at least two distinct customers. The above-recited embodiment wherein the storage hub manager is configured to: receive storage operation preferences administered for distinct customers of the data storage management system. The above-recited embodiment wherein the storage hub manager is configured to: store configuration information about each storage service cell received from each storage manager at the plurality of storage service cells. The above-recited embodiment wherein the storage hub manager is configured to: for each data source of a distinct customer, assign data protection responsibilities to one of the plurality of storage service cells. The above-recited embodiment wherein the storage hub manager is configured to: transmit one or more storage operation preferences of one or more distinct customers to each storage service cell based on data protection responsibilities assigned to each storage service cell, wherein each storage manager at a given storage service cell stores each received storage operation preference in association with a distinct customer, and wherein the storage manager manages storage operations within the given storage service cell according to the one or more storage operations preferences received from the storage hub manager. The above-recited embodiment wherein the storage hub manager is configured to: provide a user interface for global searching across the data storage management system, for finding, for each distinct customer, secondary copies associated with the distinct customer, wherein each secondary copy was generated by storage operations at one of the storage service cells among the plurality of storage service cells, and wherein the user interface is supplied by the storage hub manager and not supplied by the storage managers in the plurality of storage service cells. The above-recited embodiment wherein the storage hub manager is configured to: block each customer from viewing other distinct customers' storage operation preferences and secondary copies resulting from storage operations in the plurality of storage service cells.

The above-recited embodiment wherein for each data source of a distinct customer, data protection responsibilities are assigned to the one storage service cell based on: configuration information about the one storage service cell, attributes of the data source, and storage operation preferences administered for the data source. The above-recited embodiment wherein to assign data protection responsibilities to the one storage service cell, the storage hub manager is further configured to: identify among the plurality of storage service cells the one storage service cell with a configuration comprising components for backing up the data source according to attributes of the data source. The above-recited embodiment wherein to assign data protection responsibilities to the one storage service cell for a data source hosted by a cloud computing environment, the storage hub manager is further configured to: identify among the plurality of storage service cells the one storage service cell with a configuration comprising access to the cloud computing environment that hosts the data source. The above-recited embodiment wherein the storage hub manager is configured to: maintain a document-oriented database comprising a respective shard dedicated to each storage service cell in the plurality of storage service cells; add to a given shard dedicated to a respective storage service cell activity information about the respective storage service cell obtained from an active message queue at a storage manager of the respective storage service cell; and for each distinct customer, respond to global searching queries by aggregating information associated with the distinct customer from the shards of the document-oriented database, wherein query responses exclude information associated with other distinct customers of the data storage management system. The above-recited embodiment wherein the user interface provides, for each distinct customer, features for administering storage operation preferences for the distinct customer's data sources and for accessing the distinct customer's secondary copies resulting from storage operations at one or more storage service cells among the plurality of storage service cells.

The above-recited embodiment wherein the storage hub manager is configured to: for a data source of a distinct customer, assign data protection responsibility to a second storage service cell and unassign the responsibility from a previously-assigned storage service cell without notice to the customer. The above-recited embodiment wherein the system expands by adding new storage service cells to the plurality of storage service cells. The above-recited embodiment wherein after the system adds a new storage service cell the storage hub manager is configured to: for a data source of a distinct customer, assign data protection responsibility to the new storage service cell and unassign the responsibility from a previously-assigned storage service cell without notice to the customer. The above-recited embodiment wherein after the system adds a new storage service cell the storage hub manager is configured to: for a data source of a distinct customer, move the secondary copies associated with the data source to the new storage service cell without notice to the customer. The above-recited embodiment wherein after the system adds a new storage service cell the storage hub manager is configured to: for a new data source of a distinct customer, assign data protection responsibility to the new storage service cell even though the new data source has similar attributes to an other data source of the distinct customer for which data protection responsibility was assigned to an other storage service cell, thereby distributing data protection responsibility for certain data source attributes across more than one storage service cell.

According to an example embodiment, a data storage management system comprises: a plurality of storage service cells, wherein each storage service cell comprises a respective storage manager, and wherein each storage manager has an active message queue; a storage hub manager in communication with each storage manager at the plurality of storage service cells; and a management database that is a logical component of the storage hub manager; wherein the storage hub manager is configured to: receive a respective registration from each storage manager at the plurality of storage service cells; store at the management database respective configuration information about each storage service cell received from each storage manager at the plurality of storage service cells; receive storage operation preferences administered for distinct customers of the data storage management system, wherein the storage operation preferences are associated with each distinct customer's data sources; and assign data protection responsibilities among the plurality of storage service cells, based on respective configuration information about each storage service cell and further based on the distinct customers' data sources.

The above-recited embodiment wherein the storage hub manager is further configured to: transmit one or more storage operation preferences of one or more distinct customers to the plurality of storage service cells based on respective data protection responsibilities assigned thereto, wherein the storage manager at each storage service cell stores the respective one or more storage operation preferences and associates each of the one or more storage operation preferences with a customer that supplied the respective storage operation preference. The above-recited embodiment wherein at least one storage service cell among the plurality of storage service cells in the data storage management system is assigned data protection responsibilities for one or more data sources of at least two distinct customers. The above-recited embodiment wherein a first data source of a first customer is backed up at a first storage service cell among the plurality of storage service cells and wherein a second data source of the first customer is backed up at a second storage service cell among the plurality of storage service cells. The above-recited embodiment wherein a first customer's data sources are backed up by at least two storage service cells among the plurality of storage service cells, based on respective data protection responsibilities assigned thereto. The above-recited embodiment wherein a first customer's data sources are backed up into secondary copies based on storage operation preferences associated with each respective first customer's data source; and wherein the first customer's secondary copies are generated by at least two storage service cells among the plurality of storage service cells, based on respective data protection responsibilities assigned thereto. The above-recited embodiment wherein the storage hub manager is further configured to: provide a user interface to each distinct customer, wherein each distinct customer receives access to their own storage operation preferences and secondary copies; and block each distinct customer from viewing other customers' storage operation preferences and secondary copies at a same storage service cell. The above-recited embodiment wherein the storage hub manager is further configured to: maintain a document-oriented database comprising a respective shard dedicated to each storage service cell in the plurality of storage service cells. The above-recited embodiment wherein the storage hub manager is further configured to: maintain a document-oriented database comprising a respective shard dedicated to each storage service cell in the plurality of storage service cells; and add to a respective shard dedicated to each storage service cell activity information about each storage service cell obtained from a respective active message queue at a respective storage manager of each storage service cell. The above-recited embodiment wherein the storage hub manager is further configured to: maintain a document-oriented database comprising a respective shard dedicated to each storage service cell in the plurality of storage service cells; add to a respective shard dedicated to each storage service cell activity information about each storage service cell obtained from a respective active message queue at a respective storage manager of each storage service cell; and respond to queries from a customer by aggregating customer-associated information from the shards of the document-oriented database, wherein query responses exclude information associated with other customers of the data storage management system. The above-recited embodiment wherein the activity information of a given storage service cell obtained from a respective active message queue comprises one or more of: job status, client changes, events, and alerts at the given storage service cell.

The above-recited embodiment wherein the storage hub manager controls customer account access, authentication, service allocation, data security, and sharing of information between the storage hub manager and any number of storage service cells that perform storage operations, including data backup, data recovery, and data lifecycle management. The above-recited embodiment wherein cloud-based data sources of a first customer are backed up at a first storage service cell that also backs up other customers' cloud-based data sources; and wherein laptop-based data sources of the first customer are backed up at a second storage service cell that does not back up cloud-based data sources. The above-recited embodiment, wherein the data storage management expands by adding storage service cells to the plurality of storage service cells without requiring additional administrative input from the customers. The above-recited embodiment, wherein the data storage management distributes the generating of secondary copies for a first customer among two or more of the storage service cells in the plurality of storage service cells. The above-recited embodiment, wherein the data storage management distributes the generating of secondary copies for a first customer among two or more of the storage service cells in the plurality of storage service cells without requiring the first customer to select which storage service cells are responsible for backing up the first customer's source data.

According to another example embodiment, a data storage management system comprises: a plurality of storage service cells, wherein each storage service cell comprises a respective storage manager, and wherein each storage manager maintains an active message queue and logically comprises a management database; a storage hub manager in communication with each storage manager at the plurality of storage service cells; and a document-oriented database that is a logical component of the storage hub manager.

The above-recited embodiment wherein the storage hub manager is configured to: receive a respective registration from each storage manager at the plurality of storage service cells; store configuration information about each storage service cell received from each storage manager at the plurality of storage service cells; receive storage operation preferences administered for distinct customers of the data storage management system, wherein the storage operation preferences are associated with each distinct customer's data sources; assign data protection responsibilities among the plurality of storage service cells, based on respective configuration information about each storage service cell and further based on the distinct customers' data sources, wherein at least one storage service cell is responsible for backing up one or more data sources of at least two distinct customers. The above-recited embodiment wherein the storage hub manager is configured to: transmit one or more storage operation preferences of one or more distinct customers to the plurality of storage service cells based on respective data protection responsibilities assigned thereto, wherein the storage manager at each storage service cell stores the respective one or more storage operation preferences to a respective management database and associates each of the one or more storage operation preferences with a distinct customer that supplied the respective storage operation preference. The above-recited embodiment wherein the storage hub manager is configured to: maintain in the document-oriented database a respective shard dedicated to each storage service cell in the plurality of storage service cells; and add to a first shard dedicated to a first storage service cell activity information about the first storage service cell obtained from a first active message queue at a first storage manager of the first storage service cell. The above-recited embodiment wherein a first data source of a first customer is backed up at a first storage service cell among the plurality of storage service cells, and wherein a second data source of the first customer is backed up at a second storage service cell among the plurality of storage service cells. The above-recited embodiment wherein a first customer's data sources are backed up by at least two storage service cells among the plurality of storage service cells, based on respective data protection responsibilities assigned thereto. The above-recited embodiment wherein a first customer's data sources are backed up into secondary copies based on storage operation preferences associated with the first customer's data source; and wherein the first customer's secondary copies are generated by at least two storage service cells among the plurality of storage service cells, based on respective data protection responsibilities assigned thereto. The above-recited embodiment wherein the storage hub manager is configured to: provide a user interface that provides each distinct customer with access to their own storage operation preferences and secondary copies, and blocks each distinct customer from viewing other customers' storage operation preferences and secondary copies at a same storage service cell. The above-recited embodiment wherein the storage hub manager is configured to: respond to queries from a first customer by aggregating customer-associated information from the shards of the document-oriented database, wherein query responses exclude information associated with other customers of the data storage management system. The above-recited embodiment wherein the activity information of a given storage service cell obtained from a respective active message queue comprises one or more of: job status, client changes, events, and alerts at the given storage service cell. The above-recited embodiment wherein the storage hub manager controls customer account access, authentication, service allocation, data security, and sharing of information between the storage hub manager and any number of storage service cells that perform storage operations, including data backup, data recovery, and data lifecycle management. The above-recited embodiment wherein cloud-based data sources of a first customer are backed up at a first storage service cell that also backs up other customers' cloud-based data sources; and wherein laptop-based data sources of the first customer are backed up at a second storage service cell that does not back up cloud-based data sources.

According to an illustrative embodiment, a data storage management system comprises: a plurality of storage service cells, wherein each storage service cell comprises a respective storage manager, and wherein each storage manager has an active message queue; and a storage hub manager in communication with each storage manager at the plurality of storage service cells. The above-recited embodiment wherein the storage hub manager is configured to: receive storage operation preferences administered for distinct customers of the data storage management system, wherein the storage operation preferences are associated with each distinct customer's data sources; assign data protection responsibilities among the plurality of storage service cells, based on respective configuration information about each storage service cell and further based on the distinct customers' data sources, wherein at least one storage service cell among the plurality of storage service cells in the data storage management system is assigned data protection responsibilities for one or more data sources of at least two distinct customers; wherein a first storage manager of a first storage service cell is configured to: initiate generating from first source data of a first customer first secondary copies based on storage operation preferences supplied by the first customer; wherein the first storage manager of the first storage service cell is configured to: initiate generating from second source data of a second customer, which is distinct from the first customer, second secondary copies based on storage operation preferences supplied by the second customer.

The above-recited embodiment wherein the storage hub manager is configured to: receive a respective registration from each storage manager at the plurality of storage service cells; and store respective configuration information about each storage service cell received from each storage manager at the plurality of storage service cells. The above-recited embodiment wherein the storage hub manager is configured to: maintain in a document-oriented database a respective shard dedicated to each storage service cell in the plurality of storage service cells, including a first shard for the first storage service cell; and add to the first shard information about the generating of the first secondary copies and information about the second secondary copies obtained from a first active message queue at the first storage manager. The above-recited embodiment wherein the storage hub manager is configured to: transmit one or more storage operation preferences of one or more distinct customers to the plurality of storage service cells based on respective data protection responsibilities assigned thereto, wherein the first storage manager (i) stores the storage operation preferences supplied by the first customer and associates them with the first customer, and (ii) stores the storage operation preferences supplied by the second customer and associates them with the second customer. The above-recited embodiment wherein a given customer's data sources are backed up by at least two storage service cells among the plurality of storage service cells, based on respective data protection responsibilities assigned thereto. The above-recited embodiment wherein the storage hub manager is configured to: respond to queries from the first customer by aggregating information associated with the first customer from the shards of the document-oriented database, including from the first shard, wherein query responses exclude information associated with other customers of the data storage management system.

In other embodiments according to the present invention, a system or systems operates according to one or more of the methods and/or computer-readable media recited in the preceding paragraphs. In yet other embodiments, a method or methods operates according to one or more of the systems and/or computer-readable media recited in the preceding paragraphs. In yet more embodiments, a non-transitory computer-readable medium or media causes one or more computing devices having one or more processors and computer-readable memory to operate according to one or more of the systems and/or methods recited in the preceding paragraphs.

### Terminology

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources. Two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. For example, while only one aspect of the invention is recited as a means-plus-function claim under 35 U.S.C. sec. 112(f) (AIA), other aspects may likewise be embodied as a means-plus-function claim, or in other forms, such as being embodied in a computer-readable medium. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application, in either this application or in a continuing application.

What is claimed is:

1. A data storage management system comprising:
a plurality of storage service cells, wherein each storage service cell comprises a storage manager for managing storage operations within the storage service cell;
a storage hub manager in communication with each storage manager at the plurality of storage service cells;
wherein the storage hub manager is configured to:
receive storage operation preferences administered for distinct customers of the data storage management system, wherein each storage operation preference is associated with a data source of a distinct customer;
store configuration information about each storage service cell received from each storage manager at the plurality of storage service cells;
for each data source of a distinct customer, assign data protection responsibilities to one of the plurality of storage service cells based on: configuration information about the one storage service cell, attributes of the data source, and storage operation preferences administered for the data source;
distribute one or more storage operation preferences of one or more distinct customers to each storage service cell based on data protection responsibilities assigned to each storage service cell, wherein each storage manager at a given storage service cell stores each received storage operation preference in association with a distinct customer, and wherein the storage manager manages storage operations within the given storage service cell according to the one or more storage operation preferences received from the storage hub manager; and
wherein at least one storage service cell among the plurality of storage service cells in the data storage management system is assigned data protection responsibilities for data sources of at least two distinct customers.

2. The system of claim 1 wherein a first data source of a first customer is backed up at a first storage service cell among the plurality of storage service cells and wherein a second data source of the first customer is backed up at a second storage service cell among the plurality of storage service cells.

3. The system of claim 1 wherein a first customer's data sources are backed up by at least two storage service cells among the plurality of storage service cells, based on respective data protection responsibilities assigned thereto.

4. The system of claim 1 wherein a first customer's data sources are backed up into secondary copies based on a storage operation preference associated with each first customer's respective data source; and wherein the first customer's secondary copies are generated by at least two storage service cells among the plurality of storage service cells, based on respective data protection responsibilities assigned thereto.

5. The system of claim 1 wherein to assign data protection responsibilities to one of the plurality of storage service cells, the storage hub manager is further configured to: identify among the plurality of storage service cells the one storage service cell with a configuration suitable for backing up the data source according to the attributes of the data source.

6. The system of claim 1 wherein to assign data protection responsibilities to one of the plurality of storage service cells, the storage hub manager is further configured to: identify among the plurality of storage service cells the one storage service cell with a configuration comprising components for backing up the data source according to the attributes of the data source.

7. The system of claim 1 wherein to assign data protection responsibilities to one of the plurality of storage service cells based on attributes of the data source of the distinct customer indicating that the data source is hosted by a cloud computing environment, and storage operation preferences administered for the data source of the distinct customer, the storage hub manager is further configured to: identify among the plurality of storage service cells the one storage service cell with a configuration comprising access to the cloud computing environment that hosts the data source.

8. The system of claim 1 wherein the system maintains a many-to-many relationship between distinct customers and storage service cells among the plurality of storage service cells, wherein data sources of a first customer are protected by at least two distinct storage service cells, and further wherein a first storage service cell protects data sources of at least two distinct customers; and
wherein the storage hub manager is further configured to block each distinct customer from viewing other customers' storage operation preferences and secondary copies resulting from storage operations in the plurality of storage service cells.

9. The system of claim 1 wherein the storage hub manager is further configured to:
provide a user interface, which provides for each distinct customer, features for administering storage operation preferences for the distinct customer's data sources and for accessing the distinct customer's secondary copies resulting from storage operations at one or more storage service cells among the plurality of storage service cells; and
block each distinct customer from viewing other customers' storage operation preferences and secondary copies at the one or more storage service cells.

10. The system of claim 1 wherein the storage hub manager is further configured to:
provide a user interface for global searching across the data storage management system, for each distinct customer, for finding secondary copies associated with the distinct customer, wherein each secondary copy was generated by storage operations at one of the storage service cells among the plurality of storage service cells, and wherein the user interface is supplied by the storage hub manager and not supplied by the storage managers in the plurality of storage service cells; and
block each distinct customer from viewing other customers' storage operation preferences and secondary copies at the plurality of storage service cells.

11. The system of claim 1 wherein administration of the storage operation preferences is performed via a user interface supplied by the storage hub manager and not supplied by the storage managers in the plurality of storage service cells.

12. The system of claim 1 wherein the storage hub manager is further configured to:
maintain a document-oriented database comprising a respective shard dedicated to each storage service cell in the plurality of storage service cells; and
add to a given shard dedicated to a respective storage service cell activity information about the respective storage service cell obtained from an active message queue at a storage manager of the respective storage service cell.

13. The system of claim 1 wherein the storage hub manager is further configured to:
maintain a document-oriented database comprising a respective shard dedicated to each storage service cell in the plurality of storage service cells; and
add to a given shard dedicated to a respective storage service cell activity information about the respective storage service cell obtained from an active message queue at a storage manager of the respective storage service cell; and
respond to queries from a customer by aggregating customer-associated information from the shards of the document-oriented database, wherein query responses exclude information associated with other customers of the data storage management system.

14. The system of claim 13 wherein the activity information of the respective storage service cell obtained from the active message queue comprises one or more of: job status, information about secondary copies generated at the respective storage service cell, client changes, events, and alerts at the given storage service cell.

15. A data storage management system comprising:
a plurality of storage service cells, wherein each storage service cell comprises a storage manager for managing storage operations within the storage service cell;
a storage hub manager in communication with each storage manager at the plurality of storage service cells;
wherein the storage hub manager is configured to:
receive storage operation preferences administered for distinct customers of the data storage management system;
store configuration information about each storage service cell received from each storage manager at the plurality of storage service cells;
for each data source of a distinct customer, assign data protection responsibilities to one of the plurality of storage service cells;
transmit one or more storage operation preferences of one or more distinct customers to each storage service cell based on data protection responsibilities assigned to each storage service cell, wherein each storage manager at a given storage service cell stores each received storage operation preference in association with a distinct customer, and wherein the storage manager manages storage operations within the given storage service cell according to the one or more storage operations preferences received from the storage hub manager;
provide a user interface for global searching across the data storage management system, for finding, for each distinct customer, secondary copies associated with the distinct customer, wherein each secondary copy was generated by storage operations at one of the storage service cells among the plurality of storage service cells, and wherein the user interface is supplied by the storage hub manager and not supplied by the storage managers in the plurality of storage service cells;
wherein the system maintains a many-to-many relationship between distinct customers and storage service cells among the plurality of storage service cells, wherein data sources of a first customer are protected by at least two distinct storage service cells, and further wherein a first storage service cell protects data sources of at least two distinct customers; and
wherein the storage hub manager is further configured to: block each customer from viewing other distinct customers' storage operation preferences and secondary copies resulting from storage operations in the plurality of storage service cells.

16. The system of claim 15 wherein for each data source of a distinct customer, data protection responsibilities are assigned to the one storage service cell based on: configuration information about the one storage service cell, attributes of the data source, and storage operation preferences administered for the data source.

17. The system of claim 15 wherein to assign data protection responsibilities to the one storage service cell, the storage hub manager is further configured to: identify among the plurality of storage service cells the one storage service cell with a configuration comprising components for backing up the data source according to attributes of the data source.

18. The system of claim 15 wherein to assign data protection responsibilities to the one storage service cell for a data source hosted by a cloud computing environment, the storage hub manager is further configured to: identify among the plurality of storage service cells the one storage service cell with a configuration comprising access to the cloud computing environment that hosts the data source.

19. The system of claim 15 wherein the storage hub manager is further configured to:
maintain a document-oriented database comprising a respective shard dedicated to each storage service cell in the plurality of storage service cells;
add to a given shard dedicated to a respective storage service cell activity information about the respective storage service cell obtained from an active message queue at a storage manager of the respective storage service cell; and
for each distinct customer, respond to global searching queries by aggregating information associated with the distinct customer from the shards of the document-oriented database, wherein query responses exclude information associated with other distinct customers of the data storage management system.

20. The system of claim 15 wherein the user interface provides, for each distinct customer, features for administering storage operation preferences for the distinct customer's data sources and for accessing the distinct customer's secondary copies resulting from storage operations at one or more storage service cells among the plurality of storage service cells.
